(19) United States
(12) Patent Application Publication
(10) Pub. No.: US 2024/0291603 A1
(43) Pub. Date: Aug. 29, 2024

(54) CSI CODEBOOK PARAMETERS FOR COHERENT JOINT TRANSMISSION

(71) Applicant: Samsung Electronics Co., Ltd., Suwon-si (KR)

(72) Inventors: Gilwon Lee, Allen, TX (US); Md. Saifur Rahman, Plano, TX (US); Eko Onggosanusi, Coppell, TX (US)

(21) Appl. No.: 18/424,450

(22) Filed: Jan. 26, 2024

Related U.S. Application Data
(60) Provisional application No. 63/444,837, filed on Feb. 10, 2023.
(60) Provisional application No. 63/444,842, filed on Feb. 10, 2023.
(60) Provisional application No. 63/447,283, filed on Feb. 21, 2023.
(60) Provisional application No. 63/447,292, filed on Feb. 21, 2023.
(60) Provisional application No. 63/448,852, filed on Feb. 28, 2023.
(60) Provisional application No. 63/461,106, filed on Apr. 21, 2023.
(60) Provisional application No. 63/465,441, filed on May 10, 2023.
(60) Provisional application No. 63/466,902, filed on May 16, 2023.
(60) Provisional application No. 63/472,167, filed on Jun. 9, 2023.
(60) Provisional application No. 63/472,179, filed on Jun. 9, 2023.

(51) Int. Cl. H04L 5/00; H04B 7/0417; H04B 7/06

(52) U.S. Cl. CPC H04L 5/0035; H04B 7/0417; H04B 7/0626; H04L 5/0051

(57) ABSTRACT

Apparatuses and methods for channel state information (CSI) codebook parameters for coherent joint-transmission. A method performed by a user equipment (UE) includes receiving information about a CSI report. The information indicates codebook parameters N_{L}≥1 combinations of values of {α₁, . . . , α_{N}_{_{TRP}}} from a first table and a value of (M,β) from a second table. {α₁, . . . , α_{N}_{_{TRP}}} is related to a number of a first set of vectors associated with each of N_{TRP} groups of ports, where αᵣ≤1 for r=1, . . . , N_{TRP}, β is a parameter related to a maximum number of coefficients, and M is a parameter related to a second set of vectors. The method further includes determining the CSI report based on the information and transmitting the CSI report. The codebook parameters are configured based on a third table that links the first and second tables.

### CROSS-REFERENCE TO RELATED APPLICATION AND CLAIM OF PRIORITY

This application claims priority under 35 U.S.C. § 119(e) to U.S. Provisional Patent Application No. 63/444,837 filed on Feb. 10, 2023, U.S. Provisional Patent Application No. 63/444,842 filed on Feb. 10, 2023, U.S. Provisional Patent Application No. 63/447,283 filed on Feb. 21, 2023, U.S. Provisional Patent Application No. 63/447,292 filed on Feb. 21, 2023, U.S. Provisional Patent Application No. 63/448,852 filed on Feb. 28, 2023, U.S. Provisional Patent Application No. 63/461,106 filed on Apr. 21, 2023, U.S. Provisional Patent Application No. 63/465,441 filed on May 10, 2023, U.S. Provisional Patent Application No. 63/466,902 filed on May 16, 2023, U.S. Provisional Patent Application No. 63/472,167 filed on Jun. 9, and 2023, and U.S. Provisional Patent Application No. 63/472,179 filed on Jun. 9, 2023. The above-identified provisional patent applications are hereby incorporated by reference in their entirety.

### TECHNICAL FIELD

The present disclosure relates generally to wireless communication systems and, more specifically, to apparatuses and methods for channel state information (CSI) codebook parameters for coherent joint-transmission.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to apparatuses and methods for CSI codebook parameters for coherent joint-transmission.

In one embodiment, a user equipment (UE) is provided. The UE includes a transceiver configured to receive information about a CSI report. The information indicates codebook parameters N_{L}≥1 combinations of values of {α₁, . . . , α_{N}_{_{TRP}}} from a first table, and a value of (M,β) from a second table. {α₁, . . . , α_{N}_{_{TRP}}} is related to a number of a first set of vectors associated with each of N_{TRP} groups of ports, where αᵣ≤1 for r=1, . . . , N_{TRP}, β is a parameter related to a maximum number of coefficients, and M is a parameter related to a second set of vectors. The UE further includes a processor operably coupled to the transceiver, the processor configured to determine the CSI report based on the information. The transceiver is further configured to transmit the CSI report. The codebook parameters are configured based on a third table that links the first and second tables.

In another embodiment, a base station (BS) is provided. The BS includes a processor and a transceiver operably coupled to the processor. The transceiver is configured to transmit information about a CSI report and receive the CSI report that is based on the information. The information indicates codebook parameters N_{L}≥1 combinations of values of {α₁, . . . , α_{N}_{_{TRP}}}, from a first table and a value of (M,β) from a second table. {α₁, . . . , α_{N}_{_{TRP}}} is related to a number of a first set of vectors associated with each of N_{TRP} groups of ports, where αᵣ≤ 1 for r=1, . . . , N_{TRP}, β is a parameter related to a maximum number of coefficients, and M is a parameter related to a second set of vectors. The codebook parameters are configured based on a third table that links the first and second tables.

In yet another embodiment, a method performed by a UE is provided. The method includes receiving information about a CSI report. The information indicates codebook parameters N_{L}≥1 combinations of values of {α₁, . . . , α_{N}_{_{TRP}}} from a first table and a value of (M,β) from a second table. {α₁, . . . , α_{N}_{_{TRP}}} is related to a number of a first set of vectors associated with each of N_{TRP} groups of ports, where αᵣ≤1 for r=1, . . . , N_{TRP}, β is a parameter related to a maximum number of coefficients, and M is a parameter related to a second set of vectors. The method further includes determining the CSI report based on the information and transmitting the CSI report. The codebook parameters are configured based on a third table that links the first and second tables.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIG. 4 illustrates an example antenna blocks or arrays forming beams according to embodiments of the present disclosure;

FIG. 5 illustrates an example distributed multiple-input multiple-output (MIMO) system according to embodiments of the present disclosure;

FIG. 6 illustrates an example distributed MIMO system according to embodiments of the present disclosure;

FIG. 7 illustrates an example antenna port layout according to embodiments of the present disclosure;

FIG. 8 illustrates a 3D grid of oversampled discrete Fourier transform (DFT) beams according to embodiments of the present disclosure;

FIG. 9 illustrates two new codebooks according to embodiments of the present disclosure;

FIG. 10 illustrates codebook parameters for the mTRP codebook configured using two (parameter-combination) tables according to embodiments of the present disclosure;

FIG. 11 illustrates a one-to-one relation between Lₙ and αₙ according to embodiments of the present disclosure;

FIG. 12 illustrates a many-to-one relation between Lₙ and αₙ according to embodiments of the present disclosure;

FIG. 13 illustrates a one-to-one relation between pᵥ and M according to embodiments of the present disclosure;

FIG. 14 illustrates a many-to-one relation between pᵥ and M according to embodiments of the present disclosure;

FIG. 15 illustrates a one-to-one relation between β_{R16} and β_{R17} according to embodiments of the present disclosure;

FIG. 16 illustrates a many-to-one relation between β_{R16} and β_{R17} according to embodiments of the present disclosure; and

FIG. 17 illustrates a flowchart of an example method performed by a UE according to embodiments of the present disclosure.

### DETAILED DESCRIPTION

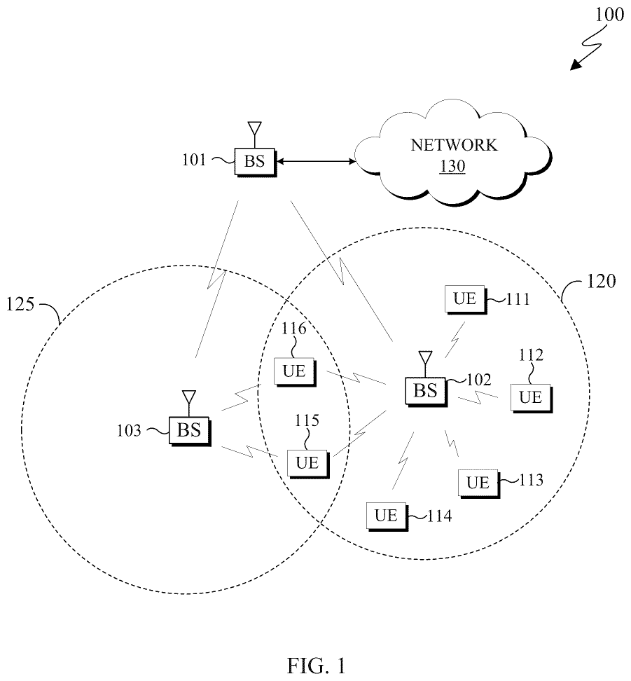

FIGS. 1 through 17, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

The following documents and standards descriptions are hereby incorporated by reference into the present disclosure as if fully set forth herein: 3GPP TS 36.211 v17.2.0, “E-UTRA, Physical channels and modulation” (herein “REF 1”); 3GPP TS 36.212 v17.1.0, “E-UTRA, Multiplexing and Channel coding” (herein “REF 2”); 3GPP TS 36.213 v17.4.0, “E-UTRA, Physical Layer Procedures” (herein “REF 3”); 3GPP TS 36.321 v17.3.0, “E-UTRA, Medium Access Control (MAC) protocol specification” (herein “REF 4”); 3GPP TS 36.331 v17.3.0, “E-UTRA, Radio Resource Control (RRC) Protocol Specification” (herein “REF 5”); 3GPP TS 38.211 v17.4.0, “NR, Physical channels and modulation” (herein “REF 6”); 3GPP TS 38.212 v17.4.0, “NR, Multiplexing and Channel coding” (herein “REF 7”); 3GPP TS 38.213 v17.4.0, “NR, Physical Layer Procedures for Control” (herein “REF 8”); 3GPP TS 38.214 v17.4.0, “NR, Physical Layer Procedures for Data” (herein “REF 9”); 3GPP TS 38.215 v17.2.0, “NR, Physical Layer Measurements” (herein “REF 10”); 3GPP TS 38.321 v17.3.0, “NR, Medium Access Control (MAC) protocol specification” (herein “REF 11”); and 3GPP TS 38.331 v17.3.0, “NR, Radio Resource Control (RRC) Protocol Specification” (herein “REF 12”).

For a cellular system operating in a sub-1GHz frequency range (e.g., less than 1 GHz), supporting large number of CSI-RS antenna ports (e.g., 32) at a single location or remote radio head (RRH) or TRP is challenging due to that a larger antenna form factor size is needed at these frequencies than a system operating at a higher frequency such as 2 GHz or 4 GHz. At such low frequencies, the maximum number of CSI-RS antenna ports that can be co-located at a single site (or TRP/RRH) can be limited, for example to 8. This limits the spectral efficiency of such systems. In particular, the MU-MIMO spatial multiplexing gains offered due to large number of CSI-RS antenna ports (such as 32) can't be achieved.

One way to operate a sub-1GHz system with large number of CSI-RS antenna ports is based on distributing antenna ports at multiple locations (or TRP/RRHs). The multiple sites or TRPs/RRHs can still be connected to a single (common) base unit, hence the signal transmitted/received via multiple distributed TRPs/RRHs can still be processed at a centralized location. This is called distributed MIMO or multi-TRP coherent joint transmission (C-JT).

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

Embodiments of the present disclosure propose methods and apparatuses for codebook parameters considering feedback overhead in a multi-TRP C-JT scenario.

Embodiments of the present disclosure recognize that CSI enhancement described in Rel-18 MIMO considers Rel-16/17 Type-II CSI codebook refinements to support mTRP coherent joint transmission (C-JT) operations by considering performance-and-overhead trade-off. The Rel-16/17 Type-II CSI codebook has three components W₁, W₂, and W_{f}. Among them, W₂ is the component that could induce large CSI feedback overhead especially in mTRP C-JT operations. Embodiments of the present disclosure recognize that codebook parameter configuration may alleviate the amount of CSI reporting overhead to have good performance-and-overhead trade-off for C-JT operations.

Accordingly, embodiments of the present disclosure propose codebook parameter configurations (an extension of the tables of paraCombination-r16, paraCombination-r17) to have good performance-and-overhead trade-off for mTRP C-JT operations. Additionally, embodiments of the present disclosure propose several components on how to map or translate from codebook parameter combinations for Rel-16-based CJT (multi-TRP) codebook to codebook parameter combinations for Rel-16-based CJT codebook to yield good performance-and-overhead trade-off.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (cNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for using CSI codebook parameters for coherent joint-transmission. In certain embodiments, one or more of the BSs 101-103 include circuitry, programing, or a combination thereof for providing CSI codebook parameters for coherent joint-transmission.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

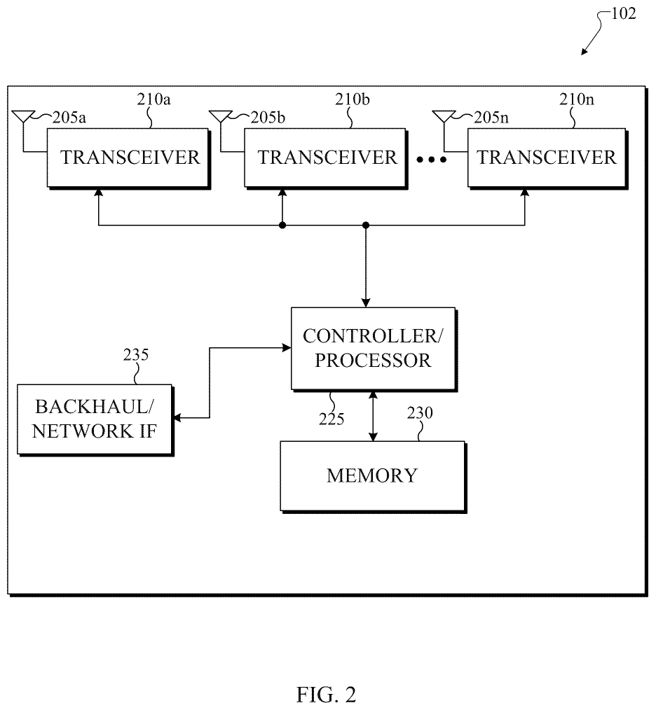

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for providing CSI codebook parameters for coherent joint-transmission. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

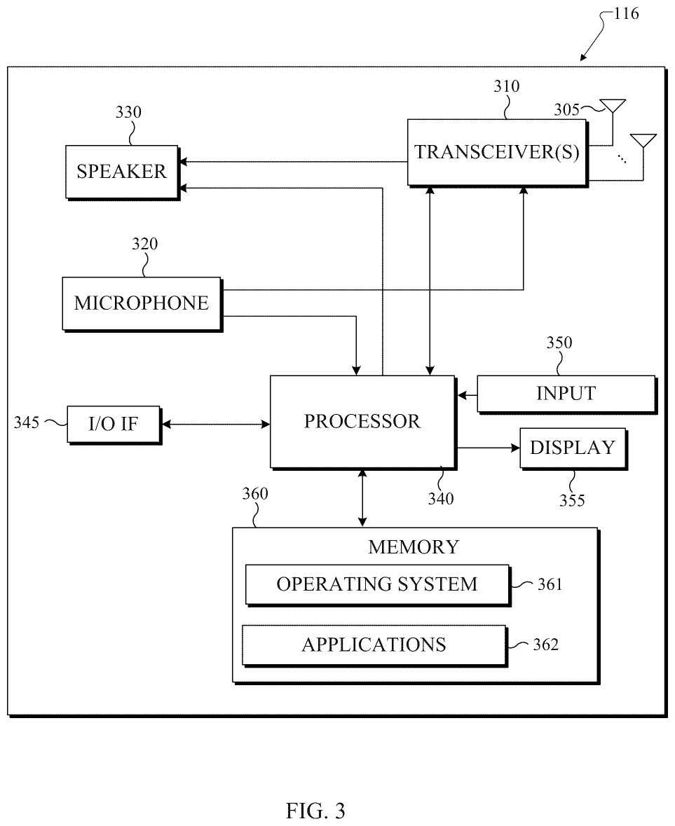

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. As another example, the processor 340 could support methods for using CSI codebook parameters for coherent joint-transmission. In some embodiments, the processor 340 includes at least one microprocessor or microcontroller.

The processor 340 is also capable of executing other processes and programs resident in the memory 360. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

The 3GPP NR specification supports up to 32 CSI-RS antenna ports which enable a gNB to be equipped with a large number of antenna elements (such as 64 or 128). In this case, a plurality of antenna elements is mapped onto one CSI-RS port. For next generation cellular systems such as 5G, the maximum number of CSI-RS ports can either remain the same or increase.

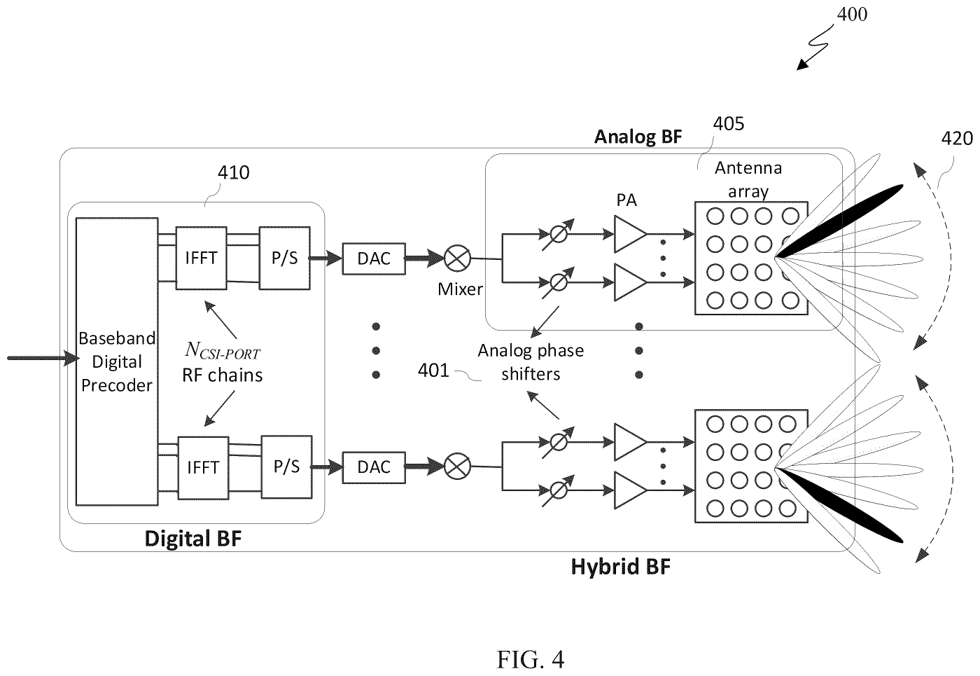

FIG. 4 illustrates an example antenna blocks or arrays 400 according to embodiments of the present disclosure. The embodiment of the antenna blocks or arrays 400 illustrated in FIG. 4 is for illustration only. FIG. 4 does not limit the scope of the present disclosure to any particular implementation of the antenna blocks or arrays.

For mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated in FIG. 4. In this case, one CSI-RS port is mapped onto a large number of antenna elements which can be controlled by a bank of analog phase shifters 401. One CSI-RS port can then correspond to one sub-array which produces a narrow analog beam through analog beamforming 405. This analog beam can be configured to sweep across a wider range of angles 420 by varying the phase shifter bank across symbols or subframes. The number of sub-arrays (equal to the number of RF chains) is the same as the number of CSI-RS ports N_{CSI-PORT}. A digital beamforming unit 410 performs a linear combination across N_{CSI-PORT} analog beams to further increase precoding gain. While analog beams are wideband (hence not frequency-selective), digital precoding can be varied across frequency sub-bands or resource blocks. Receiver operation can be conceived analogously.

Since the above system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL transmit (TX) beam (also termed “beam indication”), measuring at least one reference signal for calculating and performing beam reporting (also termed “beam measurement” and “beam reporting”, respectively), and receiving a DL or UL transmission via a selection of a corresponding receive (RX) beam.

The above system is also applicable to higher frequency bands such as >52.6 GHz (also termed the FR4). In this case, the system can employ only analog beams. Due to the O2 absorption loss around 60 GHz frequency (˜10 dB additional loss @ 100 m distance), larger number of and sharper analog beams (hence larger number of radiators in the array) will be needed to compensate for the additional path loss.

At lower frequency bands such as <1 GHz, on the other hand, the number of antenna elements may not be large in a given form factor due to the large wavelength. As an example, for the case of the wavelength size (λ) of the center frequency 600 MHZ (which is 50 cm), it desires 4 m for uniform-linear-array (ULA) antenna panel of 16 antenna elements with the half-wavelength distance between two adjacent antenna elements. Considering a plurality of antenna elements is mapped to one digital port in practical cases, the desirable size for antenna panel(s) at gNB to support a large number of antenna ports such as 32 CSI-RS ports becomes very large in such low frequency bands, and it leads the difficulty of deploying 2-D antenna element arrays within the size of a conventional form factor. This results in a limited number of CSI-RS ports that can be supported at a single site and limits the spectral efficiency of such systems.

Various embodiments of the present disclosure recognize that for a cellular system operating in a sub-1GHz frequency range (e.g., less than 1 GHz), supporting large number of CSI-RS antenna ports (e.g., 32) at a single location or remote radio head (RRH) or TRP is challenging due to that a larger antenna form factor size is needed at these frequencies than a system operating at a higher frequency such as 2 GHz or 4 GHz. At such low frequencies, the maximum number of CSI-RS antenna ports that can be co-located at a single site (or TRP/RRH) can be limited, for example to 8. This limits the spectral efficiency of such systems. In particular, the MU-MIMO spatial multiplexing gains offered due to large number of CSI-RS antenna ports (such as 32) can't be achieved.

One way to operate a sub-1GHz system with large number of CSI-RS antenna ports is based on distributing antenna ports at multiple locations (or TRP/RRHs). The multiple sites or TRPs/RRHs can still be connected to a single (common) base unit, hence the signal transmitted/received via multiple distributed TRPs/RRHs can still be processed at a centralized location. This is called distributed MIMO or multi-TRP coherent joint transmission (C-JT).

Various embodiments of the present disclosure recognize that CSI enhancement described in Rel-18 MIMO considers Rel-16/17 Type-II CSI codebook refinements to support mTRP coherent joint transmission (C-JT) operations by considering performance-and-overhead trade-off. Various embodiments of the present disclosure recognize that utilizing codebook subset restriction (CBSR) is one of the ways to manage CSI feedback overhead. Especially, in multi-TRP C-JT scenarios, CBSR could be useful in terms of reducing overhead.

Accordingly, various embodiments of the present disclosure provide mechanisms for CBSR for multi-TRP C-JT scenarios.

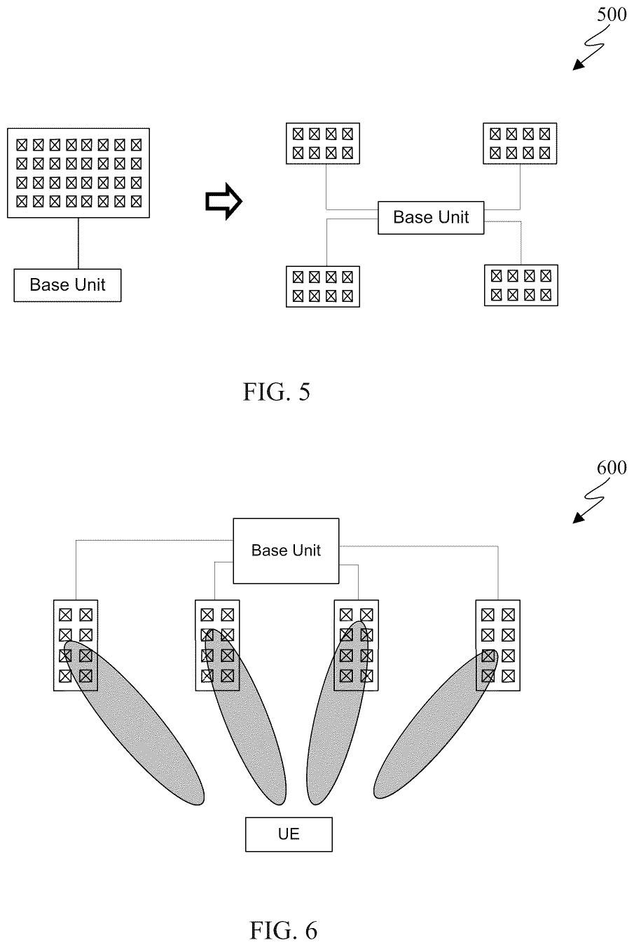

FIG. 5 illustrates an example distributed MIMO system 500 according to embodiments of the present disclosure. The embodiment of the distributed MIMO system 500 illustrated in FIG. 5 is for illustration only. FIG. 5 does not limit the scope of the present disclosure to any particular implementation of the distributed MIMO system 500.

One possible approach to resolving the issue is to form multiple TRPs (multi-TRP) or RRHs with a small number of antenna ports instead of integrating all of the antenna ports in a single panel (or at a single site) and to distribute the multiple panels in multiple locations/sites (or TRPs, RRHs). This approach is shown in FIG. 5.

FIG. 6 illustrates an example distributed MIMO system 600 according to embodiments of the present disclosure. The embodiment of the distributed MIMO system 600 illustrated in FIG. 6 is for illustration only. FIG. 6 does not limit the scope of the present disclosure to any particular implementation of the distributed MIMO system 600.

As illustrated in FIG. 6, the multiple TRPs at multiple locations can still be connected to a single base unit, and thus the signal transmitted/received via multiple distributed TRPs can be processed in a centralized manner through the single base unit.

Although the present disclosure has mentioned low frequency band systems (sub-1 GHz band) as a motivation for distributed MIMO (or mTRP), the distributed MIMO technology is frequency-band-agnostic and can be useful in mid- (sub-6GHz) and high-band (above-6GHz) systems in addition to low-band (sub-1GHz) systems.

The terminology “distributed MIMO” is used as an illustrative purpose, it can be considered under another terminology such as multi-TRP, mTRP, cell-free network, and so on.

All the following components and embodiments are applicable for UL transmission with CP-OFDM (cyclic prefix OFDM) waveform as well as DFT-SOFDM (DFT-spread OFDM) and SC-FDMA (single-carrier FDMA) waveforms. Furthermore, all the following components and embodiments are applicable for UL transmission when the scheduling unit in time is either one subframe (which can include one or multiple slots) or one slot.

In the present disclosure, the frequency resolution (reporting granularity) and span (reporting bandwidth) of CSI reporting can be defined in terms of frequency “subbands” and “CSI reporting band” (CRB), respectively.

A subband for CSI reporting is defined as a set of contiguous PRBs which represents the smallest frequency unit for CSI reporting. The number of PRBs in a subband can be fixed for a given value of DL system bandwidth, configured either semi-statically via higher-layer/RRC signaling, or dynamically via L1 DL control signaling or MAC control element (MAC CE). The number of PRBs in a subband can be included in CSI reporting setting.

“CSI reporting band” is defined as a set/collection of subbands, either contiguous or non-contiguous, wherein CSI reporting is performed. For example, CSI reporting band can include all the subbands within the DL system bandwidth. This can also be termed “full-band”. Alternatively, CSI reporting band can include only a collection of subbands within the DL system bandwidth. This can also be termed “partial band”.

The term “CSI reporting band” is used only as an example for representing a function. Other terms such as “CSI reporting subband set” or “CSI reporting bandwidth” can also be used.

In terms of UE configuration, a UE can be configured with at least one CSI reporting band. This configuration can be semi-static (via higher-layer signaling or RRC) or dynamic (via MAC CE or L1 DL control signaling). When configured with multiple (N) CSI reporting bands (e.g., via RRC signaling), a UE can report CSI associated with n≤N CSI reporting bands. For instance, >6 GHz, large system bandwidth may require multiple CSI reporting bands. The value of n can either be configured semi-statically (via higher-layer signaling or RRC) or dynamically (via MAC CE or L1 DL control signaling). Alternatively, the UE can report a recommended value of n via an UL channel.

Therefore, CSI parameter frequency granularity can be defined per CSI reporting band as follows. A CSI parameter is configured with “single” reporting for the CSI reporting band with Mₙ subbands when one CSI parameter for all the Mₙ subbands within the CSI reporting band. A CSI parameter is configured with “subband” for the CSI reporting band with Mₙ subbands when one CSI parameter is reported for each of the Mₙ subbands within the CSI reporting band.

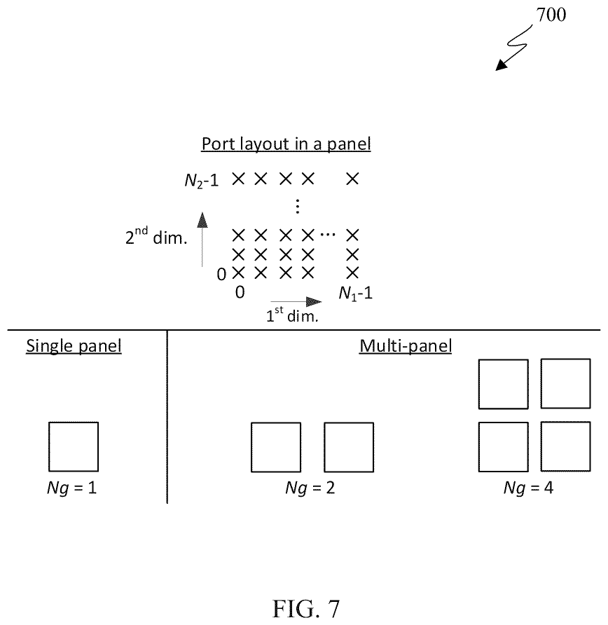

FIG. 7 illustrates an example antenna port layout 700 according to embodiments of the present disclosure. The embodiment of the antenna port layout 700 illustrated in FIG. 7 is for illustration only. FIG. 7 does not limit the scope of the present disclosure to any particular implementation of the antenna port layout.

As illustrated in FIGS. 7, N₁ and N₂ are the number of antenna ports with the same polarization in the first and second dimensions, respectively. For 2D antenna port layouts, N₁>1, N₂>1, and for 1D antenna port layouts N₁>1 and N₂=1. Therefore, for a dual-polarized antenna port layout, the total number of antenna ports is 2N₁N₂ when each antenna maps to an antenna port. An illustration is shown in FIG. 7 where “X” represents two antenna polarizations. In the present disclosure, the term “polarization” refers to a group of antenna ports. For example, antenna ports

$$\\ j = X + 0 , X + 1 , … , X + \frac{{P}_{CSIRS}}{2} - 1$$

comprise a first antenna polarization, and antenna ports

$$\\ j = X + \frac{{P}_{CSIRS}}{2} , X + \frac{{P}_{CSIRS}}{2} + 1 , … , X + {P}_{CSIRS} - 1$$

comprise a second antenna polarization, where P_{CSIRS} is a number of CSI-RS antenna ports and X is a starting antenna port number (e.g., X=3000, then antenna ports are 3000, 3001, 3002, . . . ). Let N_{g} be a number of antenna panels at the gNB. When there are multiple antenna panels (N_{g}>1), we assume that each panel is dual-polarized antenna ports with N₁ and N₂ ports in two dimensions. This is illustrated in FIG. 7. Note that the antenna port layouts may or may not be the same in different antenna panels.

In one example, the antenna architecture of a D-MIMO or CJT (coherent joint-transmission) system is structured. For example, the antenna structure at each RRH (or TRP) is dual-polarized (single or multi-panel as shown in FIG. 7. The antenna structure at each RRH/TRP can be the same. Alternatively, the antenna structure at an RRH/TRP can be different from another RRH/TRP. Likewise, the number of ports at each RRH/TRP can be the same. Alternatively, the number of ports at one RRH/TRP can be different from another RRH/TRP. In one example, N_{g}=N_{RRH}, a number of RRHs/TRPs in the D-MIMO transmission.

In another example, the antenna architecture of a D-MIMO or CJT system is unstructured. For example, the antenna structure at one RRH/TRP can be different from another RRH/TRP.

The remainder of the present disclosure assumes a structured antenna architecture. For simplicity, in the remainder of the present disclosure it is assumed that each RRH/TRP is equivalent to a panel, although, an RRH/TRP can have multiple panels in practice. The present disclosure however is not restrictive to a single panel assumption at each RRH/TRP, and can easily be extended (covers) the case when an RRH/TRP has multiple antenna panels.

In one embodiment, an RRH constitutes (or corresponds to or is equivalent to) at least one of the following:
In one example, an RRH corresponds to a TRP.
In one example, an RRH or TRP corresponds to a CSI-RS resource. A UE is configured with K=N_{RRH}>1 non-zero-power (NZP) CSI-RS resources, and a CSI reporting is configured to be across multiple CSI-RS resources. This is similar to Class B, K>1 configuration in Rel. 14 LTE. The K NZP CSI-RS resources can belong to a CSI-RS resource set or multiple CSI-RS resource sets (e.g., K resource sets each comprising one CSI-RS resource). The details are as explained earlier in the present disclosure.
In one example, an RRH or TRP corresponds to a CSI-RS resource group, where a group comprises one or multiple NZP CSI-RS resources. A UE is configured with K≥N_{RRH}>1 non-zero-power (NZP) CSI-RS resources, and a CSI reporting is configured to be across multiple CSI-RS resources from resource groups. This is similar to Class B, K>1 configuration in Rel. 14 LTE. The K NZP CSI-RS resources can belong to a CSI-RS resource set or multiple CSI-RS resource sets (e.g., K resource sets each comprising one CSI-RS resource). The details are as explained earlier in the present disclosure. In particular, the K CSI-RS resources can be partitioned into N_{RRH} resource groups. The information about the resource grouping can be provided together with the CSI-RS resource setting/configuration, or with the CSI reporting setting/configuration, or with the CSI-RS resource configuration.
In one example, an RRH or TRP corresponds to a subset (or a group) of CSI-RS ports. A UE is configured with at least one NZP CSI-RS resource comprising (or associated with) CSI-RS ports that can be grouped (or partitioned) multiple subsets/groups/parts of antenna ports, each corresponding to (or constituting) an RRH/TRP. The information about the subsets of ports or grouping of ports can be provided together with the CSI-RS resource setting/configuration, or with the CSI reporting setting/configuration, or with the CSI-RS resource configuration.
In one example, an RRH or TRP corresponds to one or more examples described above depending on a configuration. For example, this configuration can be explicit via a parameter (e.g., an RRC parameter). Alternatively, it can be implicit.
In one example, when implicit, it could be based on the value of K. For example, when K>1 CSI-RS resources, an RRH corresponds to one or more examples described above, and when K=1 CSI-RS resource, an RRH corresponds to one or more examples described above.
In another example, the configuration could be based on the configured codebook. For example, an RRH corresponds to a CSI-RS resource or resource group when the codebook corresponds to a decoupled codebook (modular or separate codebook for each RRH), and an RRH corresponds to a subset (or a group) of CSI-RS ports when codebook corresponds to a coupled (joint or coherent) codebook (one joint codebook across TRPs/RRHs).

In one example, when RRH or TRP maps (or corresponds to) a CSI-RS resource or resource group, and a UE can select a subset of RRHs (resources or resource groups) and report the CSI for the selected TRPs/RRHs (resources or resource groups), the selected TRPs/RRHs can be reported via an indicator. For example, the indicator can be a CRI or a PMI (component) or a new indicator.

In one example, when RRH or TRP maps (or corresponds to) a CSI-RS port group, and a UE can select a subset of TRPs/RRHs (port groups) and report the CSI for the selected TRPs/RRHs (port groups), the selected TRPs/RRHs can be reported via an indicator. For example, the indicator can be a CRI or a PMI (component) or a new indicator.

In one example, when multiple (K>1) CSI-RS resources are configured for N_{RRH} TRPs/RRHs, a decoupled (modular) codebook is used/configured, and when a single (K=1) CSI-RS resource for N_{RRH} TRPs/RRHs, a joint codebook is used/configured.

As described in U.S. Pat. No. 10,659,118, issued May 19, 2020, and entitled “Method and Apparatus for Explicit CSI Reporting in Advanced Wireless Communication Systems,” which is incorporated herein by reference in its entirety, a UE is configured with high-resolution (e.g., Type II) CSI reporting in which the linear combination-based Type II CSI reporting framework is extended to include a frequency dimension in addition to the first and second antenna port dimensions.

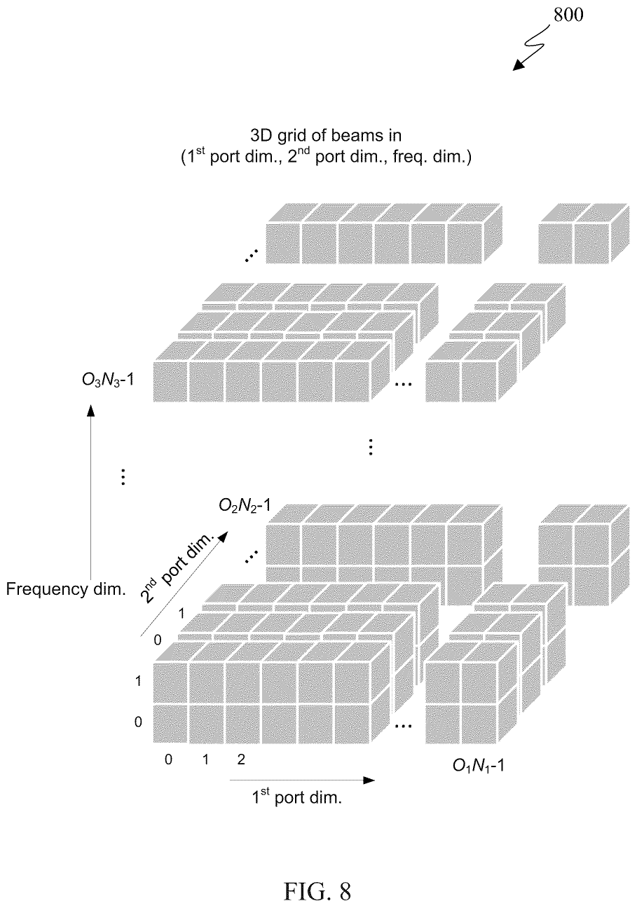

FIG. 8 illustrates a 3D grid of oversampled DFT beams 800 according to embodiments of the present disclosure. The embodiment of the 3D grid of oversampled DFT beams 800 illustrated in FIG. 8 is for illustration only. FIG. 8 does not limit the scope of the present disclosure to any particular implementation of the 3D grid of oversampled DFT beams.

As illustrated, FIG. 8 shows a 3D grid 800 of the oversampled DFT beams (1st port dim., 2nd port dim., freq. dim.) in which
a 1st dimension is associated with the 1st port dimension,
a 2nd dimension is associated with the 2nd port dimension, and
a 3rd dimension is associated with the frequency dimension.

The basis sets for 1^{st} and 2^{nd} port domain representation are oversampled DFT codebooks of length-N₁ and length-N₂, respectively, and with oversampling factors O₁ and O₂, respectively. Likewise, the basis set for frequency domain representation (i.e., 3rd dimension) is an oversampled DFT codebook of length-N₃ and with oversampling factor O₃. In one example, O₁=O₂=O₃=4. In one example, O₁=O₂=4 and O₃=1. In another example, the oversampling factors Oᵢ belongs to {2, 4, 8}. In yet another example, at least one of O₁, O₂, and O₃ is higher layer configured (via RRC signaling).

As explained in Section 5.2.2.2.6 of REF8, a UE is configured with higher layer parameter codebookType set to ‘ typeII-PortSelection-r16’ for an enhanced Type II CSI reporting in which the pre-coders for all SBs and for a given layer l=1, . . . , v, where v is the associated RI value, is given by either

$${W}^{l} = {AC}_{l} {B}^{H} = {[ {a}_{0} {a}_{1} ... {a}_{L - 1} ] [ \begin{matrix}{c}_{l , 0 , 0} & {c}_{l , 0 , 1} & … & {c}_{l , 0 , M - 1} \\ {c}_{l , 1 , 0} & {c}_{l , 1 , 1} & … & {c}_{l , 1 , M - 1} \\ ⋮ & ⋮ & ⋮ & ⋮ \\ {c}_{l , L - 1 , 0} & {c}_{l , L - 1 , 1} & … & {c}_{l , L - 1 , M - 1}\end{matrix} ] [ {b}_{0} {b}_{1} ... {b}_{M - 1} ]}^{H} = {\sum }_{f = 0}^{M - 1} {\sum }_{i = 0}^{L - 1} {c}_{l , i , f} ( {a}_{i} {b}_{f}^{H} ) = {\sum }_{i = 0}^{L - 1} {\sum }_{f = 0}^{M - 1} {c}_{l , i , f} ( {a}_{i} {b}_{f}^{H} ) , \qquad ( Eq . 1 )$$

$$or$$

$${W}^{l} = [ \begin{matrix}A & 0 \\ 0 & A\end{matrix} ] {C}_{l} {B}^{H} = {[ \begin{matrix}{a}_{0} {a}_{1} ... {a}_{L - 1} & 0 \\ 0 & {a}_{0} {a}_{1} ... {a}_{L - 1}\end{matrix} ] [ \begin{matrix}{c}_{l , 0 , 0} & {c}_{l , 0 , 1} & … & {c}_{l , 0 , M - 1} \\ {c}_{l , 1 , 0} & {c}_{l , 1 , 1} & … & {c}_{l , 1 , M - 1} \\ ⋮ & ⋮ & ⋮ & ⋮ \\ {c}_{l , L - 1 , 0} & {c}_{l , L - 1 , 1} & … & {c}_{l , L - 1 , M - 1}\end{matrix} ] [ {b}_{0} {b}_{1} ... {b}_{M - 1} ]}^{H} = [ \text{} \begin{matrix}{\sum }_{f = 0}^{M - 1} {\sum }_{i = 0}^{L - 1} {c}_{l , i , f} ( {a}_{i} {b}_{f}^{H} ) \\ {\sum }_{f = 0}^{M - 1} {\sum }_{i = 0}^{L - 1} {c}_{l , i + L , f} ( {a}_{i} {b}_{f}^{H} )\end{matrix} ] , \qquad ( Eq . 2 )$$

where:
N₁ is a number of antenna ports in a first antenna port dimension (having the same antenna polarization),
N₂ is a number of antenna ports in a second antenna port dimension (having the same antenna polarization),
P_{CSI-RS} is a number of CSI-RS ports configured to the UE,
N₃ is a number of SBs for PMI reporting or number of FD units or number of FD components (that comprise the CSI reporting band) or a total number of precoding matrices indicated by the PMI (one for each FD unit/component),
aᵢ is a 2N₁N₂×1 (Eq. 1) or N₁N₂×1 (Eq. 2) column vector, or aᵢ is a P_{CSIRS}×1 (Eq. 1) or

$$\frac{{P}_{CSIRS}}{2} \times 1$$

port selection column vector, where a port selection vector is a defined as a vector which contains a value of 1 in one element and zeros elsewhere,
b_{f} is a N₃×1 column vector,
c_{l,i,f} is a complex coefficient.

In a variation, when the UE reports a subset K<2LM coefficients (where K is either fixed, configured by the gNB or reported by the UE), then the coefficient c_{l,i,f} in precoder equations Eq. 1 or Eq. 2 is replaced with x_{l,i,f}×c_{l,i,f}, where
x_{l,i,f}=1 if the coefficient c_{l,i,f} is reported by the UE according to some embodiments of the present disclosure.
x_{l,i,f}=0 otherwise (i.e., c_{l,i,f} is not reported by the UE).

The indication whether x_{l,i,f}=1 or 0 is according to some embodiments of the present disclosure. For example, it can be via a bitmap.

In a variation, the precoder equations Eq. 1 or Eq. 2 are respectively generalized to

$${W}^{l} = {\sum }_{i = 0}^{L - 1} {\sum }_{f = 0}^{{M}_{i} - 1} {c}_{l , i , f} ( {a}_{i} {b}_{i , f}^{H} ) \qquad ( Eq . 3 )$$

$$and$$

$${W}^{l} = [ \text{} \begin{matrix}{\sum }_{i = 0}^{L - 1} {\sum }_{f = 0}^{{M}_{i} - 1} {c}_{l , i , f} ( {a}_{i} {b}_{i , f}^{H} ) \\ {\sum }_{i = 0}^{L - 1} {\sum }_{= 0}^{{M}_{i} - 1} {c}_{l , i + L , f} ( {a}_{i} {b}_{i , f}^{H} )\end{matrix} ] , \qquad ( Eq . 4 )$$

where for a given i, the number of basis vectors is Mᵢ and the corresponding basis vectors are {b_{i,f} }. Note that Mᵢ is the number of coefficients c_{l,i,f} reported by the UE for a given i, where Mᵢ≤M (where {Mᵢ} or ΣMᵢ is either fixed, configured by the gNB or reported by the UE).

The columns of W^{l} are normalized to norm one. For rank R or R layers (υ=R), the pre-coding matrix is given by

$${W}^{( R )} = \frac{1}{\sqrt{R}} [ \begin{matrix}{W}^{1} & {W}^{2} & … & {W}^{R}\end{matrix} ] .$$

Eq. 2 is assumed in the rest of the disclosure. The embodiments of the disclosure, however, are general and are also application to Eq. 1, Eq. 3 and Eq. 4.

Here

$$L \leq \frac{{P}_{CSI - RS}}{2} and M \leq {N}_{3} . If L = \frac{{P}_{CSI - RS}}{2} ,$$

then A is an identity matrix, and hence not reported. Likewise, if M=N₃, then B is an identity matrix, and hence not reported. Assuming M<N₃, in an example, to report columns of B, the oversampled DFT codebook is used. For instance, b_{f}=W_{f}, where the quantity W_{f} is given by

$${w}_{f} = {[ \begin{matrix}1 & {e}^{j \frac{2 π {n}_{3 , l}^{( f )}}{{O}_{3} {N}_{3}}} & {e}^{j \frac{2 π \cdot 2 {n}_{3 , l}^{( f )}}{{O}_{3} {N}_{3}}} & … & {e}^{j \frac{2 π \cdot ( {N}_{3} - 1 ) {n}_{3 , l}^{( f )}}{{O}_{3} {N}_{3}}}\end{matrix} ]}^{T} .$$

When O₃=1, the FD basis vector for layer l∈{1, . . . , υ} (where υ is the RI or rank value) is given by

$${w}_{f} = [ \begin{matrix}{y}_{0 , l}^{( f )} & {y}_{1 , l}^{( f )} & … & {{y}_{{N}_{3} - 1 , l}^{( f )} ]}^{T} ,\end{matrix}$$

$$where {y}_{t , l}^{( f )} = {e}^{j \frac{2 π {tn}_{3 , l}^{( f )}}{{N}_{3}}} and {n}_{3 , l} = [ {n}_{3 , l}^{( 0 )} , ... , {n}_{3 , l}^{( M - 1 )} ] where {n}_{3 , l}^{( f )} ∈ \{ 0 , 1 , ... , {N}_{3} - 1 \} .$$

In another example, discrete cosine transform DCT basis is used to construct/report basis B for the 3^{rd} dimension. The m-th column of the DCT compression matrix is simply given by

$${[ {W}_{f} ]}_{nm} = \{ \begin{matrix}\frac{1}{\sqrt{K}} , & n = 0 \\ \sqrt{\frac{2}{K}} cos \frac{π ( 2 m + 1 ) n}{2 K} , & n = 1 , ... K - 1\end{matrix} , \\ and K = {N}_{3} , and m = 0 , ... , {N}_{3} - 1.$$

Since DCT is applied to real valued coefficients, the DCT is applied to the real and imaginary components (of the channel or channel eigenvectors) separately. Alternatively, the DCT is applied to the magnitude and phase components (of the channel or channel eigenvectors) separately. The use of DFT or DCT basis is for illustration purpose only. The disclosure is applicable to any other basis vectors to construct/report A and B.

On a high level, a precoder W^{l} can be described as follows.

$$W = {A}_{l} {C}_{l} {B}_{l}^{H} = {W}_{1} {\tilde{W}}_{2} {W}_{f}^{H} , \qquad ( Eq . 5 )$$

where A=W₁ corresponds to the Rel. 15 W₁ in Type II CSI codebook [REF8], and B=W_{f}.

The Cₗ=\tilde{W}₂ matrix includes all the required linear combination coefficients (e.g., amplitude and phase or real or imaginary). Each reported coefficient (c_{l,i,f}=p_{l,i,f}ϕ_{l,i,f}) in \tilde{W}₂ is quantized as amplitude coefficient (p_{l,i,f}) and phase coefficient (ϕ_{l,i,f}). In one example, the amplitude coefficient (p_{l,i,f}) is reported using a A-bit amplitude codebook where A belongs to {2, 3, 4}. If multiple values for A are supported, then one value is configured via higher layer signaling. In another example, the amplitude coefficient (p_{l,i,f}) is reported as p_{l,i,f}=p_{l,i,f}⁽¹⁾p_{l,i,f}⁽²⁾ where
p_{l,i,f}⁽¹⁾ is a reference or first amplitude which is reported using an A1-bit amplitude codebook where A1 belongs to {2, 3, 4}, and
p_{l,i,f}⁽²⁾ is a differential or second amplitude which is reported using a A2-bit amplitude codebook where A2≤A1 belongs to {2, 3, 4}.

For layer l, let us denote the linear combination (LC) coefficient associated with spatial domain (SD) basis vector (or beam) i∈{0, 1, . . . , 2L−1} and frequency domain (FD) basis vector (or beam) f∈{0, 1, . . . , M−1} as c_{l,i,f}, and the strongest coefficient as c_{l,i*,f*}. The strongest coefficient is reported out of the K_{NZ} non-zero (NZ) coefficients that is reported using a bitmap, where K_{NZ}≤K₀=┌β×2LM┐<2LM and β is higher layer configured. The remaining 2LM−K_{NZ} coefficients that are not reported by the UE are assumed to be zero. The following quantization scheme is used to quantize/report the K_{NZ} NZ coefficients.
UE reports the following for the quantization of the NZ coefficients in \tilde{W}₂
   A X-bit indicator for the strongest coefficient index (i*,f*), where X=┌log₂ K_{NZ}┐ or ┌log₂ 2L┐.
      i. Strongest coefficient c_{l,i*,f*}=1 (hence its amplitude/phase are not reported)
   Two antenna polarization-specific reference amplitudes is used.
      i. For the polarization associated with the strongest coefficient c_{l,i*,f*}=1, since the reference amplitude p_{l,i,f}⁽¹⁾=1, it is not reported
      ii. For the other polarization, reference amplitude p_{l,i,f}⁽¹⁾, is quantized to 4 bits.
         1. The 4-bit amplitude alphabet is

$$\{ 1 , {( \frac{1}{2} )}^{\frac{1}{4}} , {( \frac{1}{4} )}^{\frac{1}{4}} , {( \frac{1}{8} )}^{\frac{1}{4}} , ... , {( \frac{1}{{2}^{14}} )}^{\frac{1}{4}} \} .$$

For {c_{l,i,f}, (i,f)≠(i*,f*)}:
   i. For each polarization, differential amplitudes p_{l,i,f}⁽²⁾ of the coefficients calculated relative to the associated polarization-specific reference amplitude and quantized to 3 bits.
      1. The 3-bit amplitude alphabet is

$$\{ 1 , \frac{1}{\sqrt{2}} , \frac{1}{2} , \frac{1}{2 \sqrt{2}} , \frac{1}{4} , \frac{1}{4 \sqrt{2}} , \frac{1}{8} , \frac{1}{8 \sqrt{2}} \} .$$

2. Note: The final quantized amplitude p_{l,i,f} is given by p_{l,i,f}⁽¹⁾×p_{l,i,f}⁽²⁾
ii. Each phase is quantized to either 8PSK (Nₚₕ=8) or 16PSK (Nₚₕ=16) (which is configurable).

For the polarization r*∈{0,1} associated with the strongest coefficient c_{l,i*,f*}, we have

$${r}^{*} = ⌊ \frac{{i}^{*}}{L} ⌋$$

and the reference amplitude p_{l,i,f}⁽¹⁾=p_{l,r*}⁽¹⁾=1. For the other polarization r∈{0,1} and r≠r*, we have

$$r = ( ⌊ \frac{{i}^{*}}{L} ⌋ + 1 )$$

mod 2 and the reference amplitude p_{l,i,f}⁽¹⁾=p_{l,r}⁽¹⁾ is quantized (reported) using the 4-bit amplitude codebook mentioned above.

In Rel. 16 enhanced Type II and Type II port selection codebooks, a UE can be configured to report M FD basis vectors. In one example,

$$M = ⌈ p \times \frac{{N}_{3}}{R} ⌉ ,$$

where R is higher-layer configured from {1,2} and p is higher-layer configured from {¼,½}. In one example, the p value is higher-layer configured for rank 1-2 CSI reporting. For rank>2 (e.g., rank 3-4), the p value (denoted by v₀) can be different. In one example, for rank 1-4, (p,v₀) is jointly configured from {(½,¼),(¼,¼),(¼,⅛)}, i.e.,

$$M = ⌈ p \times \frac{{N}_{3}}{R} ⌉$$

for rank 1-2 and

$$M = ⌈ {v}_{0} \times \frac{{N}_{3}}{R} ⌉$$

for rank 3-4. In one example, N₃=N_{SB}×R where N_{SB} is the number of SBs for CQI reporting. In one example, M is replaced with M_{υ} to show its dependence on the rank value υ, hence p is replaced with p_{υ}, υ∈{1,2} and v₀ is replaced with p_{υ}, υ∈{3,4}.

A UE can be configured to report M_{υ} FD basis vectors in one-step from N₃ basis vectors freely (independently) for each layer l∈{1, . . . , υ} of a rank υ CSI reporting. Alternatively, a UE can be configured to report M_{υ} FD basis vectors in two-step as follows.
In step 1, an intermediate set (InS) comprising N′₃<N₃ basis vectors is selected/reported, wherein the InS is common for all layers.
In step 2, for each layer l∈{1, . . . , υ} of a rank υ CSI reporting, M_{υ} FD basis vectors are selected/reported freely (independently) from N′₃ basis vectors in the InS.

In one example, a one-step method is used when N₃≤19 and a two-step method is used when N₃>19. In one example, N′₃=┌αM_{υ}┐ where α>1 is either fixed (to 2 for example) or configurable.

The codebook parameters used in the DFT based frequency domain compression (Eq. 5) are (L,p_{υ} for υ∈{1,2}, p_{υ} for υ∈{3,4},β,α,Nₚₕ). The set of values for these codebook parameters are as follows.
L: the set of values is {2,4} in general, except L∈{2,4,6} for rank 1-2, 32 CSI-RS antenna ports, and R=1.
(p_{υ} for υ∈{1,2}, p_{υ} for υ∈{3,4})∈{(½,¼),(¼,¼),(¼,⅛)}.
β∈{¼,½,¾}.
α=2
Nₚₕ=16.
   The set of values for these codebook parameters are as in Table 1.

TABLE 1

Pᵥ

| paramCombination | L | v ∈ {1, 2} | v ∈ {3, 4} | β |
|---|---|---|---|---|
| 1 | 2 | ¼ | ⅛ | ¼ |
| 2 | 2 | ¼ | ⅛ | ½ |
| 3 | 4 | ¼ | ⅛ | ½ |
| 4 | 4 | ¼ | ⅛ | ½ |
| 5 | 4 | ¼ | ¼ | ¾ |
| 6 | 4 | ½ | ¼ | ½ |
| 7 | 6 | ¼ | | ½ |
| 8 | 6 | ¼ | | ¾ |

In Rel. 17 (further enhanced Type II port selecting codebook), M∈{1,2},

$$L = \frac{{K}_{1}}{2}$$

where K₁=α×P_{CSIRS}, and codebook parameters (M,α,β) are configured from Table 2.

TABLE 2

| paramCombination-r17 | M | α | β |
|---|---|---|---|
| 1 | 1 | ¾ | ½ |
| 2 | 1 | 1 | ½ |
| 3 | 1 | 1 | ¾ |
| 4 | 1 | 1 | 1 |
| 5 | 2 | ½ | ½ |
| 6 | 2 | ¾ | ½ |
| 7 | 2 | 1 | ½ |
| 8 | 2 | 1 | ¾ |

The above-mentioned framework (Eq. 5) represents the precoding-matrices for multiple (N₃) FD units using a linear combination (double sum) over 2 L (or K₁) SD beams/ports and M_{υ} FD beams. This framework can also be used to represent the precoding-matrices in time domain (TD) by replacing the FD basis matrix W_{f} with a TD basis matrix Wₜ, wherein the columns of Wₜ comprises M_{υ} TD beams that represent some form of delays or channel tap locations. Hence, a precoder W^{l} can be described as follows.

$$W = {A}_{l} {C}_{l} {B}_{l}^{H} = {W}_{1} {\tilde{W}}_{2} {W}_{t}^{H} , \qquad ( Eq . 5 A )$$

In one example, the M_{υ} TD beams (representing delays or channel tap locations) are selected from a set of N₃ TD beams, i.e., N₃ corresponds to the maximum number of TD units, where each TD unit corresponds to a delay or channel tap location. In one example, a TD beam corresponds to a single delay or channel tap location. In another example, a TD beam corresponds to multiple delays or channel tap locations. In another example, a TD beam corresponds to a combination of multiple delays or channel tap locations.

In one example, the codebook for the CSI report is according to at least one of the following examples.
In one example, the codebook can be a Rel. 15 Type I single-panel codebook (cf. 5.2.2.2.1, TS 38.214).
In one example, the codebook can be a Rel. 15 Type I multi-panel codebook (cf. 5.2.2.2.2, TS 38.214).
In one example, the codebook can be a Rel. 15 Type II codebook (cf. 5.2.2.2.3, TS 38.214).
In one example, the codebook can be a Rel. 15 port selection Type II codebook (cf. 5.2.2.2.4, TS 38.214).
In one example, the codebook can be a Rel. 16 enhanced Type II codebook (cf. 5.2.2.2.5, TS 38.214).
In one example, the codebook can be a Rel. 16 enhanced port selection Type II codebook (cf. 5.2.2.2.6, TS 38.214).
In one example, the codebook can be a Rel. 17 further enhanced port selection Type II codebook (cf. 5.2.2.2.7, TS 38.214).
In one example, the codebook is a new codebook for C-JT CSI reporting.
   In one example, the new codebook is a decoupled codebook comprising the following components:
      Intra-TRP: per TRP Rel. 16/17 Type II codebook components, i.e., SD basis vectors (W1), FD basis vectors (Wf), W2 components (e.g., SCI, indices of NZ coefficients, and amplitude/phase of NZ coefficients).
      Inter-TRP: co-amplitude and co-phase for each TRP.
   In one example, the new codebook is a joint codebook comprising following components
      Per TRP SD basis vectors (W1)
      Single joint FD basis vectors (Wf)
      Single joint W2 components (e.g., SCI, indices of NZ coefficients, and amplitude/phase of NZ coefficients)

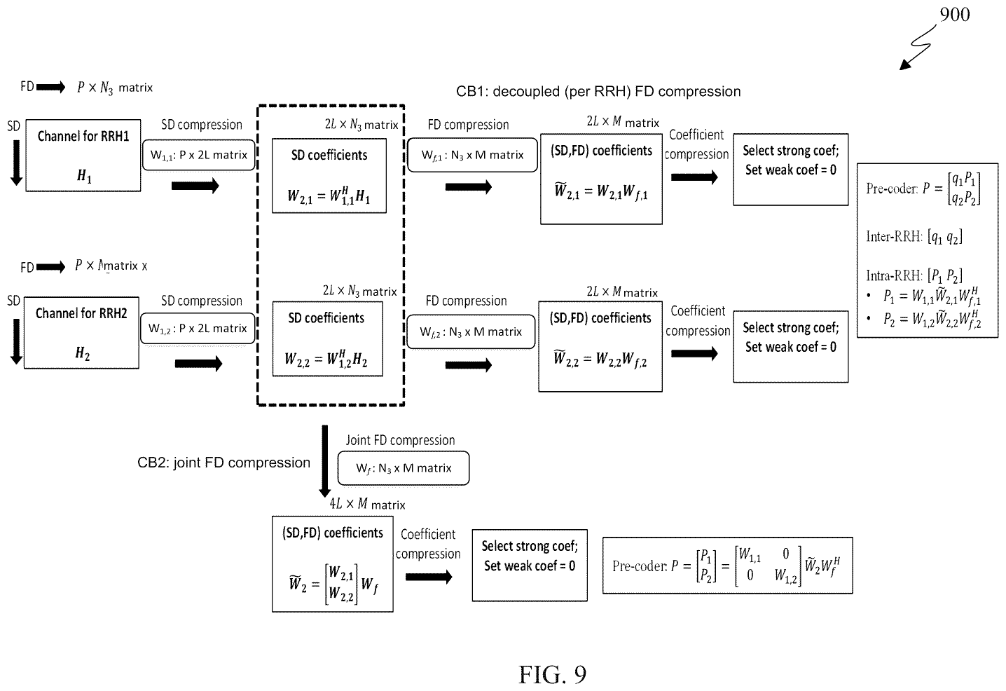

FIG. 9 illustrates two new codebooks 900 according to embodiments of the present disclosure. The embodiment of the two new codebooks 900 illustrated in FIG. 9 is for illustration only. FIG. 9 does not limit the scope of the present disclosure to any particular implementation of the two new codebooks 900.

In one example, when the codebook is a legacy codebook (e.g., one of Rel. 15/16/17 NR codebooks, according to one of the examples above), then the CSI reporting is based on a CSI resource set comprising one or multiple NZP CSI-RS resource(s), where each NZP CSI-RS resource comprises CSI-RS antenna ports for all TRPs/RRHs, i.e., P=Σᵣ₌₁^{N}Pᵣ, where P is the total number of antenna ports, and Pᵣ is the number of antenna ports associated with r-th TRP. In this case, a TRP corresponds to (or maps to or is associated with) a group of antenna ports.

In one example, when the codebook is a new codebook (e.g., one of the two new codebooks above), then the CSI reporting is based on a CSI resource set comprising one or multiple NZP CSI-RS resource(s).
In one example, each NZP CSI-RS resource comprises CSI-RS antenna ports for all TRPs/RRHs. i.e., P=Σᵣ₌₁^{N}Pᵣ, where P is the total number of antenna ports, and Pᵣ is the number of antenna ports associated with r-th TRP. In this case, a TRP corresponds to (or maps to or is associated with) a group of antenna ports. A TRP group is a group of multiple TRPs.
In one example, each NZP CSI-RS resource corresponds to (or maps to or is associated with) a TRP/RRH.

In one embodiment, a UE is configured with an mTRP (or D-MIMO or C-JT) codebook, via e.g., higher layer parameter codebookType set to ‘typeII-r18-cjt’, which is designed based on Rel-16/17 Type-II codebook. For example, The mTRP codebook has a triple-stage structure which can be represented as W=W₁W₂W_{f}^{H}, where the component W₁ is used to report/indicate a spatial-domain (SD) basis matrix comprising SD basis vectors, the component W_{f} is used to report/indicate a frequency-domain (FD) basis matrix comprising FD basis vectors, and the component W₂ is used to report/indicate coefficients corresponding to SD and FD basis vectors.

In one example, in Rel-16 Type-II codebook, L vectors, vₘ_{₁}_{⁽ⁱ⁾}_{, m}_{₂}_{⁽ⁱ⁾}, i=0, 1, . . . , L−1, are identified by the indices q₁, q₂, n₁, n₂, indicated by i_{1,1}, i_{1,2}, obtained as in 5.2.2.2.3, where the values of C(x,y) are given in Table 5.2.2.2.5-4 of [9].

In one example, in Rel-17 Type-II codebook, K₁ ports are selected from P_{CSI-RS} ports based on L vectors, vₘ_{⁽ⁱ⁾}, i=0, 1, . . . , L−1, which are identified by

$$m = [ {m}^{( 0 )} … {m}^{( L - 1 )} ]$$

$${m}^{( i )} ∈ \{ 0 , 1 , … , \frac{{P}_{C S 1 - R S}}{2} - 1 \}$$

which are indicated by the index i_{1,2}, where

$${i}_{1 , 2} ∈ \{ 0 , 1 , … , ( \begin{matrix}{P}_{C S 1 ‐ R S} / 2 \\ L\end{matrix} ) - 1 \} .$$

The elements of m are found from i_{1,2} using C(x,y) as defined in Tables 5.2.2.2.5-4 and 5.2.2.2.7-2 and the algorithm:

In one embodiment, on the SD basis selection for (Rel-18) Type-II codebook refinement for CJT mTRP, which is designed based on Rel-17 Type-II port-selection codebook, a set of N_{L}≥1 combinations of values for {αₙ, n=1, . . . , N_{TRP}} is configured by the NW via higher-layer (RRC) signaling, where N_{TRP} is a number of TRPs (CSI-RS resources) configured by the NW. The N_{L} combinations of value(s) for {αₙ, n=1, . . . , N_{TRP}} can be signaled by using a joint indicator or multiple separate indicators. In one example, N_{L}=1. In another example, N_{L}>1.

In one example, Lₙ=αₙP_{CSI-RS,n}/2 where P_{CSI-RS,n} is a number of CSI-RS ports for CSI-RS resource n (or CSI-RS port group n or TRP n). In one example, P_{CSI-RS}-P_{CSI-RS,n} for all n.

In one example, {αₙ} values can be configured based on at least one of the tables (or any table (i.e., a sub-table, or whole table) that can be constructed as) described in the present disclosure.

In one example, N_{L} can be explicitly configured via higher-layer (RRC) signaling with a separate parameter. The possible values for N_{L} are a set of [symbol] . Let denote a total number of a table including combinations of values for {αₙ, n=1, . . . , N_{TRP}} by N_{T}. In one example,

$$⌈ {log}_{2} ( \begin{matrix}{N}_{T} \\ {N}_{L}\end{matrix} ) ⌉$$

bit size parameter can be used to indicate N_{L} combinations of values for {αₙ, n=1, . . . , N_{TRP}}. In one example, the table can be any table (whole table or a sub-table) described in the present disclosure or any table that can be constructed as described in the present disclosure.

In one example, N_{L} is implicitly determined or configured via higher-layer RRC signaling.
In one example, an N_{T}-bit bitmap is used to indicate N_{L} combinations of values for {αₙ, n=1, . . . , N_{TRP}}, and N_{L} can be inferred from the configured N_{T}-bit bitmap.
In one example, N_{L} combinations of values for {αₙ, n=1, . . . , N_{TRP}} are determined from the configured {αₙ} values and its associated αₜₒₜ value (or a function of {αₙ}). For example, one combination of the values for {αₙ, n=1, . . . , N_{TRP}} is configured, and other combinations of the values for {αₙ, n=1, . . . , N_{TRP}} associated with the same αₜₒₜ for the configured combination are determined as N_{L}−1 combinations of values {αₙ, n=1, . . . , N_{TRP}}, where

$${α}_{tot} = {Σ}_{n = 1}^{{N}_{T R P}} \frac{{a}_{n}}{{N}_{T R P}} or {α}_{tot} = {Σ}_{n = 1}^{N} \frac{{a}_{n}}{N} .$$

In one example, N_{L} combinations of values for {αₙ, n=1, . . . , N_{TRP}} are determined from the configured {αₙ} values and its associated value of

$${α}_{max} = {Σ}_{n = 1}^{{N}_{T R P}} \frac{{a}_{n}}{{N}_{N T R P}} or {Σ}_{n = 1}^{N} \frac{{a}_{n}}{N}$$

(or a function of {αₙ}). For example, one combination of the values for {αₙ, n=1, . . . , N_{TRP}} is configured, and other combinations of the values for {αₙ, n=1, . . . , N_{TRP}} such that

$${α}_{max} \geq {Σ}_{n = 1}^{{N}_{T R P}} \frac{{a}_{n}}{{N}_{N T R P}} or {α}_{max} \geq {Σ}_{n = 1}^{N} \frac{{a}_{n}}{N}$$

for the configured combination are determined as N_{L}−1 combinations of values {αₙ, n=1, . . . , N_{TRP}}.
In one example, N_{L} combinations of values for {αₙ, n=1, . . . , N_{TRP}} are determined from the configured {αₙ} values and another configured value of αₘₐₓ. For example, one combination of the values for {αₙ, n=1, . . . , N_{TRP}} is configured, and other combinations of the values for {αₙ, n=1, . . . , N_{TRP}} such that

$${α}_{max} \geq {Σ}_{n = 1}^{{N}_{T R P}} \frac{{a}_{n}}{{N}_{N T R P}} or {α}_{max} \geq {Σ}_{n = 1}^{N} \frac{{a}_{n}}{N}$$

for the configured combination are determined as N_{L}−1 combinations of values {αₙ, n=1, . . . , N_{TRP}}.

In one example, when N_{L}>1, a UE reports an indicator with the size of ┌log₂ N_{L}┐-bit to indicate one selected combination of values for {αₙ, n=1, . . . , N_{TRP}} in CSI part 1. In one example, when N_{L}=1, a UE follows the configured {αₙ} values, hence no report is needed for {αₙ} values.

In one example, N_{L} combinations of {αₙ} is subject to the UE capability on

$${α}_{tot} = {Σ}_{n = 1}^{N} \frac{{a}_{n}}{N} or {α}_{max} \geq {Σ}_{n = 1}^{N} \frac{{a}_{n}}{N} .$$

In one example, N_{L} combinations of {αₙ} is subject to the UE capability on

$${α}_{tot} = {Σ}_{n = 1}^{{N}_{T R P}} \frac{{a}_{n}}{{N}_{T R P}} or {α}_{max} \geq {Σ}_{n = 1}^{{N}_{T R P}} \frac{{a}_{n}}{{N}_{T R P}} .$$

### On Parameter Combination Table

In one embodiment, a UE is configured with a CSI report (e.g., via higher layer CSI-ReportConfig) based on a codebook for C-JT transmission from multiple TRPs, as described in the present disclosure, where codebook parameters (such as α or L, β, p_{υ} or M_{υ}) are configured via a higher-layer parameter ‘paramCombination-r18’ or ‘paramCombinationCJT-r18’.
In one example, the Rel. 16 parameter combination table for ‘paraCombination-r16’ is reused for ‘paramCombination-r18’ (cf. Table 1).
In one example, the Rel. 17 parameter combination table for ‘paraCombination-r17’ is reused for ‘paramCombination-r18’ (cf. Table 2).
In one example, a new table of parameter combination is used for ‘paramCombination-r18’.
In one example, a table including existing Rel. 16 or Rel. 17 parameter combination(s) and new parameter combination(s) is used for ‘paramCombination-r18’.

Any table including at least one of the combinations provided in the (sub)-tables in the present disclosure can be an example for the table of ‘paraCombination-r18’.

In one embodiment, a table used for ‘paramCombination-r18’ is designed based on the following parameter candidates:
Candidate values for αₙ:

$$𝒜 = \{ \frac{1}{2} , \frac{3}{4} , 1 \}$$

where αₙ is α for CSI-RS resource n (TRP n); and
N_{TRP}∈{1,2,3,4} is a number of CSI-RS resources (or TRPs) and is configured by the NW via higher-layer signaling.
Candidate values for M: [symbol] ={1,2,3,4}
Candidate values for β: [symbol] ={⅛,¼,⅜,½,¼,1}

In one example, any table including at least one of the combinations provided in the tables in the present disclosure can be an example for a table of ‘paraCombination-r18’.

In one example, {αₙ} values can be configured based on at least one of the tables (or any table (i.e., sub-table, whole table) that can be constructed as) described in the present disclosure.

In one example, N_{L} can be explicitly configured via higher-layer (RRC) signaling with a separate parameter. The possible values for N_{L} are a set of [symbol] . Let denote a total number of a table including combinations of values for {αₙ, n=1, . . . , N_{TRP}} by N_{T}. In one example,

$$⌈ {log}_{2} ( \begin{matrix}{N}_{T} \\ {N}_{L}\end{matrix} ) ⌉$$

bit size parameter can be configured to indicate N_{L} combinations of values for {Lₙ, n=1, . . . , N_{TRP}}. In one example, the table can be any table (whole table or sub-table) described in the present disclosure or any table that can be constructed as described in the present disclosure.

In one example, N_{T} combinations of values for {αₙ} can be configured by using Table 3 or Table 3A or a sub-table including at least one of the rows in Table 3 or Table 3A.

TABLE 3

| Index | N_{TRP} (or N) | α₁ | α₂ | α₃ | α₄ |
|---|---|---|---|---|---|
| 1 | 1 | 0.50 | | | |
| 2 | | 0.75 | | | |
| 3 | | 1.00 | | | |
| 4 | 2 | 0.50 | 0.50 | | |
| 5 | | 0.50 | 0.75 | | |
| 6 | | 0.50 | 1.00 | | |
| 7 | | 0.75 | 0.50 | | |
| 8 | | 0.75 | 0.75 | | |
| 9 | | 0.75 | 1.00 | | |
| 10 | | 1.00 | 0.50 | | |
| 11 | | 1.00 | 0.75 | | |
| 12 | | 1.00 | 1.00 | | |
| 13 | 3 | 0.50 | 0.50 | 0.50 | |
| 14 | | 0.50 | 0.50 | 0.75 | |
| 15 | | 0.50 | 0.50 | 1.00 | |
| 16 | | 0.50 | 0.75 | 0.50 | |
| 17 | | 0.50 | 0.75 | 0.75 | |
| 18 | | 0.50 | 0.75 | 1.00 | |
| 19 | | 0.50 | 1.00 | 0.50 | |
| 20 | | 0.50 | 1.00 | 0.75 | |
| 21 | | 0.50 | 1.00 | 1.00 | |
| 22 | | 0.75 | 0.50 | 0.50 | |
| 23 | | 0.75 | 0.50 | 0.75 | |
| 24 | | 0.75 | 0.50 | 1.00 | |
| 25 | | 0.75 | 0.75 | 0.50 | |
| 26 | | 0.75 | 0.75 | 0.75 | |
| 27 | | 0.75 | 0.75 | 1.00 | |
| 28 | | 0.75 | 1.00 | 0.50 | |
| 29 | | 0.75 | 1.00 | 0.75 | |
| 30 | | 0.75 | 1.00 | 1.00 | |
| 31 | | 1.00 | 0.50 | 0.50 | |
| 32 | | 1.00 | 0.50 | 0.75 | |
| 33 | | 1.00 | 0.50 | 1.00 | |
| 34 | | 1.00 | 0.75 | 0.50 | |
| 35 | | 1.00 | 0.75 | 0.75 | |
| 36 | | 1.00 | 0.75 | 1.00 | |
| 37 | | 1.00 | 1.00 | 0.50 | |
| 38 | | 1.00 | 1.00 | 0.75 | |
| 39 | | 1.00 | 1.00 | 1.00 | |
| 40 | 4 | 0.50 | 0.50 | 0.50 | 0.50 |
| 41 | | 0.50 | 0.50 | 0.50 | 0.75 |
| 42 | | 0.50 | 0.50 | 0.50 | 1.00 |
| 43 | | 0.50 | 0.50 | 0.75 | 0.50 |
| 44 | | 0.50 | 0.50 | 0.75 | 0.75 |
| 45 | | 0.50 | 0.50 | 0.75 | 1.00 |
| 46 | | 0.50 | 0.50 | 1.00 | 0.50 |
| 47 | | 0.50 | 0.50 | 1.00 | 0.75 |
| 48 | | 0.50 | 0.50 | 1.00 | 1.00 |
| 49 | | 0.50 | 0.75 | 0.50 | 0.50 |
| 50 | | 0.50 | 0.75 | 0.50 | 0.75 |
| 51 | | 0.50 | 0.75 | 0.50 | 1.00 |
| 52 | | 0.50 | 0.75 | 0.75 | 0.50 |
| 53 | | 0.50 | 0.75 | 0.75 | 0.75 |
| 54 | | 0.50 | 0.75 | 0.75 | 1.00 |
| 55 | | 0.50 | 0.75 | 1.00 | 0.50 |
| 56 | | 0.50 | 0.75 | 1.00 | 0.75 |
| 57 | | 0.50 | 0.75 | 1.00 | 1.00 |
| 58 | | 0.50 | 1.00 | 0.50 | 0.50 |
| 59 | | 0.50 | 1.00 | 0.50 | 0.75 |
| 60 | | 0.50 | 1.00 | 0.50 | 1.00 |
| 61 | | 0.50 | 1.00 | 0.75 | 0.50 |
| 62 | | 0.50 | 1.00 | 0.75 | 0.75 |
| 63 | | 0.50 | 1.00 | 0.75 | 1.00 |
| 64 | | 0.50 | 1.00 | 1.00 | 0.50 |
| 65 | | 0.50 | 1.00 | 1.00 | 0.75 |
| 66 | | 0.50 | 1.00 | 1.00 | 1.00 |
| 67 | | 0.75 | 0.50 | 0.50 | 0.50 |
| 68 | | 0.75 | 0.50 | 0.50 | 0.75 |
| 69 | | 0.75 | 0.50 | 0.50 | 1.00 |
| 70 | | 0.75 | 0.50 | 0.75 | 0.50 |
| 71 | | 0.75 | 0.50 | 0.75 | 0.75 |
| 72 | | 0.75 | 0.50 | 0.75 | 1.00 |
| 73 | | 0.75 | 0.50 | 1.00 | 0.50 |
| 74 | | 0.75 | 0.50 | 1.00 | 0.75 |
| 75 | | 0.75 | 0.50 | 1.00 | 1.00 |
| 76 | | 0.75 | 0.75 | 0.50 | 0.50 |
| 77 | | 0.75 | 0.75 | 0.50 | 0.75 |
| 78 | | 0.75 | 0.75 | 0.50 | 1.00 |
| 79 | | 0.75 | 0.75 | 0.75 | 0.50 |
| 80 | | 0.75 | 0.75 | 0.75 | 0.75 |
| 81 | | 0.75 | 0.75 | 0.75 | 1.00 |
| 82 | | 0.75 | 0.75 | 1.00 | 0.50 |
| 83 | | 0.75 | 0.75 | 1.00 | 0.75 |
| 84 | | 0.75 | 0.75 | 1.00 | 1.00 |
| 85 | | 0.75 | 1.00 | 0.50 | 0.50 |
| 86 | | 0.75 | 1.00 | 0.50 | 0.75 |
| 87 | | 0.75 | 1.00 | 0.50 | 1.00 |
| 88 | | 0.75 | 1.00 | 0.75 | 0.50 |
| 89 | | 0.75 | 1.00 | 0.75 | 0.75 |
| 90 | | 0.75 | 1.00 | 0.75 | 1.00 |
| 91 | | 0.75 | 1.00 | 1.00 | 0.50 |
| 92 | | 0.75 | 1.00 | 1.00 | 0.75 |
| 93 | | 0.75 | 1.00 | 1.00 | 1.00 |
| 94 | | 1.00 | 0.50 | 0.50 | 0.50 |
| 95 | | 1.00 | 0.50 | 0.50 | 0.75 |
| 96 | | 1.00 | 0.50 | 0.50 | 1.00 |
| 97 | | 1.00 | 0.50 | 0.75 | 0.50 |
| 98 | | 1.00 | 0.50 | 0.75 | 0.75 |
| 99 | | 1.00 | 0.50 | 0.75 | 1.00 |
| 100 | | 1.00 | 0.50 | 1.00 | 0.50 |
| 101 | | 1.00 | 0.50 | 1.00 | 0.75 |
| 102 | | 1.00 | 0.50 | 1.00 | 1.00 |
| 103 | | 1.00 | 0.75 | 0.50 | 0.50 |
| 104 | | 1.00 | 0.75 | 0.50 | 0.75 |
| 105 | | 1.00 | 0.75 | 0.50 | 1.00 |
| 106 | | 1.00 | 0.75 | 0.75 | 0.50 |
| 107 | | 1.00 | 0.75 | 0.75 | 0.75 |
| 108 | | 1.00 | 0.75 | 0.75 | 1.00 |
| 109 | | 1.00 | 0.75 | 1.00 | 0.50 |
| 110 | | 1.00 | 0.75 | 1.00 | 0.75 |
| 111 | | 1.00 | 0.75 | 1.00 | 1.00 |
| 112 | | 1.00 | 1.00 | 0.50 | 0.50 |
| 113 | | 1.00 | 1.00 | 0.50 | 0.75 |
| 114 | | 1.00 | 1.00 | 0.50 | 1.00 |
| 115 | | 1.00 | 1.00 | 0.75 | 0.50 |
| 116 | | 1.00 | 1.00 | 0.75 | 0.75 |
| 117 | | 1.00 | 1.00 | 0.75 | 1.00 |
| 118 | | 1.00 | 1.00 | 1.00 | 0.50 |
| 119 | | 1.00 | 1.00 | 1.00 | 0.75 |
| 120 | | 1.00 | 1.00 | 1.00 | 1.00 |

TABLE 3A
TRP

| Index | N_{TRP} (or N) | α₁ | α₂ | α₃ | α₄ | f({αₙ}) |
|---|---|---|---|---|---|---|
| 1 | 1 | 0.50 | | | | . . . |
| 2 | | 0.75 | | | | . . . |
| 3 | | 1.00 | | | | . . . |
| 4 | 2 | 0.50 | 0.50 | | | . . . |
| 5 | | 0.50 | 0.75 | | | . . . |
| 6 | | 0.50 | 1.00 | | | . . . |
| 7 | | 0.75 | 0.50 | | | . . . |
| 8 | | 0.75 | 0.75 | | | . . . |
| 9 | | 0.75 | 1.00 | | | . . . |
| 10 | | 1.00 | 0.50 | | | . . . |
| 11 | | 1.00 | 0.75 | | | . . . |
| 12 | | 1.00 | 1.00 | | | . . . |
| 13 | 3 | 0.50 | 0.50 | 0.50 | | . . . |
| 14 | | 0.50 | 0.50 | 0.75 | | . . . |
| 15 | | 0.50 | 0.50 | 1.00 | | . . . |
| 16 | | 0.50 | 0.75 | 0.50 | | . . . |
| 17 | | 0.50 | 0.75 | 0.75 | | . . . |
| 18 | | 0.50 | 0.75 | 1.00 | | . . . |
| 19 | | 0.50 | 1.00 | 0.50 | | . . . |
| 20 | | 0.50 | 1.00 | 0.75 | | . . . |
| 21 | | 0.50 | 1.00 | 1.00 | | . . . |
| 22 | | 0.75 | 0.50 | 0.50 | | . . . |
| 23 | | 0.75 | 0.50 | 0.75 | | . . . |
| 24 | | 0.75 | 0.50 | 1.00 | | . . . |
| 25 | | 0.75 | 0.75 | 0.50 | | . . . |
| 26 | | 0.75 | 0.75 | 0.75 | | . . . |
| 27 | | 0.75 | 0.75 | 1.00 | | . . . |
| 28 | | 0.75 | 1.00 | 0.50 | | . . . |
| 29 | | 0.75 | 1.00 | 0.75 | | . . . |
| 30 | | 0.75 | 1.00 | 1.00 | | . . . |
| 31 | | 1.00 | 0.50 | 0.50 | | . . . |
| 32 | | 1.00 | 0.50 | 0.75 | | . . . |
| 33 | | 1.00 | 0.50 | 1.00 | | . . . |
| 34 | | 1.00 | 0.75 | 0.50 | | . . . |
| 35 | | 1.00 | 0.75 | 0.75 | | . . . |
| 36 | | 1.00 | 0.75 | 1.00 | | . . . |
| 37 | | 1.00 | 1.00 | 0.50 | | . . . |
| 38 | | 1.00 | 1.00 | 0.75 | | . . . |
| 39 | | 1.00 | 1.00 | 1.00 | | . . . |
| 40 | 4 | 0.50 | 0.50 | 0.50 | 0.50 | . . . |
| 41 | | 0.50 | 0.50 | 0.50 | 0.75 | . . . |
| 42 | | 0.50 | 0.50 | 0.50 | 1.00 | . . . |
| 43 | | 0.50 | 0.50 | 0.75 | 0.50 | . . . |
| 44 | | 0.50 | 0.50 | 0.75 | 0.75 | . . . |
| 45 | | 0.50 | 0.50 | 0.75 | 1.00 | . . . |
| 46 | | 0.50 | 0.50 | 1.00 | 0.50 | . . . |
| 47 | | 0.50 | 0.50 | 1.00 | 0.75 | . . . |
| 48 | | 0.50 | 0.50 | 1.00 | 1.00 | . . . |
| 49 | | 0.50 | 0.75 | 0.50 | 0.50 | . . . |
| 50 | | 0.50 | 0.75 | 0.50 | 0.75 | . . . |
| 51 | | 0.50 | 0.75 | 0.50 | 1.00 | . . . |
| 52 | | 0.50 | 0.75 | 0.75 | 0.50 | . . . |
| 53 | | 0.50 | 0.75 | 0.75 | 0.75 | . . . |
| 54 | | 0.50 | 0.75 | 0.75 | 1.00 | . . . |
| 55 | | 0.50 | 0.75 | 1.00 | 0.50 | . . . |
| 56 | | 0.50 | 0.75 | 1.00 | 0.75 | . . . |
| 57 | | 0.50 | 0.75 | 1.00 | 1.00 | . . . |
| 58 | | 0.50 | 1.00 | 0.50 | 0.50 | . . . |
| 59 | | 0.50 | 1.00 | 0.50 | 0.75 | . . . |
| 60 | | 0.50 | 1.00 | 0.50 | 1.00 | . . . |
| 61 | | 0.50 | 1.00 | 0.75 | 0.50 | . . . |
| 62 | | 0.50 | 1.00 | 0.75 | 0.75 | . . . |
| 63 | | 0.50 | 1.00 | 0.75 | 1.00 | . . . |
| 64 | | 0.50 | 1.00 | 1.00 | 0.50 | . . . |
| 65 | | 0.50 | 1.00 | 1.00 | 0.75 | . . . |
| 66 | | 0.50 | 1.00 | 1.00 | 1.00 | . . . |
| 67 | | 0.75 | 0.50 | 0.50 | 0.50 | . . . |
| 68 | | 0.75 | 0.50 | 0.50 | 0.75 | . . . |
| 69 | | 0.75 | 0.50 | 0.50 | 1.00 | . . . |
| 70 | | 0.75 | 0.50 | 0.75 | 0.50 | . . . |
| 71 | | 0.75 | 0.50 | 0.75 | 0.75 | . . . |
| 72 | | 0.75 | 0.50 | 0.75 | 1.00 | . . . |
| 73 | | 0.75 | 0.50 | 1.00 | 0.50 | . . . |
| 74 | | 0.75 | 0.50 | 1.00 | 0.75 | . . . |
| 75 | | 0.75 | 0.50 | 1.00 | 1.00 | . . . |
| 76 | | 0.75 | 0.75 | 0.50 | 0.50 | . . . |
| 77 | | 0.75 | 0.75 | 0.50 | 0.75 | . . . |
| 78 | | 0.75 | 0.75 | 0.50 | 1.00 | . . . |
| 79 | | 0.75 | 0.75 | 0.75 | 0.50 | . . . |
| 80 | | 0.75 | 0.75 | 0.75 | 0.75 | . . . |
| 81 | | 0.75 | 0.75 | 0.75 | 1.00 | . . . |
| 82 | | 0.75 | 0.75 | 1.00 | 0.50 | . . . |
| 83 | | 0.75 | 0.75 | 1.00 | 0.75 | . . . |
| 84 | | 0.75 | 0.75 | 1.00 | 1.00 | . . . |
| 85 | | 0.75 | 1.00 | 0.50 | 0.50 | . . . |
| 86 | | 0.75 | 1.00 | 0.50 | 0.75 | . . . |
| 87 | | 0.75 | 1.00 | 0.50 | 1.00 | . . . |
| 88 | | 0.75 | 1.00 | 0.75 | 0.50 | . . . |
| 89 | | 0.75 | 1.00 | 0.75 | 0.75 | . . . |
| 90 | | 0.75 | 1.00 | 0.75 | 1.00 | . . . |
| 91 | | 0.75 | 1.00 | 1.00 | 0.50 | . . . |
| 92 | | 0.75 | 1.00 | 1.00 | 0.75 | . . . |
| 93 | | 0.75 | 1.00 | 1.00 | 1.00 | . . . |
| 94 | | 1.00 | 0.50 | 0.50 | 0.50 | . . . |
| 95 | | 1.00 | 0.50 | 0.50 | 0.75 | . . . |
| 96 | | 1.00 | 0.50 | 0.50 | 1.00 | . . . |
| 97 | | 1.00 | 0.50 | 0.75 | 0.50 | . . . |
| 98 | | 1.00 | 0.50 | 0.75 | 0.75 | . . . |
| 99 | | 1.00 | 0.50 | 0.75 | 1.00 | . . . |
| 100 | | 1.00 | 0.50 | 1.00 | 0.50 | . . . |
| 101 | | 1.00 | 0.50 | 1.00 | 0.75 | . . . |
| 102 | | 1.00 | 0.50 | 1.00 | 1.00 | . . . |
| 103 | | 1.00 | 0.75 | 0.50 | 0.50 | . . . |
| 104 | | 1.00 | 0.75 | 0.50 | 0.75 | . . . |
| 105 | | 1.00 | 0.75 | 0.50 | 1.00 | . . . |
| 106 | | 1.00 | 0.75 | 0.75 | 0.50 | . . . |
| 107 | | 1.00 | 0.75 | 0.75 | 0.75 | . . . |
| 108 | | 1.00 | 0.75 | 0.75 | 1.00 | . . . |
| 109 | | 1.00 | 0.75 | 1.00 | 0.50 | . . . |
| 110 | | 1.00 | 0.75 | 1.00 | 0.75 | . . . |
| 111 | | 1.00 | 0.75 | 1.00 | 1.00 | . . . |
| 112 | | 1.00 | 1.00 | 0.50 | 0.50 | . . . |
| 113 | | 1.00 | 1.00 | 0.50 | 0.75 | . . . |
| 114 | | 1.00 | 1.00 | 0.50 | 1.00 | . . . |
| 115 | | 1.00 | 1.00 | 0.75 | 0.50 | . . . |
| 116 | | 1.00 | 1.00 | 0.75 | 0.75 | . . . |
| 117 | | 1.00 | 1.00 | 0.75 | 1.00 | . . . |
| 118 | | 1.00 | 1.00 | 1.00 | 0.50 | . . . |
| 119 | | 1.00 | 1.00 | 1.00 | 0.75 | . . . |
| 120 | | 1.00 | 1.00 | 1.00 | 1.00 | . . . |

Although a decimal form is used for {αₙ} in Table 3 and for {αₙ}, f({αₙ}) in Table 3A, it can be denoted in a fractional form, e.g., ½, ¾, 1 instead of 0.50, 0.75, 1.

In one example, in Table 3A,

$$f ( \{ {α}_{n} \} ) = {max}_{n} \{ {α}_{n} \} ,$$

where the max value among {αₙ} in each row is in the column of f({αₙ}).

In one example, in Table 3A,

$$f ( \{ {α}_{n} \} ) = {min}_{n} \{ {α}_{n} \} ,$$

where the min value among {αₙ} in each row is in the column of f({αₙ}).

In one example, in Table 3A,

$$f ( \{ {α}_{n} \} ) = {\sum }_{n = 1}^{{N}_{TRP}} \frac{{α}_{n}}{{N}_{TRP}} ,$$

where the average value of {αₙ} in each row is in the column of f({αₙ}).

In one example, in Table 3A,

$$f ( \{ {α}_{n} \} ) \geq {\sum }_{n = 1}^{{N}_{TRP}} \frac{{α}_{n}}{{N}_{TRP}} ,$$

where an upper bound of the average value of {αₙ} in each row is in the column of f({αₙ}).

In one example, in table 3a, f({αₙ})=Σₙ₌₁^{N}^{_{TRP}}αₙ, where the average value of {αₙ} in each row is in the column of f({αₙ}).

In one example, in Table 3A, f({αₙ})≥Σₙ₌₁^{N}^{_{TRP}}αₙ, where an upper bound of the average value of {αₙ} in each row is in the column of f({αₙ}).

In one example, in Table 3A, f({αₙ}) can be replaced by another parameter such as αₜₒₜ, αₘₐₓ, αₛᵤₘ, αₘᵢₙ, α̅, \tilde{α}, and so on.

In one example, a sub-table of Table 3 excluding the column of N_{TRP} can be an example for a table of ‘paraCombination-r18’.

In one example, a sub-table of Table 3 excluding the column of N_{TRP} and/or inserting 0s in the blanks can be an example for a table of ‘paraCombination-r18’.

In one example, a sub-table of Table 3 can be as follows:

| Index | N_{TRP} (or N) | α₁ | α₂ | α₃ | α₄ |
|---|---|---|---|---|---|
| 1 | 1 | 0.50 | | | |
| 2 | | 0.75 | | | |
| 3 | | 1.00 | | | |
| 4 | 2 | 0.50 | 0.50 | | |
| 5 | | 0.50 | 1.00 | | |
| 6 | | 1.00 | 0.50 | | |
| 7 | | 0.75 | 0.75 | | |
| 8 | | 1.00 | 1.00 | | |
| 9 | 3 | 0.50 | 0.50 | 0.50 | |
| 10 | | 0.50 | 0.50 | 0.75 | |
| 11 | | 0.50 | 0.75 | 0.50 | |
| 12 | | 0.75 | 0.50 | 0.50 | |
| 13 | | 0.50 | 0.50 | 1.00 | |
| 14 | | 0.50 | 1.00 | 0.50 | |
| 15 | | 1.00 | 0.50 | 0.50 | |
| 16 | | 1.00 | 1.00 | 1.00 | |
| 17 | 4 | 0.50 | 0.50 | 0.50 | 0.50 |
| 18 | | 0.50 | 0.50 | 0.50 | 1.00 |
| 19 | | 0.50 | 0.50 | 1.00 | 1.00 |
| 20 | | 1.00 | 1.00 | 1.00 | 1.00 |

In one example, a sub-table of Table 3 corresponding to a value of N_{TRP} can be an example for a table of ‘paraCombination-r18’.

For example, for N_{TRP}=1, the following table can be an example.

| Index | N_{TRP} (or N) | α₁ |
|---|---|---|
| 1 | 1 | 0.50 |
| 2 | | 0.75 |
| 3 | | 1.00 |

In another example, the column of N_{TRP} does not exist in the above table. In another example, indexing number can be different.

For example, for N_{TRP}=2, the following table can be an example.

| Index | N_{TRP} (or N) | α₁ | α₂ |
|---|---|---|---|
| 4 | 2 | 0.50 | 0.50 |
| 5 | | 0.50 | 0.75 |
| 6 | | 0.50 | 1.00 |
| 7 | | 0.75 | 0.50 |
| 8 | | 0.75 | 0.75 |
| 9 | | 0.75 | 1.00 |
| 10 | | 1.00 | 0.50 |
| 11 | | 1.00 | 0.75 |
| 12 | | 1.00 | 1.00 |

In another example, the column of N_{TRP} does not exist in the above table. In another example, indexing number can be different.

For example, for N_{TRP}=3, the following table can be an example.

| Index | N_{TRP} (or N) | α₁ | α₂ | α₃ |
|---|---|---|---|---|
| 13 | 3 | 0.50 | 0.50 | 0.50 |
| 14 | | 0.50 | 0.50 | 0.75 |
| 15 | | 0.50 | 0.50 | 1.00 |
| 16 | | 0.50 | 0.75 | 0.50 |
| 17 | | 0.50 | 0.75 | 0.75 |
| 18 | | 0.50 | 0.75 | 1.00 |
| 19 | | 0.50 | 1.00 | 0.50 |
| 20 | | 0.50 | 1.00 | 0.75 |
| 21 | | 0.50 | 1.00 | 1.00 |
| 22 | | 0.75 | 0.50 | 0.50 |
| 23 | | 0.75 | 0.50 | 0.75 |
| 24 | | 0.75 | 0.50 | 1.00 |
| 25 | | 0.75 | 0.75 | 0.50 |
| 26 | | 0.75 | 0.75 | 0.75 |
| 27 | | 0.75 | 0.75 | 1.00 |
| 28 | | 0.75 | 1.00 | 0.50 |
| 29 | | 0.75 | 1.00 | 0.75 |
| 30 | | 0.75 | 1.00 | 1.00 |
| 31 | | 1.00 | 0.50 | 0.50 |
| 32 | | 1.00 | 0.50 | 0.75 |
| 33 | | 1.00 | 0.50 | 1.00 |
| 34 | | 1.00 | 0.75 | 0.50 |
| 35 | | 1.00 | 0.75 | 0.75 |
| 36 | | 1.00 | 0.75 | 1.00 |
| 37 | | 1.00 | 1.00 | 0.50 |
| 38 | | 1.00 | 1.00 | 0.75 |
| 39 | | 1.00 | 1.00 | 1.00 |

In another example, the column of N_{TRP} does not exist in the above table. In another example, indexing number can be different.

For example, for N_{TRP}=4, the following table can be an example.

| Index | N_{TRP} (or N) | α₁ | α₂ | α₃ | α₄ |
|---|---|---|---|---|---|
| 40 | 4 | 0.50 | 0.50 | 0.50 | 0.50 |
| 41 | | 0.50 | 0.50 | 0.50 | 0.75 |
| 42 | | 0.50 | 0.50 | 0.50 | 1.00 |
| 43 | | 0.50 | 0.50 | 0.75 | 0.50 |
| 44 | | 0.50 | 0.50 | 0.75 | 0.75 |
| 45 | | 0.50 | 0.50 | 0.75 | 1.00 |
| 46 | | 0.50 | 0.50 | 1.00 | 0.50 |
| 47 | | 0.50 | 0.50 | 1.00 | 0.75 |
| 48 | | 0.50 | 0.50 | 1.00 | 1.00 |
| 49 | | 0.50 | 0.75 | 0.50 | 0.50 |
| 50 | | 0.50 | 0.75 | 0.50 | 0.75 |
| 51 | | 0.50 | 0.75 | 0.50 | 1.00 |
| 52 | | 0.50 | 0.75 | 0.75 | 0.50 |
| 53 | | 0.50 | 0.75 | 0.75 | 0.75 |
| 54 | | 0.50 | 0.75 | 0.75 | 1.00 |
| 55 | | 0.50 | 0.75 | 1.00 | 0.50 |
| 56 | | 0.50 | 0.75 | 1.00 | 0.75 |
| 57 | | 0.50 | 0.75 | 1.00 | 1.00 |
| 58 | | 0.50 | 1.00 | 0.50 | 0.50 |
| 59 | | 0.50 | 1.00 | 0.50 | 0.75 |
| 60 | | 0.50 | 1.00 | 0.50 | 1.00 |
| 61 | | 0.50 | 1.00 | 0.75 | 0.50 |
| 62 | | 0.50 | 1.00 | 0.75 | 0.75 |
| 63 | | 0.50 | 1.00 | 0.75 | 1.00 |
| 64 | | 0.50 | 1.00 | 1.00 | 0.50 |
| 65 | | 0.50 | 1.00 | 1.00 | 0.75 |
| 66 | | 0.50 | 1.00 | 1.00 | 1.00 |
| 67 | | 0.75 | 0.50 | 0.50 | 0.50 |
| 68 | | 0.75 | 0.50 | 0.50 | 0.75 |
| 69 | | 0.75 | 0.50 | 0.50 | 1.00 |
| 70 | | 0.75 | 0.50 | 0.75 | 0.50 |
| 71 | | 0.75 | 0.50 | 0.75 | 0.75 |
| 72 | | 0.75 | 0.50 | 0.75 | 1.00 |
| 73 | | 0.75 | 0.50 | 1.00 | 0.50 |
| 74 | | 0.75 | 0.50 | 1.00 | 0.75 |
| 75 | | 0.75 | 0.50 | 1.00 | 1.00 |
| 76 | | 0.75 | 0.75 | 0.50 | 0.50 |
| 77 | | 0.75 | 0.75 | 0.50 | 0.75 |
| 78 | | 0.75 | 0.75 | 0.50 | 1.00 |
| 79 | | 0.75 | 0.75 | 0.75 | 0.50 |
| 80 | | 0.75 | 0.75 | 0.75 | 0.75 |
| 81 | | 0.75 | 0.75 | 0.75 | 1.00 |
| 82 | | 0.75 | 0.75 | 1.00 | 0.50 |
| 83 | | 0.75 | 0.75 | 1.00 | 0.75 |
| 84 | | 0.75 | 0.75 | 1.00 | 1.00 |
| 85 | | 0.75 | 1.00 | 0.50 | 0.50 |
| 86 | | 0.75 | 1.00 | 0.50 | 0.75 |
| 87 | | 0.75 | 1.00 | 0.50 | 1.00 |
| 88 | | 0.75 | 1.00 | 0.75 | 0.50 |
| 89 | | 0.75 | 1.00 | 0.75 | 0.75 |
| 90 | | 0.75 | 1.00 | 0.75 | 1.00 |
| 91 | | 0.75 | 1.00 | 1.00 | 0.50 |
| 92 | | 0.75 | 1.00 | 1.00 | 0.75 |
| 93 | | 0.75 | 1.00 | 1.00 | 1.00 |
| 94 | | 1.00 | 0.50 | 0.50 | 0.50 |
| 95 | | 1.00 | 0.50 | 0.50 | 0.75 |
| 96 | | 1.00 | 0.50 | 0.50 | 1.00 |
| 97 | | 1.00 | 0.50 | 0.75 | 0.50 |
| 98 | | 1.00 | 0.50 | 0.75 | 0.75 |
| 99 | | 1.00 | 0.50 | 0.75 | 1.00 |
| 100 | | 1.00 | 0.50 | 1.00 | 0.50 |
| 101 | | 1.00 | 0.50 | 1.00 | 0.75 |
| 102 | | 1.00 | 0.50 | 1.00 | 1.00 |
| 103 | | 1.00 | 0.75 | 0.50 | 0.50 |
| 104 | | 1.00 | 0.75 | 0.50 | 0.75 |
| 105 | | 1.00 | 0.75 | 0.50 | 1.00 |
| 106 | | 1.00 | 0.75 | 0.75 | 0.50 |
| 107 | | 1.00 | 0.75 | 0.75 | 0.75 |
| 108 | | 1.00 | 0.75 | 0.75 | 1.00 |
| 109 | | 1.00 | 0.75 | 1.00 | 0.50 |
| 110 | | 1.00 | 0.75 | 1.00 | 0.75 |
| 111 | | 1.00 | 0.75 | 1.00 | 1.00 |
| 112 | | 1.00 | 1.00 | 0.50 | 0.50 |
| 113 | | 1.00 | 1.00 | 0.50 | 0.75 |
| 114 | | 1.00 | 1.00 | 0.50 | 1.00 |
| 115 | | 1.00 | 1.00 | 0.75 | 0.50 |
| 116 | | 1.00 | 1.00 | 0.75 | 0.75 |
| 117 | | 1.00 | 1.00 | 0.75 | 1.00 |
| 118 | | 1.00 | 1.00 | 1.00 | 0.50 |
| 119 | | 1.00 | 1.00 | 1.00 | 0.75 |
| 120 | | 1.00 | 1.00 | 1.00 | 1.00 |

In another example, the column of N_{TRP} does not exist in the above table. In another example, indexing number can be different.

In one example, a sub-table of any-table described in the present disclosure associated with {αₙ} such that αₙ₁≤αₙ₂ (non-decreasing order) when n1<n2 can be an example for a table of ‘paraCombination-r18’.

In one example, a sub-table of any-table described in the present disclosure associated with {αₙ} such that αₙ₁≥αₙ₂ (non-increasing order) when n1<n2 can be an example for a table of ‘paraCombination-r18’.

In one example, the ordering of the TRPs (or CSI-RS resources) can be configured by the NW, via e.g., RRC, or MAC CE or, DCI.

In one example, {M,β} pair values can be configured based on at least one of the tables (or any table (i.e., sub-table, whole table) that can be constructed as) described in the present disclosure.

In one example, a sub-table of Table 3A excluding the column of N_{TRP} can be an example for a table of ‘paraCombination-r18’.

In one example, a sub-table of Table 3A excluding the column of N_{TRP} and/or inserting 0s in the blanks can be an example for a table of ‘paraCombination-r18’.

In one example, a sub-table of Table 3A corresponding to a value of N_{TRP} can be an example for a table of ‘paraCombination-r18’.

For example, for N_{TRP}=1, the following table can be an example.

| Index | N_{TRP} (or N) | α₁ | f({αₙ}) |
|---|---|---|---|
| 1 | 1 | 0.50 | . . . |
| 2 | | 0.75 | . . . |
| 3 | | 1.00 | . . . |

In another example, the column of N_{TRP} does not exist in the above table. In another example, indexing number can be different.

For example, for N_{TRP}=2, the following table can be an example.

| Index | N_{TRP} (or N) | α₁ | α₂ | f({αₙ}) |
|---|---|---|---|---|
| 4 | 2 | 0.50 | 0.50 | . . . |
| 5 | | 0.50 | 0.75 | . . . |
| 6 | | 0.50 | 1.00 | . . . |
| 7 | | 0.75 | 0.50 | . . . |
| 8 | | 0.75 | 0.75 | . . . |
| 9 | | 0.75 | 1.00 | . . . |
| 10 | | 1.00 | 0.50 | . . . |
| 11 | | 1.00 | 0.75 | . . . |
| 12 | | 1.00 | 1.00 | . . . |

In another example, the column of N_{TRP} does not exist in the above table. In another example, indexing number can be different.

For example, for N_{TRP}=3, the following table can be an example.

| Index | N_{TRP} (or N) | α₁ | α₂ | α₃ | f({αₙ}) |
|---|---|---|---|---|---|
| 13 | 3 | 0.50 | 0.50 | 0.50 | . . . |
| 14 | | 0.50 | 0.50 | 0.75 | . . . |
| 15 | | 0.50 | 0.50 | 1.00 | . . . |
| 16 | | 0.50 | 0.75 | 0.50 | . . . |
| 17 | | 0.50 | 0.75 | 0.75 | . . . |
| 18 | | 0.50 | 0.75 | 1.00 | . . . |
| 19 | | 0.50 | 1.00 | 0.50 | . . . |
| 20 | | 0.50 | 1.00 | 0.75 | . . . |
| 21 | | 0.50 | 1.00 | 1.00 | . . . |
| 22 | | 0.75 | 0.50 | 0.50 | . . . |
| 23 | | 0.75 | 0.50 | 0.75 | . . . |
| 24 | | 0.75 | 0.50 | 1.00 | . . . |
| 25 | | 0.75 | 0.75 | 0.50 | . . . |
| 26 | | 0.75 | 0.75 | 0.75 | . . . |
| 27 | | 0.75 | 0.75 | 1.00 | . . . |
| 28 | | 0.75 | 1.00 | 0.50 | . . . |
| 29 | | 0.75 | 1.00 | 0.75 | . . . |
| 30 | | 0.75 | 1.00 | 1.00 | . . . |
| 31 | | 1.00 | 0.50 | 0.50 | . . . |
| 32 | | 1.00 | 0.50 | 0.75 | . . . |
| 33 | | 1.00 | 0.50 | 1.00 | . . . |
| 34 | | 1.00 | 0.75 | 0.50 | . . . |
| 35 | | 1.00 | 0.75 | 0.75 | . . . |
| 36 | | 1.00 | 0.75 | 1.00 | . . . |
| 37 | | 1.00 | 1.00 | 0.50 | . . . |
| 38 | | 1.00 | 1.00 | 0.75 | . . . |
| 39 | | 1.00 | 1.00 | 1.00 | . . . |

In another example, the column of N_{TRP} does not exist in the above table. In another example, indexing number can be different.

For example, for N_{TRP}=4, the following table can be an example.

| Index | N_{TRP} (or N) | α₁ | α₂ | α₃ | α₄ | f({αₙ}) |
|---|---|---|---|---|---|---|
| 40 | 4 | 0.50 | 0.50 | 0.50 | 0.50 | . . . |
| 41 | | 0.50 | 0.50 | 0.50 | 0.75 | . . . |
| 42 | | 0.50 | 0.50 | 0.50 | 1.00 | . . . |
| 43 | | 0.50 | 0.50 | 0.75 | 0.50 | . . . |
| 44 | | 0.50 | 0.50 | 0.75 | 0.75 | . . . |
| 45 | | 0.50 | 0.50 | 0.75 | 1.00 | . . . |
| 46 | | 0.50 | 0.50 | 1.00 | 0.50 | . . . |
| 47 | | 0.50 | 0.50 | 1.00 | 0.75 | . . . |
| 48 | | 0.50 | 0.50 | 1.00 | 1.00 | . . . |
| 49 | | 0.50 | 0.75 | 0.50 | 0.50 | . . . |
| 50 | | 0.50 | 0.75 | 0.50 | 0.75 | . . . |
| 51 | | 0.50 | 0.75 | 0.50 | 1.00 | . . . |
| 52 | | 0.50 | 0.75 | 0.75 | 0.50 | . . . |
| 53 | | 0.50 | 0.75 | 0.75 | 0.75 | . . . |
| 54 | | 0.50 | 0.75 | 0.75 | 1.00 | . . . |
| 55 | | 0.50 | 0.75 | 1.00 | 0.50 | . . . |
| 56 | | 0.50 | 0.75 | 1.00 | 0.75 | . . . |
| 57 | | 0.50 | 0.75 | 1.00 | 1.00 | . . . |
| 58 | | 0.50 | 1.00 | 0.50 | 0.50 | . . . |
| 59 | | 0.50 | 1.00 | 0.50 | 0.75 | . . . |
| 60 | | 0.50 | 1.00 | 0.50 | 1.00 | . . . |
| 61 | | 0.50 | 1.00 | 0.75 | 0.50 | . . . |
| 62 | | 0.50 | 1.00 | 0.75 | 0.75 | . . . |
| 63 | | 0.50 | 1.00 | 0.75 | 1.00 | . . . |
| 64 | | 0.50 | 1.00 | 1.00 | 0.50 | . . . |
| 65 | | 0.50 | 1.00 | 1.00 | 0.75 | . . . |
| 66 | | 0.50 | 1.00 | 1.00 | 1.00 | . . . |
| 67 | | 0.75 | 0.50 | 0.50 | 0.50 | . . . |
| 68 | | 0.75 | 0.50 | 0.50 | 0.75 | . . . |
| 69 | | 0.75 | 0.50 | 0.50 | 1.00 | . . . |
| 70 | | 0.75 | 0.50 | 0.75 | 0.50 | . . . |
| 71 | | 0.75 | 0.50 | 0.75 | 0.75 | . . . |
| 72 | | 0.75 | 0.50 | 0.75 | 1.00 | . . . |
| 73 | | 0.75 | 0.50 | 1.00 | 0.50 | . . . |
| 74 | | 0.75 | 0.50 | 1.00 | 0.75 | . . . |
| 75 | | 0.75 | 0.50 | 1.00 | 1.00 | . . . |
| 76 | | 0.75 | 0.75 | 0.50 | 0.50 | . . . |
| 77 | | 0.75 | 0.75 | 0.50 | 0.75 | . . . |
| 78 | | 0.75 | 0.75 | 0.50 | 1.00 | . . . |
| 79 | | 0.75 | 0.75 | 0.75 | 0.50 | . . . |
| 80 | | 0.75 | 0.75 | 0.75 | 0.75 | . . . |
| 81 | | 0.75 | 0.75 | 0.75 | 1.00 | . . . |
| 82 | | 0.75 | 0.75 | 1.00 | 0.50 | . . . |
| 83 | | 0.75 | 0.75 | 1.00 | 0.75 | . . . |
| 84 | | 0.75 | 0.75 | 1.00 | 1.00 | . . . |
| 85 | | 0.75 | 1.00 | 0.50 | 0.50 | . . . |
| 86 | | 0.75 | 1.00 | 0.50 | 0.75 | . . . |
| 87 | | 0.75 | 1.00 | 0.50 | 1.00 | . . . |
| 88 | | 0.75 | 1.00 | 0.75 | 0.50 | . . . |
| 89 | | 0.75 | 1.00 | 0.75 | 0.75 | . . . |
| 90 | | 0.75 | 1.00 | 0.75 | 1.00 | . . . |
| 91 | | 0.75 | 1.00 | 1.00 | 0.50 | . . . |
| 92 | | 0.75 | 1.00 | 1.00 | 0.75 | . . . |
| 93 | | 0.75 | 1.00 | 1.00 | 1.00 | . . . |
| 94 | | 1.00 | 0.50 | 0.50 | 0.50 | . . . |
| 95 | | 1.00 | 0.50 | 0.50 | 0.75 | . . . |
| 96 | | 1.00 | 0.50 | 0.50 | 1.00 | . . . |
| 97 | | 1.00 | 0.50 | 0.75 | 0.50 | . . . |
| 98 | | 1.00 | 0.50 | 0.75 | 0.75 | . . . |
| 99 | | 1.00 | 0.50 | 0.75 | 1.00 | . . . |
| 100 | | 1.00 | 0.50 | 1.00 | 0.50 | . . . |
| 101 | | 1.00 | 0.50 | 1.00 | 0.75 | . . . |
| 102 | | 1.00 | 0.50 | 1.00 | 1.00 | . . . |
| 103 | | 1.00 | 0.75 | 0.50 | 0.50 | . . . |
| 104 | | 1.00 | 0.75 | 0.50 | 0.75 | . . . |
| 105 | | 1.00 | 0.75 | 0.50 | 1.00 | . . . |
| 106 | | 1.00 | 0.75 | 0.75 | 0.50 | . . . |
| 107 | | 1.00 | 0.75 | 0.75 | 0.75 | . . . |
| 108 | | 1.00 | 0.75 | 0.75 | 1.00 | . . . |
| 109 | | 1.00 | 0.75 | 1.00 | 0.50 | . . . |
| 110 | | 1.00 | 0.75 | 1.00 | 0.75 | . . . |
| 111 | | 1.00 | 0.75 | 1.00 | 1.00 | . . . |
| 112 | | 1.00 | 1.00 | 0.50 | 0.50 | . . . |
| 113 | | 1.00 | 1.00 | 0.50 | 0.75 | . . . |
| 114 | | 1.00 | 1.00 | 0.50 | 1.00 | . . . |
| 115 | | 1.00 | 1.00 | 0.75 | 0.50 | . . . |
| 116 | | 1.00 | 1.00 | 0.75 | 0.75 | . . . |
| 117 | | 1.00 | 1.00 | 0.75 | 1.00 | . . . |
| 118 | | 1.00 | 1.00 | 1.00 | 0.50 | . . . |
| 119 | | 1.00 | 1.00 | 1.00 | 0.75 | . . . |
| 120 | | 1.00 | 1.00 | 1.00 | 1.00 | . . . |

In another example, the column of N_{TRP} does not exist in the above table. In another example, indexing number can be different.

In one example, a sub-table of any-table described in the present disclosure associated with {αₙ} such that αₙ₁≤αₙ₂ (non-decreasing order) when n1<n2 can be an example for a table of ‘paraCombination-r18’.

In one example, a sub-table of any-table described in the present disclosure associated with {αₙ} such that αₙ₁≥αₙ₂ (non-increasing order) when n1<n2 can be an example for a table of ‘paraCombination-r18’.

In one example, the ordering of the TRPs (or CSI-RS resources) can be configured by the NW, via e.g., RRC, or MAC CE or, DCI.

In one example, {M,β} pair values can be configured based on at least one of the tables (or any table (i.e., sub-table, whole table) that can be constructed as) described in the present disclosure.

In one example, a sub-table of Table 4 can be an example for a table of ‘paraCombination-r18’.

TABLE 4

| Index | M | β |
|---|---|---|
| 1 | 1 | ⅛ |
| 2 | 1 | ¼ |
| 3 | 1 | ⅜ |
| 4 | 1 | ½ |
| 5 | 1 | ¾ |
| 6 | 1 | 1 |
| 7 | 2 | ⅛ |
| 8 | 2 | ¼ |
| 9 | 2 | ⅜ |
| 10 | 2 | ½ |
| 11 | 2 | ¾ |
| 12 | 2 | 1 |
| 13 | 3 | ⅛ |
| 14 | 3 | ¼ |
| 15 | 3 | ⅜ |
| 16 | 3 | ½ |
| 17 | 3 | ¾ |
| 18 | 3 | 1 |
| 19 | 4 | ⅛ |
| 20 | 4 | ¼ |
| 21 | 4 | ⅜ |
| 22 | 4 | ½ |
| 23 | 4 | ¾ |
| 24 | 4 | 1 |

In one example, separate tables for {αₙ, n=1, . . . , N_{TRP}} and {M,β}, respectively, are used for the configuration of {αₙ}, M, β, where each table corresponds to one of the tables that can be constructed in the present disclosure.

In one embodiment, any table including at least one of the parameter combinations in a sub-table of Table 4 can be used for a table of ‘paramCombination-r18’, where the sub-table includes parameter combinations associated with M∈ [symbol] , where [symbol] is a subset of [symbol] . For example, if [symbol] ={1,2}, the sub-table includes the parameter combinations associated with M={1,2} in Table 4.
In one example, [symbol] ={1,2} and the sub-table includes parameter combinations associated with M=1, 2 in Table 4.
In one example, [symbol] ={1,2,4} and the sub-table includes parameter combinations associated with M=1, 2, 4 in Table 4.
In one example, [symbol] ={1,2,3} and the sub-table includes parameter combinations associated with M=1, 2, 3 in Table 4.
In one example, [symbol] ={1} and the sub-table includes parameter combinations associated with M=1 in Table 4.

In one embodiment, any table including at least one of the parameter combinations in a sub-table of Table 4 can be used for a table of ‘paramCombination-r18’, where the sub-table includes parameter combinations associated with β∈ [symbol] , where [symbol] is a subset of [symbol] . For example, if [symbol] ={⅜,½,¾,1}, the sub-table includes the parameter combinations associated with β=⅜,½,¾,1 in Table 4.
In one example, [symbol] ={½,¾,1} and the sub-table includes parameter combinations associated with β=½,¾,1 in Table 4.
In one example, [symbol] ={¼,½,¾,1} and the sub-table includes parameter combinations associated with β=¼,½,¾,1 in Table 4.
In one example, [symbol] ={⅛,¼,½,¾,1} and the sub-table includes parameter combinations associated with β=⅛,¼,½,¾,1 in Table 4.
In one example, [symbol] ={⅛,¼,½,¾,1} and the sub-table includes parameter combinations associated with β=⅜,½,¾,1 in Table 4.
In one example, [symbol] =¼,⅜,½,¾,1 and the sub-table includes parameter combinations associated with β=¼,⅜,½,¾,1 in Table 4.

In one embodiment, any table including at least one of parameter combinations in a sub-table of Table 4 can be used for a table of ‘paramCombination-r18’, where the sub-table includes parameter combinations associated M∈ [symbol] and β∈ [symbol] , where M∈ [symbol] is defined in one or more embodiments described herein, and β ∈ [symbol] is defined in one or more embodiments described herein.

In one example, the sub-table includes parameter combinations associated with:
M∈ [symbol] ={1,2} and β∈ [symbol] ={½,¾,1}.

In one example, a sub-table of Table 4A can be an example for a table of ‘paraCombination-r18’.

TABLE 4A

| Index | g({αₙ}) | M | β |
|---|---|---|---|
| 1 | X₁ | 1 | ⅛ |
| 2 | X₁ | 1 | ¼ |
| 3 | X₁ | 1 | ⅜ |
| 4 | X₁ | 1 | ½ |
| 5 | X₁ | 1 | ¾ |
| 6 | X₁ | 1 | 1 |
| 7 | X₁ | 2 | ⅛ |
| 8 | X₁ | 2 | ¼ |
| 9 | X₁ | 2 | ⅜ |
| 10 | X₁ | 2 | ½ |
| 11 | X₁ | 2 | ¾ |
| 12 | X₁ | 2 | 1 |
| 13 | X₁ | 3 | ⅛ |
| 14 | X₁ | 3 | ¼ |
| 15 | X₁ | 3 | ⅜ |
| 16 | X₁ | 3 | ½ |
| 17 | X₁ | 3 | ¾ |
| 18 | X₁ | 3 | 1 |
| 19 | X₁ | 4 | ⅛ |
| 20 | X₁ | 4 | ¼ |
| 21 | X₁ | 4 | ⅜ |
| 22 | X₁ | 4 | ½ |
| 23 | X₁ | 4 | ¾ |
| 24 | X₁ | 4 | 1 |
| 25 | X₂ | 1 | ⅛ |
| 26 | X₂ | 1 | ¼ |
| 27 | X₂ | 1 | ⅜ |
| 28 | X₂ | 1 | ½ |
| 29 | X₂ | 1 | ¾ |
| 30 | X₂ | 1 | 1 |
| 31 | X₂ | 2 | ⅛ |
| 32 | X₂ | 2 | ¼ |
| 33 | X₂ | 2 | ⅜ |
| 34 | X₂ | 2 | ½ |
| 35 | X₂ | 2 | ¾ |
| 36 | X₂ | 2 | 1 |
| 37 | X₂ | 3 | ⅛ |
| 38 | X₂ | 3 | ¼ |
| 39 | X₂ | 3 | ⅜ |
| 40 | X₂ | 3 | ½ |
| 41 | X₂ | 3 | ¾ |
| 42 | X₂ | 3 | 1 |
| 43 | X₂ | 4 | ⅛ |
| 44 | X₂ | 4 | ¼ |
| 45 | X₂ | 4 | ⅜ |
| 46 | X₂ | 4 | ½ |
| 47 | X₂ | 4 | ¾ |
| 48 | X₂ | 4 | 1 |
| . | . | . | . |
| . | . | . | . |
| . | . | . | . |

In one example, in Table 4A,

$$g ( \{ {α}_{n} \} ) = {max}_{n} \{ {α}_{n} \} ,$$

where the max value among {αₙ} in each row is in the column of g({αₙ}).

In one example, in Table 4A,

$$g ( \{ {α}_{n} \} ) = {min}_{n} \{ {α}_{n} \} ,$$

where the min value among {αₙ} in each row is in the column of g({αₙ}).

In one example, in Table 4A,

$$g ( \{ {α}_{n} \} ) = {\sum }_{n = 1}^{{N}_{TRP}} \frac{{α}_{n}}{{N}_{TRP}} ,$$

where the average value of {αₙ} in each row is in the column of g({αₙ}).

In one example, in Table 4A,

$$g ( \{ {α}_{n} \} ) \geq {\sum }_{n = 1}^{{N}_{TRP}} \frac{{α}_{n}}{{N}_{TRP}} ,$$

where an upper bound of the average value of {αₙ} in each row is in the column of g({αₙ}).

In one example, in Table 4A, g({αₙ})=Σₙ₌₁^{N}^{_{TRP}}αₙ, where the average value of {αₙ} in each row is in the column of g({αₙ}).

In one example, in Table 4A, g({αₙ})≥Σₙ₌₁^{N}^{_{TRP}}αₙ, where an upper bound of the average value of {αₙ} in each row is in the column of g({αₙ}).

In one example, in Table 4A, g({αₙ}) can be replaced by another parameter such as αₜₒₜ, αₘₐₓ, αₛᵤₘ, αₘᵢₙ, α̅, \tilde{α}, and so on.

Values of Xᵢ in Table 4A depend on how g(⋅) is defined. For example,

$$g ( \{ {α}_{n} \} ) = {max}_{n} \{ {α}_{n} \} ,$$

then X₁=0.5, X₂=0.75, and X₃=1 where it can be constructed by g(⋅) and candidate values of αₙ, i.e., [symbol] ={½,¾,1}.

In one example, f({αₙ})=g({αₙ}), i.e., the metric or parameter is the same.

In another example, f({αₙ})≠g({αₙ}), i.e., the metric or parameter is independent (different).

In one example, separate tables for {αₙ, n=1, . . . , N_{TRP}} and {M,β}, respectively, are used for the configuration of {αₙ}, M, β, where each table corresponds to one of the tables that can be constructed in this disclosure.

In one embodiment, any table including at least one of the parameter combinations in a sub-table of Table 4A can be used for a table of ‘paramCombination-r18’, where the sub-table includes parameter combinations associated with M∈ [symbol] , where [symbol] is a subset of [symbol] . For example, if [symbol] ={1,2}, the sub-table includes the parameter combinations associated with M={1,2} in Table 4A.
In one example, [symbol] ={1,2} and the sub-table includes parameter combinations associated with M=1, 2 in Table 4A.
In one example, [symbol] ={1,2,4} and the sub-table includes parameter combinations associated with M=1, 2, 4 in Table 4A.
In one example, [symbol] ={1,2,3} and the sub-table includes parameter combinations associated with M=1, 2, 3 in Table 4A.
In one example, [symbol] ={1} and the sub-table includes parameter combinations associated with M=1 in Table 4A.

In one embodiment, any table including at least one of parameter combinations in a sub-table of Table 4A can be used for a table of ‘paramCombination-r18’, where the sub-table includes parameter combinations associated with β∈ [symbol] , where [symbol] is a subset of [symbol] . For example, if [symbol] ={⅜,½,¾,1}, the sub-table includes the parameter combinations associated with β=⅜,½,¾,1 in Table 4.
In one example, [symbol] ={½,¾,1} and the sub-table includes parameter combinations associated with β=½,¾,1 in Table 4A.
In one example, [symbol] ={⅓,½,¾,1} and the sub-table includes parameter combinations associated with β=¼,½,¾,1 in Table 4A.
In one example, [symbol] ={⅛,¼,½,¾,1} and the sub-table includes parameter combinations associated with β=⅛,¼,½,¾,1 in Table 4A.
In one example, [symbol] ={⅜,½,¾,1} and the sub-table includes parameter combinations associated with β=⅜,½,¾,1 in Table 4A.
In one example, [symbol] ={¼,⅜,½,¾,1} and the sub-table includes parameter combinations associated with β=¼,⅜,½,¾,1 in Table 4A.

In one embodiment, any table including at least one of parameter combinations in a sub-table of Table 4A can be used for a table of ‘paramCombination-r18’ where the sub-table includes parameter combinations associated M∈ [symbol] and β∈ [symbol] , where M∈ [symbol] is defined in one or more embodiments herein, and β∈ [symbol] is defined in one or more embodiments herein.

In one example, the sub-table includes parameter combinations associated with:
M∈ [symbol] ={1,2} and β∈ [symbol] ={½,¾,1}.

In one example, a sub-table of Table 4 can be as follows:

| Index | M | β |
|---|---|---|
| 1 | 1 | ½ |
| 2 | 1 | ¾ |
| 3 | 1 | 1 |
| 4 | 2 | ½ |
| 5 | 2 | ¾ |

In one example, a table of ‘paramCombination-r18’ for αₘₐₓ, M, β can include at least one of the parameter combinations described in the following table.

| Index | αₘₐₓ | M | beta |
|---|---|---|---|
| 1 | 1.25 | 1 | 0.5 |
| 2 | 1.5 | 1 | 0.5 |
| 3 | 1.75 | 1 | 0.5 |
| 4 | 2 | 1 | 0.75 |
| 5 | 2.5 | 1 | 0.75 |
| 6 | 1.75 | 2 | 0.5 |
| 7 | 2 | 2 | 0.5 |
| 8 | 2.75 | 2 | 0.5 |

In one example, a table of ‘paramCombination-r18’ for αₘₐₓ, M, β can include at least one of the parameter combinations described in the following table.

| Index | αₘₐₓ | M | beta |
|---|---|---|---|
| 1 | 1.5 | 1 | 0.5 |
| 2 | 1.75 | 1 | 0.5 |
| 3 | 2 | 1 | 0.75 |
| 4 | 2.5 | 1 | 0.75 |
| 5 | 1.75 | 2 | 0.5 |
| 6 | 2 | 2 | 0.5 |
| 7 | 2.75 | 2 | 0.5 |

In one example, supported {M,β} combinations for Rel-17-based CJT codebook are as follows:

| M | β |
|---|---|
| 1 | ½ |
| 1 | ¾ |
| 1 | 1 |
| 2 | ½ |
| 2 | ¾ |

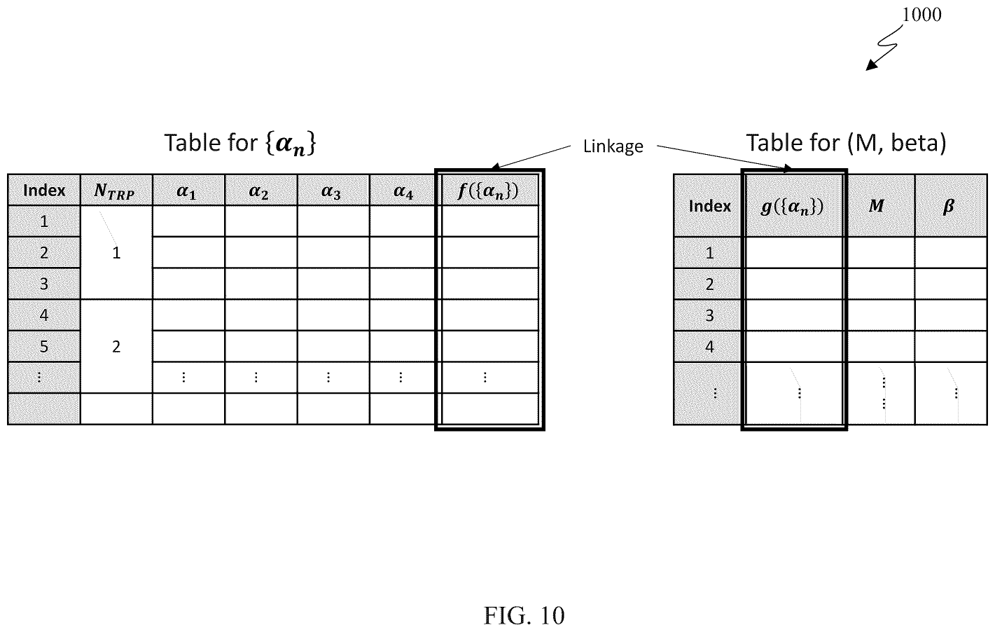

FIG. 10 illustrates codebook parameters for the mTRP codebook configured using two (parameter-combination) tables 1000 according to embodiments of the present disclosure. The embodiment of the codebook parameters for the mTRP codebook configured using two (parameter-combination) tables 1000 illustrated in FIG. 10 is for illustration only. FIG. 10 does not limit the scope of the present disclosure to any particular implementation of the codebook parameters for the mTRP codebook configured using two (parameter-combination) tables 1000.

In one embodiment, a UE is configured with an mTRP (or D-MIMO or C-JT) codebook, via e.g., higher layer parameter codebookType set to ‘typeII-r18-cjt’, wherein codebook parameters for the mTRP codebook are configured using two (parameter-combination) tables.

In one embodiment, a first table is one of the tables for {αₙ} (or whole tables/sub-tables, or tables that can be constructed) in/under embodiment 1, and a second table is one of the tables for {M,β} (or whole tables/sub-tables, or tables that can be constructed) in/under embodiment 1 (or vice versa). For example, a first table is used to configure a combination of {Lₙ}, and a second table is used to configure a combination of (pᵥ,β) or vice versa.

An illustration of an example is shown in FIG. 10. In one embodiment, the two tables can be linked using a (overlapping) parameter that is a function of {αₙ}, i.e., f({αₙ}) or g({αₙ}) as described in one or more embodiments herein.
In one example,

$${max}_{n} \{ {α}_{n} \}$$

can be the parameter to link two tables.
In one example,

$${min}_{n} \{ {α}_{n} \}$$

can be the parameter to link two tables.
In one example, the average of {αₙ},

$$( {\sum }_{n = 1}^{{N}_{TRP}} \frac{{α}_{n}}{{N}_{TRP}} ) ,$$

can be the parameter to link two tables.
In one example, Σₙ₌₁^{N}^{_{TRP}}αⁿ can be the parameter to link two tables.
In one example, an upper bound of the average of {αₙ},

$$( {\sum }_{n = 1}^{{N}_{TRP}} \frac{{α}_{n}}{{N}_{TRP}} ) ,$$

can be the parameter to link two tables.
In one example, an upper bound of Σₙ₌₁^{N}^{_{TRP}}αⁿ can be the parameter to link two tables.

In one example, the NW can configure index X in a first table and index Y among indices associated with a value of the linked parameter in a second table. Here, the value of linked parameter is the value associated with index X of the first table.

As an example, by using the illustration shown in FIG. 10, the NW configures a combination of {Lₙ} using the table for {Lₙ} and, based on the linked parameter, Lₘₐₓ, the NW configures a combination of (pᵥ,β) among the indices associated with the value of Lₘₐₓ. In this way, the size of parameter(s) required for the codebook parameter configuration can be efficiently reduced.

In one example, N_{L} is implicitly derived using ({αₙ}) and/or g({αₙ}).

In one embodiment, a subset of parameter combinations in a table designed based on one or more embodiments herein for a table of ‘paramCombination-r18’ can be restricted not to configure based on one or more aspects such as a number of TRPs (N_{TRP}), a number of SBs K (numberOfPMI-SubbandsPerCQI-Subband), and a number of CSI-RS ports (2N₁N₂ or P_{CSI-RS})

In one example, the parameter combination with αₙ=1 and/or ¾ for any n can be used/reported (by the UE) or configured (by the NW) under a condition.
In one example, the condition corresponds to the case when number of CSI-RS ports (for a TRP)=32.
In one example, the condition corresponds to the case when number of CSI-RS ports (for a TRP)≥t, where t is a threshold, which can be fixed, or configured, or subject to UE capability.
In one example, the condition corresponds to the case when number of CSI-RS ports (for a TRP)>t, where t is a threshold, which can be fixed, or configured, or subject to UE capability.
In one example, the condition corresponds to the case when N_{TRP}<3 (i.e., N_{TRP}=1, 2).
In one example, the condition corresponds to the case when N_{TRP}<s, where s is a threshold, which can be fixed, or configured, or subject to UE capability.
In one example, the condition corresponds to the case when N_{TRP}≤s, where s is a threshold, which can be fixed, or configured, or subject to UE capability.
In one example, the condition corresponds to the case when N_{TRP}>s, where s is a threshold, which can be fixed, or configured, or subject to UE capability.
In one example, the condition corresponds to the case when N_{TRP}≥s, where s is a threshold, which can be fixed, or configured, or subject to UE capability.
In one example, the condition corresponds to the case when K<k, where k is a threshold, which can be fixed, or configured, or subject to UE capability.
In one example, the condition corresponds to the case when K≤k, where k is a threshold, which can be fixed, or configured, or subject to UE capability.
In one example, the condition corresponds to the case when K>k, where k is a threshold, which can be fixed, or configured, or subject to UE capability.
In one example, the condition corresponds to the case when K≥k, where k is a threshold, which can be fixed, or configured, or subject to UE capability.
In one example, the condition corresponds to one or more conditions described herein and the max rank value (for RI reporting) is 2 (e.g., configured via RI-restriction).
In one example, the condition corresponds to one or more conditions described herein and the value of R is 1 (e.g., configured via higher layer numberOfPMIsubbandPerCQIsubband).
In one example, the condition corresponds to one or more conditions described herein and the max rank value (for RI reporting) is 2 (e.g., configured via RI-restriction), and the value of R is 1 (e.g., configured via higher layer numberOfPMIsubbandPerCQIsubband).

In one example, the parameter combination with M=2 and/or 3 or and/or 4 for any n can be used/reported (by the UE) or configured (by the NW) under a condition.
In one example, the condition corresponds to the case when number of CSI-RS ports (for a TRP)=32.
In one example, the condition corresponds to the case when number of CSI-RS ports (for a TRP)≥t, where t is a threshold, which can be fixed, or configured, or subject to UE capability.
In one example, the condition corresponds to the case when number of CSI-RS ports (for a TRP)>t, where t is a threshold, which can be fixed, or configured, or subject to UE capability.
In one example, the condition corresponds to the case when N_{TRP}<3 (i.e., N_{TRP}=1, 2).
In one example, the condition corresponds to the case when N_{TRP}<s, where s is a threshold, which can be fixed, or configured, or subject to UE capability.
In one example, the condition corresponds to the case when N_{TRP}≤s, where s is a threshold, which can be fixed, or configured, or subject to UE capability.
In one example, the condition corresponds to the case when N_{TRP}>s, where s is a threshold, which can be fixed, or configured, or subject to UE capability.
In one example, the condition corresponds to the case when N_{TRP}≥s, where s is a threshold, which can be fixed, or configured, or subject to UE capability.
In one example, the condition corresponds to the case when K<k, where k is a threshold, which can be fixed, or configured, or subject to UE capability.
In one example, the condition corresponds to the case when K≤k, where k is a threshold, which can be fixed, or configured, or subject to UE capability.
In one example, the condition corresponds to the case when K>k, where k is a threshold, which can be fixed, or configured, or subject to UE capability.
In one example, the condition corresponds to the case when K≥k, where k is a threshold, which can be fixed, or configured, or subject to UE capability.
In one example, the condition corresponds to one or more conditions described herein and the max rank value (for RI reporting) is 2 (e.g., configured via RI-restriction).
In one example, the condition corresponds to one or more conditions described herein and the value of R is 1 (e.g., configured via higher layer numberOfPMIsubbandPerCQIsubband).
In one example, the condition corresponds to one or more conditions described herein and the max rank value (for RI reporting) is 2 (e.g., configured via RI-restriction), and the value of R is 1 (e.g., configured via higher layer numberOfPMIsubbandPerCQIsubband).

In one example, the parameter combination with M=1 for any n can be used/reported (by the UE) or configured (by the NW) under a condition.
In one example, the condition corresponds to the case when number of CSI-RS ports (for a TRP)=32.
In one example, the condition corresponds to the case when number of CSI-RS ports (for a TRP)≥t, where t is a threshold, which can be fixed, or configured, or subject to UE capability.
In one example, the condition corresponds to the case when number of CSI-RS ports (for a TRP)>t, where t is a threshold, which can be fixed, or configured, or subject to UE capability.
In one example, the condition corresponds to the case when N_{TRP}<3 (i.e., N_{TRP}=1, 2).
In one example, the condition corresponds to the case when N_{TRP}<s, where s is a threshold, which can be fixed, or configured, or subject to UE capability.
In one example, the condition corresponds to the case when N_{TRP}≤s, where s is a threshold, which can be fixed, or configured, or subject to UE capability.
In one example, the condition corresponds to the case when N_{TRP}>s, where s is a threshold, which can be fixed, or configured, or subject to UE capability.
In one example, the condition corresponds to the case when N_{TRP}≥s, where s is a threshold, which can be fixed, or configured, or subject to UE capability.
In one example, the condition corresponds to the case when K<k, where k is a threshold, which can be fixed, or configured, or subject to UE capability.
In one example, the condition corresponds to the case when K≤k, where k is a threshold, which can be fixed, or configured, or subject to UE capability.
In one example, the condition corresponds to the case when K>k, where k is a threshold, which can be fixed, or configured, or subject to UE capability.
In one example, the condition corresponds to the case when K≥k, where k is a threshold, which can be fixed, or configured, or subject to UE capability.
In one example, the condition corresponds to one or more conditions described herein and the max rank value (for RI reporting) is 2 (e.g., configured via RI-restriction).
In one example, the condition corresponds to one or more conditions described herein and the value of R is 1 (e.g., configured via higher layer numberOfPMIsubbandPerCQIsubband).
In one example, the condition corresponds to one or more conditions described herein and the max rank value (for RI reporting) is 2 (e.g., configured via RI-restriction), and the value of R is 1 (e.g., configured via higher layer numberOfPMIsubbandPerCQIsubband).

In one example, the parameter combination with β=½ and/or ¾ and/or 1 for any n can be used/reported (by the UE) or configured (by the NW) under a condition.
In one example, the condition corresponds to the case when number of CSI-RS ports (for a TRP)=32.
In one example, the condition corresponds to the case when number of CSI-RS ports (for a TRP)≥t, where t is a threshold, which can be fixed, or configured, or subject to UE capability.
In one example, the condition corresponds to the case when number of CSI-RS ports (for a TRP)>t, where t is a threshold, which can be fixed, or configured, or subject to UE capability.
In one example, the condition corresponds to the case when N_{TRP}<3 (i.e., N_{TRP}=1, 2).
In one example, the condition corresponds to the case when N_{TRP}<s, where s is a threshold, which can be fixed, or configured, or subject to UE capability.
In one example, the condition corresponds to the case when N_{TRP}≤s, where s is a threshold, which can be fixed, or configured, or subject to UE capability.
In one example, the condition corresponds to the case when N_{TRP}>s, where s is a threshold, which can be fixed, or configured, or subject to UE capability.
In one example, the condition corresponds to the case when N_{TRP}≥s, where s is a threshold, which can be fixed, or configured, or subject to UE capability.
In one example, the condition corresponds to the case when K<k, where k is a threshold, which can be fixed, or configured, or subject to UE capability.
In one example, the condition corresponds to the case when K≤k, where k is a threshold, which can be fixed, or configured, or subject to UE capability.
In one example, the condition corresponds to the case when K>k, where k is a threshold, which can be fixed, or configured, or subject to UE capability.
In one example, the condition corresponds to the case when K≥k, where k is a threshold, which can be fixed, or configured, or subject to UE capability.
In one example, the condition corresponds to one or more conditions described herein and the max rank value (for RI reporting) is 2 (e.g., configured via RI-restriction).
In one example, the condition corresponds to one or more conditions described herein and the value of R is 1 (e.g., configured via higher layer numberOfPMIsubbandPerCQIsubband).
In one example, the condition corresponds to one or more conditions described herein and the max rank value (for RI reporting) is 2 (e.g., configured via RI-restriction), and the value of R is 1 (e.g., configured via higher layer numberOfPMIsubbandPerCQIsubband).

In one example, the parameter combination with αₙ=1 and/or ¾ and/or M=2 and/or 3 and/or 4 and/or 1 for any n can be used/reported (by the UE) or configured (by the NW) under a condition.
In one example, the condition corresponds to the case when number of CSI-RS ports (for a TRP)=32.
In one example, the condition corresponds to the case when number of CSI-RS ports (for a TRP)≥t, where t is a threshold, which can be fixed, or configured, or subject to UE capability.
In one example, the condition corresponds to the case when number of CSI-RS ports (for a TRP)>t, where t is a threshold, which can be fixed, or configured, or subject to UE capability.
In one example, the condition corresponds to the case when N_{TRP}<3 (i.e., N_{TRP}=1, 2).
In one example, the condition corresponds to the case when N_{TRP}<s, where s is a threshold, which can be fixed, or configured, or subject to UE capability.
In one example, the condition corresponds to the case when N_{TRP}≤s, where s is a threshold, which can be fixed, or configured, or subject to UE capability.
In one example, the condition corresponds to the case when N_{TRP}>s, where s is a threshold, which can be fixed, or configured, or subject to UE capability.
In one example, the condition corresponds to the case when N_{TRP}≥s, where s is a threshold, which can be fixed, or configured, or subject to UE capability.
In one example, the condition corresponds to the case when K<k, where k is a threshold, which can be fixed, or configured, or subject to UE capability.
In one example, the condition corresponds to the case when K≤k, where k is a threshold, which can be fixed, or configured, or subject to UE capability.
In one example, the condition corresponds to the case when K>k, where k is a threshold, which can be fixed, or configured, or subject to UE capability.
In one example, the condition corresponds to the case when K≥k, where k is a threshold, which can be fixed, or configured, or subject to UE capability.
In one example, the condition corresponds to one or more conditions described herein and the max rank value (for RI reporting) is 2 (e.g., configured via RI-restriction).
In one example, the condition corresponds to one or more conditions described herein and the value of R is 1 (e.g., configured via higher layer numberOfPMIsubbandPerCQIsubband).
In one example, the condition corresponds to one or more conditions described herein and the max rank value (for RI reporting) is 2 (e.g., configured via RI-restriction), and the value of R is 1 (e.g., configured via higher layer numberOfPMIsubbandPerCQIsubband).

In one example, the parameter combination with αₙ=1 and/or ¾ and/or β=½ and/or ¾ and/or 1 for any n can be used/reported (by the UE) or configured (by the NW) under a condition.
In one example, the condition corresponds to the case when number of CSI-RS ports (for a TRP)=32.
In one example, the condition corresponds to the case when number of CSI-RS ports (for a TRP)≥t, where t is a threshold, which can be fixed, or configured, or subject to UE capability.
In one example, the condition corresponds to the case when number of CSI-RS ports (for a TRP)>t, where t is a threshold, which can be fixed, or configured, or subject to UE capability.
In one example, the condition corresponds to the case when N_{TRP}<3 (i.e., N_{TRP}=1, 2).
In one example, the condition corresponds to the case when N_{TRP}<s, where s is a threshold, which can be fixed, or configured, or subject to UE capability.
In one example, the condition corresponds to the case when N_{TRP}≤s, where s is a threshold, which can be fixed, or configured, or subject to UE capability.
In one example, the condition corresponds to the case when N_{TRP}>s, where s is a threshold, which can be fixed, or configured, or subject to UE capability.
In one example, the condition corresponds to the case when N_{TRP}≥s, where s is a threshold, which can be fixed, or configured, or subject to UE capability.
In one example, the condition corresponds to the case when K<k, where k is a threshold, which can be fixed, or configured, or subject to UE capability.
In one example, the condition corresponds to the case when K≤k, where k is a threshold, which can be fixed, or configured, or subject to UE capability.
In one example, the condition corresponds to the case when K>k, where k is a threshold, which can be fixed, or configured, or subject to UE capability.
In one example, the condition corresponds to the case when K≥k, where k is a threshold, which can be fixed, or configured, or subject to UE capability.
In one example, the condition corresponds to one or more conditions described herein and the max rank value (for RI reporting) is 2 (e.g., configured via RI-restriction).
In one example, the condition corresponds to one or more conditions described herein and the value of R is 1 (e.g., configured via higher layer numberOfPMIsubbandPerCQIsubband).
In one example, the condition corresponds to one or more conditions described herein and the max rank value (for RI reporting) is 2 (e.g., configured via RI-restriction), and the value of R is 1 (e.g., configured via higher layer numberOfPMIsubbandPerCQIsubband).

In one example, the parameter combination with M=2 and/or 3 and/or 4 and/or 1 and/or β=½ and/or ¾ and/or 1 for any n can be used/reported (by the UE) or configured (by the NW) under a condition.
In one example, the condition corresponds to the case when number of CSI-RS ports (for a TRP)=32.
In one example, the condition corresponds to the case when number of CSI-RS ports (for a TRP)≥t, where t is a threshold, which can be fixed, or configured, or subject to UE capability.
In one example, the condition corresponds to the case when number of CSI-RS ports (for a TRP)>t, where t is a threshold, which can be fixed, or configured, or subject to UE capability.
In one example, the condition corresponds to the case when N_{TRP}<3 (i.e., N_{TRP}=1, 2).
In one example, the condition corresponds to the case when N_{TRP}<s, where s is a threshold, which can be fixed, or configured, or subject to UE capability.
In one example, the condition corresponds to the case when N_{TRP}≤s, where s is a threshold, which can be fixed, or configured, or subject to UE capability.
In one example, the condition corresponds to the case when N_{TRP}>s, where s is a threshold, which can be fixed, or configured, or subject to UE capability.
In one example, the condition corresponds to the case when N_{TRP}≥s, where s is a threshold, which can be fixed, or configured, or subject to UE capability.
In one example, the condition corresponds to the case when K<k, where k is a threshold, which can be fixed, or configured, or subject to UE capability.
In one example, the condition corresponds to the case when K≤k, where k is a threshold, which can be fixed, or configured, or subject to UE capability.
In one example, the condition corresponds to the case when K>k, where k is a threshold, which can be fixed, or configured, or subject to UE capability.
In one example, the condition corresponds to the case when K≥k, where k is a threshold, which can be fixed, or configured, or subject to UE capability.
In one example, the condition corresponds to one or more conditions described herein and the max rank value (for RI reporting) is 2 (e.g., configured via RI-restriction).
In one example, the condition corresponds to one or more conditions described herein and the value of R is 1 (e.g., configured via higher layer numberOfPMIsubbandPerCQIsubband).
In one example, the condition corresponds to one or more conditions described herein and the max rank value (for RI reporting) is 2 (e.g., configured via RI-restriction), and the value of R is 1 (e.g., configured via higher layer numberOfPMIsubbandPerCQIsubband).

In one example, the parameter combination with αₙ=1 and/or ¾and/or M=2 and/or 3 and/or 4 and/or 1 and/or β=½ and/or ¾ and/or 1 for any n can be used/reported (by the UE) or configured (by the NW) under a condition.
In one example, the condition corresponds to the case when number of CSI-RS ports (for a TRP)=32.
In one example, the condition corresponds to the case when number of CSI-RS ports (for a TRP)≥t, where t is a threshold, which can be fixed, or configured, or subject to UE capability.
In one example, the condition corresponds to the case when number of CSI-RS ports (for a TRP)>t, where t is a threshold, which can be fixed, or configured, or subject to UE capability.
In one example, the condition corresponds to the case when N_{TRP}<3 (i.e., N_{TRP}=1, 2).
In one example, the condition corresponds to the case when N_{TRP}<s, where s is a threshold, which can be fixed, or configured, or subject to UE capability.
In one example, the condition corresponds to the case when N_{TRP}≤s, where s is a threshold, which can be fixed, or configured, or subject to UE capability.
In one example, the condition corresponds to the case when N_{TRP}>s, where s is a threshold, which can be fixed, or configured, or subject to UE capability.
In one example, the condition corresponds to the case when N_{TRP}≥s, where s is a threshold, which can be fixed, or configured, or subject to UE capability.
In one example, the condition corresponds to the case when K<k, where k is a threshold, which can be fixed, or configured, or subject to UE capability.
In one example, the condition corresponds to the case when K≤k, where k is a threshold, which can be fixed, or configured, or subject to UE capability.
In one example, the condition corresponds to the case when K>k, where k is a threshold, which can be fixed, or configured, or subject to UE capability.
In one example, the condition corresponds to the case when K≥k, where k is a threshold, which can be fixed, or configured, or subject to UE capability.
In one example, the condition corresponds to one or more conditions described herein and the max rank value (for RI reporting) is 2 (e.g., configured via RI-restriction).
In one example, the condition corresponds to one or more conditions described herein and the value of R is 1 (e.g., configured via higher layer numberOfPMIsubbandPerCQIsubband).
In one example, the condition corresponds to one or more conditions described herein and the max rank value (for RI reporting) is 2 (e.g., configured via RI-restriction), and the value of R is 1 (e.g., configured via higher layer numberOfPMIsubbandPerCQIsubband).

In one embodiment, parameter combinations M, α, β or {αₙ} and (M,β) for Rel-17-based (further enhanced Type-II port-selection codebook) CJT codebook are derived/generated/constructed/translated from (or based on/related to) parameter combinations L,pᵥ,β or {Lₙ} and (pᵥ,β) for Rel-16-based (Enhanced Type-II (regular) codebook) CJT codebook.

In one example, parameter combinations for Rel-16-based CJT codebook are used to derive parameter combinations for Rel-17-based CJT codebook, e.g., based on some rules or equations.

In one example, parameter combinations for Rel-16-based CJT codebook are used for constructing/generating/deriving tables of parameter combinations for Rel-17-based CJT codebook. (tables)

To Map (Relate) from Lₙ to αₙ

In one embodiment, there is one-to-one relation between Lₙ and αₙ, where each Lₙ value has a corresponding value of αₙ. (or vice versa) For example, based on increasing order or decreasing order of Lₙ and αₙ (the smallest Lₙ maps to the smallest αₙ, the largest Lₙ maps to the largest αₙ, and the rest can be mapped similarly according to the order).

In one example, Lₙ∈{2,4,6} in parameter combinations of Rel-16-based CJT codebook can be mapped to αₙ={½,¾,1} for Rel-17-based CJT codebook.

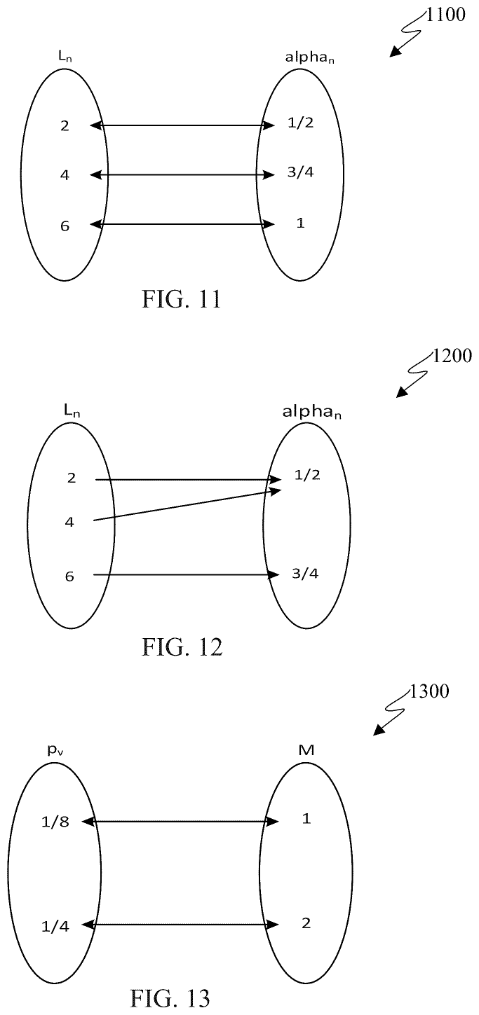

FIG. 11 illustrates a one-to-one relation between Lₙ and αₙ 1100 according to embodiments of the present disclosure. The embodiment of the one-to-one relation between Lₙ and αₙ 1100 illustrated in FIG. 11 is for illustration only. FIG. 11 does not limit the scope of this disclosure to any particular implementation of the one-to-one relation between Lₙ and αₙ 1100.

FIG. 11 shows a one-to-one relation between Lₙ and αₙ, where Lₙ=2 maps to αₙ=½, Lₙ=4 maps to αₙ=¾, and Lₙ=6 maps to αₙ=1. (other one-to-one relation cases are omitted.)

Assuming the above relation described in FIG. 11, (another relation between Lₙ and αₙ is also another example in this disclosure) {αₙ} for Rel-17-based CJT codebook can be mapped from {Lₙ} for Rel-16-based CJT codebook:
In one example, (L₁,L₂,L₃)=(6,4,2) maps to (α₁,α₂,α₃)=(1,¾,½).
In one example, (L₁,L₂,L₃,L₄)=(4,4,4,4) maps to (α₁,α₂,α₃,α₄)=(¾,¾,¾,¾).
In one example, (L₁,L₂)=(4,2) maps to (α₁,α₂)=(¾,½).

In one example, a one-to-one mapping or relation shown in this example can be used to derive {αₙ} for Rel-17-based CJT codebook.

In one example, a one-to-one mapping or relation shown in this example can be used to construct/generate/derive a table for {αₙ} for Rel-17-based CJT codebook.

In example, Lₙ∈{2,4} in parameter combinations of Rel-16-based CJT codebook can be mapped to αₙ={½,¾} for Rel-17-based CJT codebook. An example with the same approach shown in one or more examples herein can be an example to derive {αₙ} for Rel-17-based CJT codebook from {Lₙ} for Rel-16-based CJT codebook.

In one example, Lₙ∈{2,4} in parameter combinations of Rel-16-based CJT codebook can be mapped to αₙ={¾,1} for Rel-17-based CJT codebook.

In one example, an example with the same approach shown in one or more examples described herein can be an example to derive {αₙ} for Rel-17-based CJT codebook from {Lₙ} for Rel-16-based CJT codebook.

In one example, Lₙ∈{2,4} in parameter combinations of Rel-16-based CJT codebook can be mapped to αₙ={½,1} for Rel-17-based CJT codebook.

An example with the same approach shown in one or more examples herein can be an example to derive {αₙ} for Rel-17-based CJT codebook from {Lₙ} for Rel-16-based CJT codebook.

In one embodiment, there is one-to-one relation between Lₙ and αₙ, where each Lₙ value has a corresponding value of αₙ, and different Lₙ values can be corresponding to a same value of αₙ. (or vice versa).

In one example, Lₙ∈{2,4,6} in parameter combinations of Rel-16-based CJT codebook can be mapped to αₙ={½,¾} for Rel-17-based CJT codebook.

FIG. 12 illustrates a many-to-one relation between Lₙ and αₙ 1200 according to embodiments of the present disclosure. The embodiment of the many-to-one relation between Lₙ and αₙ 1200 illustrated in FIG. 12 is for illustration only. FIG. 12 does not limit the scope of this disclosure to any particular implementation of the many-to-one relation between Lₙ and αₙ 1200.

FIG. 12 shows a many-to-one relation between Lₙ and αₙ, where Lₙ=2 maps to αₙ=½, and Lₙ=4 maps to αₙ=½, and Lₙ=6 maps to αₙ=¾ (other many-to-one relation cases are omitted.)

In one example, a many-to-one mapping, or relation shown in this example can be used to derive {αₙ} for Rel-17-based CJT codebook.

In one example, a many-to-one mapping, or relation shown in this example can be used to construct/generate/derive a table for {αₙ} for Rel-17-based CJT codebook.

In one example, Lₙ∈{2,4,6} in parameter combinations of Rel-16-based CJT codebook can be mapped to αₙ={¾,1} for Rel-17-based CJT codebook. An example with the same approach shown in one or more examples herein can be an example to derive {αₙ} for Rel-17-based CJT codebook from {Lₙ} for Rel-16-based CJT codebook.

In one example, Lₙ∈{2,4,6} in parameter combinations of Rel-16-based CJT codebook can be mapped to αₙ={½,1} for Rel-17-based CJT codebook. An example with the same approach shown in one or more examples herein can be an example to derive {αₙ} for Rel-17-based CJT codebook from {Lₙ} for Rel-16-based CJT codebook.

In one example, a one-to-many relation between Lₙ and αₙ, where Lₙ=2 maps to αₙ=½, and Lₙ=4 maps to αₙ=½ or ¾, and Lₙ=6 maps to αₙ=1 (other one-to-many relation cases are omitted.)

In one embodiment, {αₙ} for Rel-17-based CJT codebook are derived using a relation between α and L, e.g.,

$$α = \frac{2 L}{{P}_{CSI - RS}}$$

(in section 5.2.2.2.7 of [9]), where P_{CSI-RS} is a number of CSI-RS ports associated with n-th CSI-RS resource. We assume P_{CSI-RS,n}-P_{CSI-RS} for all CSI-RS resources in the rest of the examples below. For, the examples are general and apply to the case when P_{CSI-RS,n} can be different for different CSI-RS resources.

(calculate

$$\frac{2 {L}_{n}}{{P}_{CSI - RS}}$$

→take it upper bounding by 1)

In one example, for a given configured value of Lₙ and P_{CSI-RS}, an is determined by

$${α}_{n} = min ( c , \frac{2 {L}_{n}}{{P}_{CSI - RS}} ) .$$

In one example, c=1. In one example, c≤1. In one example, c≥1. P_{CSI-RS} For the case of c=1, we can have following examples:
In one example, when Lₙ=4 and P_{CSI-RS}=4, αₙ is set to 1.
In one example, when Lₙ=2 and P_{CSI-RS}=12, αₙ is set to ⅓.
In one example, when Lₙ=2 and P_{CSI-RS}=16, αₙ is set to ¼.

That is, based on the rule of

$${α}_{n} = min ( c , \frac{2 {L}_{n}}{{P}_{CSI - RS}} ) ,$$

αₙ is determined using configured values of Lₙ and P_{CSI-RS}.

(calculate

$$\frac{2 {L}_{n}}{{P}_{CSI - RS}}$$

→take it upper bounding by 1→find a nearest value from legacy candidates for α)

In one example, for a given configured value of Lₙ and P_{CSI-RS}, αₙ is selected from [symbol] ={½, ¾, 1}, where the selected value from [symbol] is the nearest value to

$$min ( c , \frac{2 {L}_{n}}{{P}_{CSI - RS}} ) .$$

In one example, c=1. In one example, c≤1. In one example, c≥1. For the case of c=1, we can have following examples:
In one example, when Lₙ=4 and P_{CSI-RS}=4, αₙ is set to 1.
In one example, when Lₙ=2 and P_{CSI-RS}=12, αₙ is set to ½.
In one example, when Lₙ=2 and P_{CSI-RS}=16, αₙ is set to ½.

That is, based on the rule of αₙ selected from [symbol] , the nearest value to

$$min ( c , \frac{2 {L}_{n}}{{P}_{CSI - RS}} ) ,$$

αₙ is determined using configured values of Lₙ and P_{CSI-RS}.

(calculate

$$\frac{2 {L}_{n}}{{P}_{CSI - RS}}$$

→take it upper bounding by 1→find a nearest value from legacy candidates+new candidates for α)

In one example, for a given configured value of Lₙ and P_{CSI-RS}, αₙ is selected from [symbol] , where the selected value from [symbol] is the nearest value to

$$min ( c , \frac{2 {L}_{n}}{{P}_{CSI - RS}} ) .$$

In one example, c=1. In one example, c≤1. In one example, c≥1. In one example, A includes (the whole or any subset of) legacy candidate values and/or new candidate values. In one example, [symbol] ={¼,½,¾,1}. For the case of c=1 and [symbol] ={¼,½,¾,1}, we can have following examples:
In one example, when Lₙ=4 and P_{CSI-RS}=4, αₙ is set to 1.
In one example, when Lₙ=2 and P_{CSI-RS}=12, αₙ is set to ¼.
In one example, when Lₙ=2 and P_{CSI-RS}=16, αₙ is set to ¼.

That is, based on the rule of αₙ selected from [symbol] , the nearest value to

$$min ( c , \frac{2 {L}_{n}}{{P}_{CSI - RS}} ) ,$$

αₙ is determined using configured values of Lₙ and P_{CSI-RS}.

In one example, for a given Lₙ and P_{CSI-RS}, αₙ is directly determined by

$${α}_{n} = \frac{2 {L}_{n}}{{P}_{CSI - RS}} .$$

In this case, we can have following examples:
In one example, when Lₙ=4 and P_{CSI-RS}=4, αₙ is set to 2.
In one example, when Lₙ=2 and P_{CSI-RS}=12, αₙ is set to ⅓.
In one example, when Lₙ=2 and P_{CSI-RS}=16, αₙ is set to ¼.

In this disclosure, a criterion on identifying the nearest value can be based on [symbol] ₁-norm, [symbol] ₂-norm, or another [symbol] -norm metric.

(calculate

$$\frac{{\sum }_{n} 2 {L}_{n}}{{P}_{CSI - RS}}$$

→take it upper bounding by 1)

In one example, for a given configured value of {Lₙ} combination and P_{CSI-RS}, Σₙαₙ is determined by

$${\sum }_{n} {α}_{n} = min ( c , \frac{{\sum }_{n} 2 {L}_{n}}{{P}_{CSI - RS}} ) .$$

In one example, c=2. In one example, c≤2. In one example, c≥2. For the case of c=1, examples include:
In one example, when (L₁,L₂,L₃)=(4,4,4) and P_{CSI-RS}=16, Σₙαₙ is set to 2.
In one example, when (L₁,L₂,L₃)=(2,2,2) and P_{CSI-RS}=16, Σₙαₙ is set to 12/16.
In one example, when (L₁,L₂,L₃)=(2,2,2) and P_{CSI-RS}=12, Σₙαₙ is set to 1.

That is, based on the rule of

$${\sum }_{n} {α}_{n} = min ( c , \frac{{\sum }_{n} 2 {L}_{n}}{{P}_{CSI - RS}} ) ,$$

Σₙαₙ is determined using configured values of {Lₙ} and P_{CSI-RS}.

(calculate

$$\frac{{\sum }_{n} 2 {L}_{n}}{{P}_{CSI - RS}}$$

→take it upper bounding by 1→find a nearest value from legacy candidates for Σₙαₙ)

(calculate

$$\frac{2 {L}_{n}}{{P}_{CSI - RS}}$$

→take it upper bounding by 1→find a nearest value from legacy candidates+new candidates for α)

In one example, for a given configured value of {Lₙ} combination and P_{CSI-RS}, Σₙαₙ is directly determined by

$${\sum }_{n} {α}_{n} = \frac{{\sum }_{n} 2 {L}_{n}}{{P}_{CSI - RS}} .$$

In one embodiment, {αₙ} for Rel-17-based CJT codebook are derived using a relation between α and L, e.g.,

$$L = \frac{α {P}_{CSI - RS}}{2}$$

(in section 5.2.2.2.7 of [9]), where P_{CSI-RS} is a number of CSI-RS ports associated with n-th CSI-RS resource. It may be assumed that P_{CSI-RS,n}=P_{CSI-RS} for all CSI-RS resources in the rest of the examples below. For, the examples are general and apply to the case when P_{CSI-RS,n} can be different for different CSI-RS resources.

(calculate

$$\frac{{α}_{n} {P}_{CSI - RS}}{2}$$

→take it upper bounding by 1)

In one example, for a given configured value of an and P_{CSI-RS}, Lₙ is determined by

$${L}_{n} = min ( c , \frac{{α}_{n} {P}_{CSI - RS}}{2} ) .$$

In one example, c=6. In one example, c≤6. In one example, c≥6. In one example, c=4. In one example, c≤4. In one example, c≥4. For the case of c=4, examples may include:
In one example, when αₙ=1 and P_{CSI-RS}=4, Lₙ is set to 2.
In one example, when αₙ=1 and P_{CSI-RS}=12, Lₙ is set to 4.
In one example, when αₙ=1 and P_{CSI-RS}=16, Lₙ is set to 4.

That is, based on the rule of

$${L}_{n} = min ( c , \frac{{α}_{n} {P}_{CSI - RS}}{2} ) .$$

Lₙ is determined using configured values of αₙ and P_{CSI-RS}.

(calculate

$$\frac{{α}_{n} {P}_{CSI - RS}}{2}$$

→take it upper bounding by 1→find a nearest value from legacy candidates for α)

In one example, for a given configured value of αₙ and P_{CSI-RS}, Lₙ is selected from [symbol] ={2,4,6} or [symbol] ={2,4}, where the selected value from [symbol] is the nearest value to

$$min ( c , \frac{{α}_{n} {P}_{CSI - RS}}{2} ) .$$

In one example, c≤6. In one example, c≥6. In one example, c=4. In one example, c≤4. In one example, c≥4. For the case of c=4, examples may include:
In one example, when αₙ=1 and P_{CSI-RS}=4, Lₙ is set to 2.
In one example, when αₙ=1 and P_{CSI-RS}=6, Lₙ is set to 2 or 4.
In one example, when αₙ=1 and P_{CSI-RS}=16, Lₙ is set to 4.

That is, based on the rule of

$${L}_{n} = min ( c , \frac{{α}_{n} {P}_{CSI - RS}}{2} )$$

selected from [symbol] , the nearest value to

$$min ( c , \frac{{α}_{n} {P}_{CSI - RS}}{2} ) ,$$

Lₙ is determined using configured values of αₙ and P_{CSI-RS}.

(calculate

$$\frac{{α}_{n} {P}_{CSI - RS}}{2}$$

→take it upper bounding by 1→find a nearest value from legacy candidates for α+new legacy value)

In one example, for a given configured value of αₙ and P_{CSI-RS}, Lₙ is selected from [symbol] ={2,4,6} or [symbol] ={2,3,4}, where the selected value from [symbol] is the nearest value to

$$min ( c , \frac{{α}_{n} {P}_{CSI - RS}}{2} ) .$$

In one example, c≤6. In one example, c≥6. In one example, c=4. In one example, c≤4. In one example, c≥4. For the case of c=4, examples may include:
In one example, when αₙ=1 and P_{CSI-RS}=4, Lₙ is set to 2.
In one example, when αₙ=1 and P_{CSI-RS}=6, Lₙ is set to 3.
In one example, when αₙ=1 and P_{CSI-RS}=16, Lₙ is set to 4.

That is, based on the rule of

$${L}_{n} = min ( c , \frac{{α}_{n} {P}_{CSI - RS}}{2} )$$

selected from [symbol] the nearest value to

$$min ( c , \frac{{α}_{n} {P}_{CSI - RS}}{2} ) ,$$

Lₙ is determined using configured values of αₙ and P_{CSI-RS}.

In one example, for a given configured value of αₙ and P_{CSI-RS}, Lₙ is directly determined by

$$\frac{{α}_{n} {P}_{CSI - RS}}{2} .$$

(calculate

$$\frac{{\sum }_{n} {α}_{n} {P}_{CSI - RS}}{2}$$

→take it upper bounding by 1)

In one example, for a given configured value of {αₙ} and P_{CSI-RS}, ΣₙLₙ is determined by

$${\sum }_{n} {L}_{n} = min ( c , \frac{{\sum }_{n} {α}_{n} {P}_{CSI - RS}}{2} ) .$$

In one example, c=8. In one example, c≤8. In one example, c≥8. For the case of c=8, examples may include:
In one example, when (α₁,α₂,α₃)=(1,1,1) and P_{CSI-RS}=16, ΣₙLₙ is set to 8.
In one example, when (α₁,α₂,α₃)=(½,½,½) and P_{CSI-RS}=16, ΣₙLₙ is set to 8.
In one example, when (α₁,α₂,α₃)=(½,½,½) and P_{CSI-RS}=8 ΣₙLₙ is set to 6.

That is, based on the rule of

$${\sum }_{n} {L}_{n} = min ( c , \frac{{\sum }_{n} {α}_{n} {P}_{CSI - RS}}{2} ) ,$$

ΣₙLₙ is determined using configured values of {αₙ} and P_{CSI-RS}.

(calculate

$$\frac{{\sum }_{n} {α}_{n} {P}_{CSI - RS}}{2}$$

→take it upper bounding by 1→find a nearest value from legacy candidates for, ΣₙLₙ)

(calculate

$$\frac{{\sum }_{n} {α}_{n} {P}_{CSI - RS}}{2}$$

→take it upper bounding by 1→find a nearest value from legacy candidates+new candidates for α)

In one example, for a given configured value of αₙ and P_{CSI-RS}, ΣₙLₙ is directly determined by

$${\sum }_{n} {L}_{n} = \frac{{\sum }_{n} 2 {L}_{n}}{{P}_{CSI - RS}} .$$

In one embodiment, {αₙ} for Rel-17-based CJT codebook are derived by Lₙ and a normalization factor

$${L}^{*} = {max}_{n} {L}_{n}$$

where n=1, . . . , N_{TRP}.

$$( calculate {α}_{n} = \frac{{L}_{n}}{{L}^{*}} )$$

In one example, for a given combination of {Lₙ}, αₙ is determined by

$${α}_{n} = \frac{{L}_{n}}{{L}^{*}} .$$

In one example, when (L₁,L₂,L₃)=(6,4,2), (α₁,α₂,α₃)=(1,⅔,⅓)
In one example, when (L₁,L₂,L₃)=(4,4,2), (α₁,α₂,α₃)=(1,1, ½).
In one example, when (L₁,L₂,L₃,L₄)=(6,4,2,2), (α₁,α₂,α₃)=(1,⅔,⅓,⅓).

(calculate

$${α}_{n} = \frac{{L}_{n}}{{L}^{*}}$$

→find a nearest value from legacy candidates for α)

In one example, for a given combination of {Lₙ}, αₙ is selected from [symbol] ={½,¾,1}, where the selected value from [symbol] is the nearest value to

$$\frac{{L}_{n}}{{L}^{*}} .$$

In one example, when (L₁,L₂,L₃)=(6,4,2), (α₁,α₂,α₃)=(1,¾,½).
In one example, when (L₁,L₂,L₃)=(4,4,2), (α₁,α₂,α₃)=(1,1,½).
In one example, when (L₁,L₂,L₃,L₄)=(6,4,2,2), (α₁,α₂,α₃)=(1,¾,½,½).
   To Map (Relate) from pᵥ to M.

In one embodiment, there is one-to-one relation between pᵥ and M, where each pᵥ value has a corresponding value of M.

In one example, there is one-to-one relation between pᵥ for v=1, 2 and M, i.e., the relation is based on pᵥ for v=1, 2 and M.

In one example, there is one-to-one relation between pᵥ for v=3, 4 and M, i.e., the relation is based on pᵥ for v=3, 4 and M.

In one example, pᵥ∈{⅛,¼ } in parameter combinations of Rel-16-based CJT codebook can be mapped to M={1,2} for Rel-17-based CJT codebook.

FIG. 13 illustrates a one-to-one relation between pᵥ and M 1300 according to embodiments of the present disclosure. The embodiment of the one-to-one relation between pᵥ and M 1300 illustrated in FIG. 13 is for illustration only. FIG. 13 does not limit the scope of this disclosure to any particular implementation of the one-to-one relation between pᵥ and M 1300.

In one example, FIG. 13 shows one-to-one relation between pᵥ and M, where pᵥ=⅛ maps to M=1, and pᵥ=¼ maps to M=2. (other one-to-one relation cases are omitted.)

In one example, a one-to-one mapping or relation shown in this example can be used to derive M for Rel-17-based CJT codebook.

In one example, a one-to-one mapping or relation shown in this example can be used to construct/generate/derive a table for M (or (M,β)) for Rel-17-based CJT codebook.

In one example, pᵥ∈{¼,½} in parameter combinations of Rel-16-based CJT codebook can be mapped to M={1,2} for Rel-17-based CJT codebook. An example with the same approach shown in one or more examples herein can be an example to derive M for Rel-17-based CJT codebook from pᵥ for Rel-16-based CJT codebook.

In one example, pᵥ∈{⅛,½} in parameter combinations of Rel-16-based CJT codebook can be mapped to M={1,2} for Rel-17-based CJT codebook. An example with the same approach shown in one or more examples herein can be an example to derive M for Rel-17-based CJT codebook from pᵥ for Rel-16-based CJT codebook.

In one example, pᵥ∈{ 1/16,½} in parameter combinations of Rel-16-based CJT codebook can be mapped to M={1,2} for Rel-17-based CJT codebook. An example with the same approach shown in one or more examples herein can be an example to derive M for Rel-17-based CJT codebook from pᵥ for Rel-16-based CJT codebook.

In one example, pᵥ∈{ 1/16,¼ } in parameter combinations of Rel-16-based CJT codebook can be mapped to M={1,2} for Rel-17-based CJT codebook. An example with the same approach shown in one or more examples herein can be an example to derive M for Rel-17-based CJT codebook from pᵥ for Rel-16-based CJT codebook.

In one example, pᵥ∈{ 1/16,⅛ } in parameter combinations of Rel-16-based CJT codebook can be mapped to M={1,2} for Rel-17-based CJT codebook. An example with the same approach shown in one or more examples herein can be an example to derive M for Rel-17-based CJT codebook from pᵥ for Rel-16-based CJT codebook.

In one embodiment, there is a many-to-one relation between pᵥ and M, where each pᵥ value has a corresponding value of M, and different pᵥ values can be corresponding to a same value of M.

In one example, there is a many-to-one relation between pᵥ for v=1, 2 and M, i.e., the relation is based on pᵥ for v=1, 2 and M.

In one example, there is a many-to-one relation between pᵥ for v=3, 4 and M, i.e., the relation is based on pᵥ for v=3, 4 and M.

In one example, pᵥ∈{⅛,¼,½} in parameter combinations of Rel-16-based CJT codebook can be mapped to M={1,2} for Rel-17-based CJT codebook.

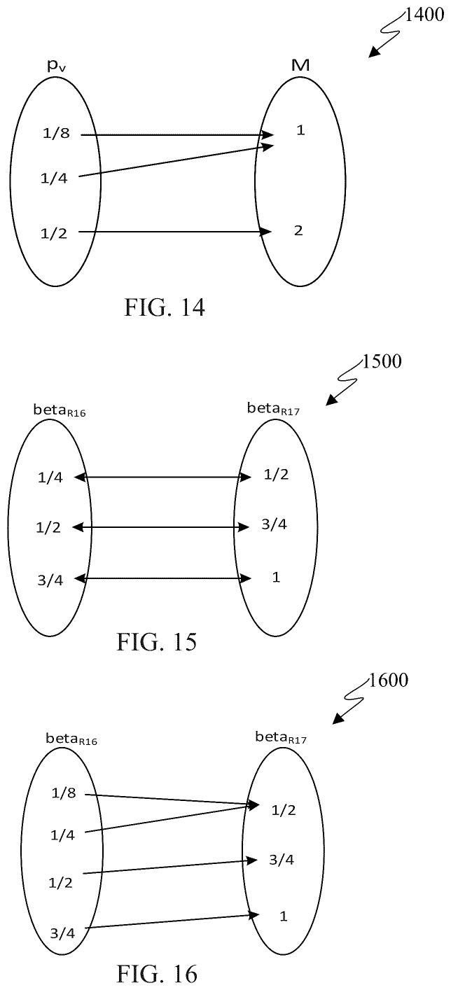

FIG. 14 illustrates a many-to-one relation between pᵥ and M 1400 according to embodiments of the present disclosure. The embodiment of the many-to-one relation between pᵥ and M 1400 illustrated in FIG. 14 is for illustration only. FIG. 14 does not limit the scope of this disclosure to any particular implementation of the many-to-one relation between pᵥ and M 1400.

In one example, FIG. 14 shows a many-to-one relation between pᵥ and M, where pᵥ=⅛ maps to M=1, and pᵥ=¼ maps to M=1, and pᵥ=½ maps to M=2 (other many-to-one relation cases are omitted.)

In one example, a many-to-one mapping, or relation shown in this example can be used to derive M for Rel-17-based CJT codebook.

In one example, a many-to-one mapping, or relation shown in this example can be used to construct/generate/derive a table for M (or (M,β)) for Rel-17-based CJT codebook.

In one example, pᵥ∈{ 1/16,⅛,¼ } in parameter combinations of Rel-16-based CJT codebook can be mapped to M={1,2} for Rel-17-based CJT codebook. An example with the same approach shown in one or more examples herein can be an example to derive M for Rel-17-based CJT codebook from pᵥ for Rel-16-based CJT codebook.

In one example, pᵥ∈{ 1/16,⅛,½} in parameter combinations of Rel-16-based CJT codebook can be mapped to M={1,2} for Rel-17-based CJT codebook. An example with the same approach shown in one or more examples herein can be an example to derive M for Rel-17-based CJT codebook from pᵥ for Rel-16-based CJT codebook.

In one example, pᵥ∈{ 1/16,¼,½} in parameter combinations of Rel-16-based CJT codebook can be mapped to M={1,2} for Rel-17-based CJT codebook. An example with the same approach shown in one or more examples herein can be an example to derive M for Rel-17-based CJT codebook from pᵥ for Rel-16-based CJT codebook.

In one example, pᵥ∈{ 1/16,⅛,¼,½} in parameter combinations of Rel-16-based CJT codebook can be mapped to M={1,2} for Rel-17-based CJT codebook. An example with the same approach shown in one or more examples herein can be an example to derive M for Rel-17-based CJT codebook from pᵥ for Rel-16-based CJT codebook.

In one embodiment, M for Rel-17-based CJT codebook is derived using an existing relation between pᵥ and M, e.g.,

$$M = ⌈ \frac{{p}_{v} {N}_{3}}{R} ⌉$$

(in section 5.2.2.2.5 of [9]), where the parameter R is configured with the higher-layer parameter numberOfPMI-SubbandsPerCQI-Subband, and N₃ is the total number of precoding matrices indicated by the PMI as a function of the number of configured subbands in csi-ReportingBand, the subband size configured by the higher-level parameter subbandSize and of the total number of PRBs in the bandwidth part according to Table 5.2.1.4-2 of [9].

In one example, the existing relation is based on pᵥ for v=1, 2 for Rel-16-based CJT codebook and M for Rel-17-based CJT codebook.

In one example, the existing relation is based on pᵥ for v=3, 4 for Rel-16-based CJT codebook and M for Rel-17-based CJT codebook.

(calculate

$$⌈ \frac{{p}_{v} {N}_{3}}{R} ⌉$$

→take it upper bounding by 2)

In one example, for a given configured value of pᵥ, R, and N₃, M is determined by

$$min ( c , ⌈ \frac{{p}_{v} {N}_{3}}{R} ⌉ ) .$$

In one example, c=2. In one example, c≤2. In one example, c≥2. For the case of c=2, examples may include:
In one example, when pᵥ=½, R=1, N₃=19, M is set to 2.
In one example, when pᵥ=⅛, R=1, N₃=7, M is set to 1.
In one example, when pᵥ=¼, R=1,N₃=6, M is set to 2.

That is, based on the rule of

$$M = min ( c , ⌈ \frac{{p}_{v} {N}_{3}}{R} ⌉ ) ,$$

M is determined using configured values of pᵥ, R, and N₃.

$$( calculate ⌈ \frac{{p}_{v} {N}_{3}}{R} ⌉ )$$

In one example, for a given configured value of pᵥ, R, and N₃, M is directly determined by

$$⌈ \frac{{p}_{v} {N}_{3}}{R} ⌉ .$$

In one example, when pᵥ=½, R=1, N₃=19, M is set to 10.
In one example, when pᵥ=⅛, R=1, N₃=7, M is set to 1.
In one example, when pᵥ=¼, R=1, N₃=6, M is set to 2.

That is, based on the rule of

$$M = ⌈ \frac{{p}_{v} {N}_{3}}{R} ⌉ ,$$

M is determined using configured values of pᵥ, R, and N₃.

In one embodiment, M for Rel-17-based CJT codebook is derived by pᵥ and a scaling factor s, where M=f(pᵥ×s)+b and f(⋅) is a function such as ceiling, flooring, etc, b is an offset value.

In one example, pᵥ for v=1, 2 can be used for deriving M value for Rel-17-based CJT codebook.

In one example, pᵥ for v=3, 4 can be used for deriving M value for Rel-17-based CJT codebook.

In one example, s=1/x where x is the minimum value among configurable pᵥ values for Rel-16-based CJT codebook and f(⋅) is a flooring function and b=0.

In one example, when a configurable value of pᵥ is in {⅛,¼,½}, x=⅛ and s=8. In this case,
pᵥ=⅛ maps to M=└pᵥ×s┘=1,
pᵥ=¼ maps to M=└pᵥ×s┘=2,
pᵥ=½ maps to M=└pᵥ×s┘=4,

In one example, s=1/x where x is the maximum value among configurable pᵥ values for Rel-16-based CJT codebook and f(⋅) is a flooring function and b=1.

In one example, when a configurable value of pᵥ is in {⅛,¼,½}, x=½ and s=2. In this case,
pᵥ=⅛ maps to M=└pᵥ×s┘+1=1,
pᵥ=¼ maps to M=└pᵥ×s┘+1=1,
pᵥ=½ maps to M=└pᵥ×s┘+1=2,
   To Map (Relate) from β_{R16} to β_{R17}

In one embodiment, there is one-to-one relation between β for Rel-16-based CJT codebook (denoted by β_{R16} hereafter) and β for Rel-17-based CJT codebook (denoted by β_{R17} hereafter), where each β_{R16} value has a corresponding value of B_{R17}.

In one example, β_{R16}∈{¼,½,¼ } in parameter combinations of Rel-16-based CJT codebook can be mapped to β_{R17}={½,¼,1} for Rel-17-based CJT codebook.

FIG. 15 illustrates a one-to-one relation between β_{R16} and β_{R17} 1500 according to embodiments of the present disclosure. The embodiment of the one-to-one relation between β_{R16} and β_{R17} 1500 illustrated in FIG. 15 is for illustration only. FIG. 15 does not limit the scope of this disclosure to any particular implementation of the one-to-one relation between β_{R16} and β_{R17} 1500.

In one example, FIG. 15 shows a one-to-one relation between β_{R16} and β_{R17}, where β_{R16}=¼ maps to β_{R17}=½, β_{R16}=½ maps to β_{R17}=¾, and β_{R16}=¾ maps to β_{R17}=1, (other one-to-one relation cases are omitted.)

In one example, a one-to-one mapping or relation shown in this example can be used to derive β_{R17} for Rel-17-based CJT codebook.

In one example, a one-to-one mapping or relation shown in this example can be used to construct/generate/derive a table for β_{R17} (or (M,β)) for Rel-17-based CJT codebook.

In one example, β_{R16}∈{⅛,¼,½,¾} in parameter combinations of Rel-16-based CJT codebook can be mapped to β_{R17}∈{¼,½,¾,1} for Rel-17-based CJT codebook. An example with the same approach shown in one or more examples herein can be an example to derive β_{R17} for Rel-17-based CJT codebook from β_{R16} for Rel-16-based CJT codebook.

In one example, β_{R16} in any subset of {⅛,¼,½,¾} having two elements in parameter combinations of Rel-16-based CJT codebook can be mapped to β_{R17} in any subset of {¼,½,¾,1} having two elements for Rel-17-based CJT codebook. An example with the same approach shown in one or more examples herein can be an example to derive β_{R17} for Rel-17-based CJT codebook from β_{R16} for Rel-16-based CJT codebook.

In one embodiment, there is a many-to-one relation between β_{R16} for Rel-16-based CJT codebook and β_{R17} for Rel-17-based CJT codebook, where each β_{R16} value has a corresponding value of β_{R17} and different β_{R16} values can be corresponding to a same value of β_{R17}.

In one example, β_{R16}∈{⅛,¼,½,¾} in parameter combinations of Rel-16-based CJT codebook can be mapped to β_{R17}={½,¾,1} for Rel-17-based CJT codebook.

FIG. 16 illustrates a many-to-one relation between β_{R16} and β_{R17} 1600 according to embodiments of the present disclosure. The embodiment of the many-to-one relation between β_{R16} and β_{R17} 1600 illustrated in FIG. 16 is for illustration only. FIG. 16 does not limit the scope of this disclosure to any particular implementation of the many-to-one relation between β_{R16} and β_{R17} 1600.

In one example, FIG. 16 shows a many-to-one relation between β_{R16} and β_{R17}, where β_{R16}=⅛ maps to β_{R17}=½, β_{R16}=¼ maps to β_{R17}=½, β_{R16}=½ maps to β_{R17}=¾, and β_{R16}=¾ maps to β_{R17}=1. (other many-to-one relation cases are omitted.)

In one example, a many-to-one mapping, or relation shown in this example can be used to derive β_{R17} for Rel-17-based CJT codebook.

In one example, a many-to-one mapping, or relation shown in this example can be used to construct/generate/derive a table for β_{R17} (or (M,β)) for Rel-17-based CJT codebook.

In one example, β_{R16}∈{⅛,¼,½,¾} in parameter combinations of Rel-16-based CJT codebook can be mapped to β_{R17} in any subset of {¼,½,¾,1} having three elements for Rel-17-based CJT codebook. An example with the same approach shown in one or more examples herein can be an example to derive β_{R17} for Rel-17-based CJT codebook from β_{R16} for Rel-16-based CJT codebook.

In one example, β_{R16} ∈{⅛,¼,½,¾} in parameter combinations of Rel-16-based CJT codebook can be mapped to β_{R17} in any subset of {¼,½,¾,1} having two elements for Rel-17-based CJT codebook. An example with the same approach shown in one or more examples herein can be an example to derive β_{R17} for Rel-17-based CJT codebook from β_{R16} for Rel-16-based CJT codebook.

In one example, β_{R16} in any subset of {⅛,¼,½,¾} having three elements in parameter combinations of Rel-16-based CJT codebook can be mapped to β_{R17} in any subset of {¼,½,¾,1} having two elements for Rel-17-based CJT codebook. An example with the same approach shown in one or more examples herein can be an example to derive β_{R17} for Rel-17-based CJT codebook from β_{R16} for Rel-16-based CJT codebook.

### Represent R17-Based CJT Parameter Combinations

In one embodiment, there is no table on parameter combinations for Rel-17-based CJT codebook, but there is a rule (or are rules) using at least one of the embodiments/examples described in this disclosure to determine/derive {αₙ} and (M,β) from parameter combinations {Lₙ} and (pᵥ,β) (or tables) for Rel-16-based CJT codebook.

In one embodiment, another table set for Rel-17-based CJT codebook is constructed/generated/derived/determined by at least one of the embodiments/examples described in this disclosure and parameter combinations (or tables) for Rel-16-based CJT codebook.

In one example, a table for {αₙ} combinations (or supported {αₙ} combinations) for Rel-17-based CJT codebook includes at least one of the combinations that can be derived from the parameter combinations {Lₙ} for Rel-16-based CJT codebook using one or more examples herein.

For example, as shown in the following table, possible {αₙ} combinations are described w.r.t. P_{CSI-RS} for given {Lₙ} combinations, using one or more examples herein.

| | {Lₙ} | | | | | | |
|---|---|---|---|---|---|---|---|
| | combi- | | | | | | |
| | nation | | | | | | |
| | supported | | | | | | |
| | For Rel- | | | | | | |
| | 16-based | {αₙ} combination corresponding to P_{CSI-RS} | | | | | |
| | CJT | using one or more examples herein | | | | | |
| N_{TRP} | codebook | 4 | 8 | 12 | 16 | 24 | 32 |
| 2 | {2, 2} | {1, 1} | {1/2, 1/2} | {1/2, 1/2} | {1/2, | {1/2, | {1/2, |
| | | | | | 1/2} | 1/2} | 1/2} |
| | {2, 4}, | / | {1/2, 1}; | {1/2, 1/2} | {1/2, | {1/2, | {1/2, |
| | {4, 2} | | {1, 1/2} | | 1/2} | 1/2} | 1/2} |
| | {4, 4} | / | {1, 1} | {3/4, 3/4} | {1/2, | {1/2, | {1/2, |
| | | | | | 1/2} | 1/2} | 1/2} |
| 3 | {2, 2, 2} | {1, 1, | {1/2, 1/2, | {1/2, 1/2, | {1/2, | {1/2, | {1/2, |
| | | 1} | | 1/2} | 1/2, | 1/2, | 1/2, |
| | | | 1/2} | | 1/2} | 1/2} | 1/2} |
| | {2, 2, 4} | / | {1/2, 1/2, | {1/2, 1/2, | {1/2, | {1/2, | {1/2, |
| | {2, 4, 2}, | | 1}; {1/2, 1, | 3/4} | 1/2, | 1/2, | 1/2, |
| | {4, 2, 2} | | 1/2}; {1/2, | and its | 1/2} | 1/2} | 1/2} |
| | | | 1/2, 1} | permutations | | | |
| | {4, 4, 4} | / | {1, 1, 1} | {3/4, 3/4, | {1/2, | {1/2, | {1/2, |
| | | | | 3/4} | 1/2, | 1/2, | 1/2, |
| | | | | | 1/2} | 1/2} | 1/2 |
| 4 | {2, 2, 2, 2} | {1, 1, | {1/2, 1/2, | {1/2, 1/2, | {1/2, | {1/2, | {1/2, |
| | | 1, 1} | 1/2, 1/2} | 1/2, 1/2} | 1/2, | 1/2, | 1/2, |
| | | | | | 1/2, | 1/2, | 1/2, |
| | | | | | 1/2} | 1/2} | 1/2} |
| | {2, 2, 2, 4} | / | {1/2, 1/2, | {1/2, 1/2, | {1/2, | {1/2, | {1/2, |
| | | | | 1/2, | 1/2, | 1/2, | 1/2, |
| | | | 1/2, 1} | 3/4} | 1/2, | 1/2, | 1/2, |
| | | | | | 1/2} | 1/2} | 1/2} |
| | {2, 2, 4, 4} | / | {1/2, 1/2, | {1/2, 1/2, | {1/2, | {1/2, | {1/2, |
| | | | 1, 1} | 3/4, 3/4} | 1/2, | 1/2, | 1/2, |
| | | | | | 1/2, | 1/2, | 1/2, |
| | | | | | 1/2} | 1/2} | 1/2} |
| | {4, 4, 4, 4} | / | {1, 1, 1, 1} | {3/4, 3/4, | {1/2, | {1/2, | {1/2, |
| | | | | 3/4, 3/4} | 1/2, | 1/2, | 1/2, |
| | | | | | 1/2, | 1/2, | 1/2, |
| | | | | | 1/2} | 1/2} | 1/2} |

In one example, a table for {αₙ} combinations (or supported {αₙ} combinations) for Rel-17-based CJT codebook includes at least one of the following combinations:

| N_{TRP} | {αₙ} combination | Label |
|---|---|---|
| 2 | {½, ½} | A1 |
| | {½, 1}, {1, ½} | A2 |
| | {¾, ¾} | A3 |
| | {1, 1} | A4 |
| 3 | {½, ½, ½} | A5 |
| | {½, ½, ¾}, and its | A6 (including |
| | permutations | permutations) |
| | | A′6 (without permutations) |
| | {½, ½, 1}, and its | A7 (including |
| | permutations | permutations) |
| | | A′7 (without permutations) |
| | {¾, ¾, ¾} | A8 |
| | {1, 1, 1} | A9 |
| 4 | {½, ½, ½, ½} | A10 |
| | {½, ½, ½, ¾} and its | A11 (including |
| | permutations | permutations) |
| | | A′11 (without |
| | | permutations) |
| | {½, ½, ¾, ¾} and its | A12 (including |
| | permutations | permutations) |
| | | A′12 (without |
| | | permutations) |
| | {½, ½, ½, 1} and its | A13 (including |
| | permutations | permutations) |
| | | A′ 13 (without |
| | | permutations) |
| | {½, ½, 1, 1} and its | A14 (including |
| | permutations | permutations) |
| | | A′14 (without |
| | | permutations) |
| | {¾, ¾, ¾, ¾} | A15 |
| | [1, 1, 1, 1} | A16 |

For each row associated with {αₙ} combination having permutations, the case of {αₙ} combination including permutations is denoted by A# and the case of {αₙ} combination without permutations is denoted by A'#, respectively.

In one example, a table for {αₙ} combinations (or supported {αₙ} combinations) for Rel-17-based CJT codebook includes at least one of the following combinations (A1-A8, A10-A14):

| N_{TRP} | {αₙ} combination |
|---|---|
| 2 | {½, ½} |
| | {½, 1}, {1, ½} |
| | {¾, ¾} |
| | {1, 1} |
| 3 | {½, ½, ½} |
| | {½, ½, ¾}, and its permutations |
| | {½, ½, 1}, and its permutations |
| | {¾, ¾, ¾} |
| 4 | {½, ½, ½, ½} |
| | {½, ½, ½, ¾} and its permutations |
| | {½, ½, ¾, ¾} and its permutations |
| | {½, ½, ½, 1} and its permutations |

In one example, a table for {αₙ} combinations (or supported {αₙ} combinations) for Rel-17-based CJT codebook includes at least one of the following combinations (A1, A2, A4, A5, A7, A9, A10, A′13, A′14, A16):

| N_{TRP} | {αₙ} combination |
|---|---|
| 2 | {½, ½} |
| | {½, 1}, {1, ½} |
| | {1, 1} |
| 3 | {½, ½, ½} |
| | {½, ½, 1}, and its permutations |
| | {1, 1, 1} |
| 4 | {½, ½, ½, ½} |
| | {½, ½, ½, 1} |
| | {½, ½, 1, 1} |
| | {1, 1, 1, 1} |

In one example, a table for {αₙ} combinations (or supported {αₙ} combinations) for Rel-17-based CJT codebook includes at least one of the following combinations (A1-A7, A9, A10, A13, A′14, A16)

| N_{TRP} | {αₙ} combination |
|---|---|
| 2 | {½, ½} |
| | {½, 1}, {1, ½} |
| | {¾, ¾} |
| | {1, 1} |
| 3 | {½, ½, ½} |
| | {½, ½, ¾}, and its permutations |
| | {½, ½, 1}, and its permutations |
| | {1, 1, 1} |
| | {½, ½, ½, ½} |
| 4 | {½, ½, ½, 1} and its permutations |
| | {½, ½, 1, 1} |
| | {1, 1, 1, 1} |

In one example, a table for {αₙ} combinations (or supported {αₙ} combinations) for Rel-17-based CJT codebook includes all of the combinations in the table above, i.e., A1-A7, A9, A10, A13, A′14, A16.

In one example, a table for {αₙ} combinations (or supported {αₙ} combinations) for Rel-17-based CJT codebook includes some of the combinations in the table above, i.e., A1-A7, A9, A10, A13, A′14, A16 and some of the combinations not in the table above, i.e., A8, A11, A12, A15.

In one example, a table for {αₙ} combinations (or supported {αₙ} combinations) for Rel-17-based CJT codebook includes at least one (or some or all) of the combinations in the table above in which for at least one of the combinations having permutations is replaced by the combination without having its permutations, i.e., A #→A′# or vice versa, i.e., A′#→A #.
For example, instead of having A13, they include A′13, i.e., in this case, the combinations A1-A7, A9, A10, A′13, A′14, A16.
For example, instead of having A′14, they include A14, i.e., in this case, the combinations A1-A7, A9, A10, A13, A14, A16.
For example, instead of having A13, A6, and A7, they include A′13, A′6, and A′7, i.e., in this case, the combinations A1-A5, A′6, A′7, A9, A10, A′13, A′14, A16.
For example, instead of having A6, and A7, they include A′6, and A′7, i.e., in this case, the combinations A1-A5, A′6, A′7, A9, A10, A13, A′14, A16.
   Linkages between {αₙ} and (M,β)

For purpose of illustration, assume that a supported number of {αₙ} combinations is S and a supported number of (M,β) combinations is Q, e.g., S=20, Q=5.

In one example, one linkage matrix with size of S×Q (or Q×S) is used to indicate/refer linking pairs between {αₙ} and (M,β) combinations. For example, each entry (s, q) of the linkage matrix has either 0 or 1, where 0 refers to “not supported” for the linkage between s-th {αₙ} combination and q-th (M,β) combination, or 1 refers to “supported” for the linkage between s-th {αₙ} combination and q-th (M,β) combination.

In one example, the UE is not expected to configure the combination pair of {αₙ} and (M,β) corresponding to any of the “not supported” entries of the linkage matrix.

In one example, the UE is expected to configure the combination pair of {αₙ} and (M,β) corresponding to one (any) of the “supported” entries of the linkage matrix.

In one example, the linkage matrix is pre-determined/fixed.

In one example, the linkage matrix is configured via higher-layer signaling (e.g., RRC).

In one example, N_{TRP} (or N_{TRP}−1) linkage matrices each with size of Sᵣ×Q (Q×Sᵣ) are used to indicate/refer linking pairs between {αₙ} and (M,β) combinations, where each linkage matrix r corresponds to the linkage matrix for N_{TRP}=r, and r=1, . . . , 4 (or r=2, . . . , 4). For example, each entry (s,q) of each linkage matrix r has either 0 or 1, where 0 refers to “not supported” for the linkage between s-th {αₙ} combination for N_{TRP}=r and q-th (M,β) combination, or 1 refers to “supported” for the linkage between s-th {αₙ} combination for N_{TRP}=r and q-th (M,β) combination.

In one example, Sᵣ is the number of supported {αₙ} combinations for N_{TRP}=r.

In one example, the UE is not expected to configure the combination pair of {αₙ} and (M,β) corresponding to any of the “not supported” entries of the linkage matrix.

In one example, the UE is expected to configure the combination pair of {αₙ} and (M,β) corresponding to one (any) of the “supported” entries of the linkage matrix.

In one example, the linkage matrix is pre-determined/fixed.

In one example, the linkage matrix is configured via higher-layer signaling (e.g., RRC).

The term linkage matrix is used herein for the sake of convenience, but it can be under a different name, e.g., linkage pair, linkage combination, (linkage/supported) pair/combination or linkages between {αₙ} and (M,β) etc.

In one example, a supported number of linkages/pairs between {αₙ} and (M,β) for each N_{TRP} is at most J, e.g., J=8 (as shown in the following table). In another example, J=12 or J=16, J=9 or J=40.

| | {αₙ} | M = 1 | | | M = 2 | |
|---|---|---|---|---|---|---|
| N_{TRP} | combination | β = 1/2 | β = 3/4 | β = 1 | β = 1/2 | β = 3/4 |
| 2 | {1/2, 1/2} | Linked | | | | |
| | {1/2, 1} | Linked | Linked | Linked | Linked | Linked |
| | {1, 1/2} | Linked | Linked | Linked | Linked | Linked |
| | {3/4, 3/4} | | | Linked | Linked | Linked |
| | {1, 1} | | | | Linked | Linked |
| | N_{L} | 1, 2 | 1, 2 | 1, 2 | 1, 2, 4 | 1, 2, 4 |
| 3 | {1/2, 1/2, 1/2} | Linked | Linked | | | |
| | {1/2, 1/2, 3/4} | Linked | Linked | | | |
| | {1/2, 3/4, 1/2} | Linked | Linked | | | |
| | {3/4, 1/2, 1/2} | Linked | Linked | | | |
| | {1/2, 1/2, 1} | | | Linked | | |
| | {1/2, 1, 1/2} | | | Linked | | |
| | {1, 1/2, 1/2} | | | Linked | | |
| | {1, 1,1} | | | Linked | Linked | Linked |
| | N_{L} | 1, 2, 4 | 1, 2, 4 | 1, 2, 4 | 1 | 1 |
| 4 | {1/2, 1/2, 1/2, | Linked | | | | |
| | 1/2} | | | | | |
| | {1/2, 1/2, 1/2, | Linked | Linked | | | |
| | 1} | | | | | |
| | {1/2, 1/2, 1, | Linked | Linked | | | |
| | 1/2} | | | | | |
| | {1/2, 1, 1/2, | Linked | Linked | | | |
| | 1/2} | | | | | |
| | {1, 1/2, 1/2, | Linked | Linked | | | |
| | 1/2} | | | | | |
| | {1/2, 1/2, 1, 1} | | | Linked | Linked | Linked |
| | {1, 1, 1, 1} | | | Linked | Linked | Linked |
| | N_{L} | 1, 2, 4 | 1, 2, 4 | 1, 2 | 1, 2 | 1, 2 |

For example, in the table above, the ones with ‘linked’ are supported linkages/pairs between {αₙ} and (M,β) for each N_{TRP}, wherein the number of supported linkages/pairs for each N_{TRP} is at most 16.

In one example, possible values of N_{L} are determined/restricted by the linkages for a given (M,β) and for each N_{TRP}. For example, using the table above as an example, for the case of (M,β) corresponding to (2,½) for N_{TRP}=2, the possible {αₙ} combinations are {½,1}, {1,½}, {¾,¾}, {1,1}. In this case, the possible values of N_{L} are 1 and/or 2 and/or 4. That is, the number of rows with ‘linked’ for each column determines the possible {αₙ} combinations and the possible values of N_{L}. We denote possible values of N_{L} in the last row for each N_{TRP} in the table above.

In one example, N_{L}=4 can be supported only for N_{TRP}=3.

In one example, for all N_{TRP}=1,2,3,4, the possible values of N_{L} are 1 and 2 only.

In one example, the possible values of N_{L} are 1, 2, and 4, but N_{L}=4 is only for N_{TRP}=2.

In one example, the possible values of N_{L} are 1, 2, and 4, but N_{L}=4 is only for N_{TRP}=3.

In one example, the possible values of N_{L} are 1, 2, and 4, but N_{L}=4 is only for N_{TRP}=4.

In one example, the possible values of N_{L} are 1, 2, and 4, but N_{L}=4 is only for N_{TRP}=2, 3.

In one example, the possible values of N_{L} are 1, 2, and 4, but N_{L}=4 is only for N_{TRP}=3, 4.

In one example, the possible values of N_{L} are 1, 2, and 4, but N_{L}=4 is only for N_{TRP}=2, 4.

In one example, the possible values of N_{L} are 1, 2, and 4, but N_{L}=4 is only for N_{TRP}=2,3,4.

In one example, the supported linkages/pairs between {αₙ} and (M,β) include all of the ‘linked’ ones described in one of the linkage tables that can be constructed or are described in the present disclosure.

In one example, the supported linkages/pairs between {αₙ} and (M,β) include a subset of the ‘linked’ ones described in one of the linkage tables that can be constructed or are described in the present disclosure.

In one example, the supported linkages/pairs between {αₙ} and (M,β) include at least one of the ‘linked’ ones described in one of the linkage tables that can be constructed or are described in the present disclosure.

In one example, for a given (M,β) and for each N_{TRP}, the linkages for {αₙ} combinations that are in permutation relationship (e.g., {½,½,1}, {½,1,½}, {1,½,½} for N_{TRP}=3) are either ‘all linked or ‘all not linked’.

In one example, for each N_{TRP}, the supported linkages/pairs between {αₙ} and (M,β) include at least one of the highlighted ones (denoted by ‘W #’) described in the following table.

| | {αₙ} | M = 1 | | | M = 2 | |
|---|---|---|---|---|---|---|
| N_{TRP} | combination | β = 1/2 | β = 3/4 | β = 1 | β = 1/2 | β = 3/4 |
| 2 | {1/2, 1/2} | W1 | | | W9 | |
| | {1/2, 1} | W2 | W4 | | | |
| | {1, 1/2} | W3 | W5 | | | |
| | {3/4, 3/4} | | W6 | W7 | | |
| | {1, 1} | | | W8 | W10 | W11 |
| 3 | {1/2, 1/2, 1/2} | W12 | | | W23 | |
| | {1/2, 1/2, 3/4} | W13 | | | | |
| | {1/2, 3/4, 1/2} | W14 | | | | |
| | {3/4, 1/2, 1/2} | W15 | | | | |
| | {1/2, 1/2, 1} | | W16 | W19 | W24 | |
| | [1/2, 1, 1/2} | | W17 | W20 | W25 | |
| | {1, 1/2, 1/2} | | W18 | W21 | W26 | |
| | {1, 1, 1} | | | W22 | | W27 |
| 4 | {1/2, 1/2, 1/2, | W28 | | | W40 | |
| | 1/2} | | | | | |
| | {1/2, 1/2, 1/2, | W29 | W33 | | | |
| | 1} | | | | | |
| | {1/2, 1/2, 1, | W30 | W34 | | | |
| | 1/2} | | | | | |
| | {1/2, 1, 1/2, | W31 | W35 | | | |
| | 1/2} | | | | | |
| | {1, 1/2, 1/2, | W32 | W36 | | | |
| | 1/2} | | | | | |
| | {1/2, 1/2, 1, 1} | | W37 | W38 | W41 | |
| | {1, 1, 1, 1} | | | W39 | | W42 |

For example, for N_{TRP}=2, the supported linkages/pairs between {αₙ} and (M,β) include at least one of the highlighted ones labelled from W1 to W11. For example, J₁ linkages selected from W1-W11 are supported linkages, where 1≤J₁≤J, and J₂ linkages selected from the ones other than W1-W11 (for N_{TRP}=2) are supported linkages, where 0≤J₂≤J−J₁.

For example, for N_{TRP}=3, the supported linkages/pairs between {αₙ} and (M,β) include at least one of the highlighted ones labelled from W12 to W27. For example, J₁ linkages selected from W12-W27 are supported linkages, where 1≤J₁≤J, and J₂ linkages selected from the ones other than W12-W27 (for N_{TRP}=3) are supported linkages, where 0≤J₂≤J−J₁.

For example, for N_{TRP}=4, the supported linkages/pairs between {αₙ} and (M,β) include at least one of the highlighted ones labelled from W28 to W42. For example, J₁ linkages selected from W28-W42 are supported linkages, where 1≤J₁≤J, and J₂ linkages selected from the ones other than W28-W42 (for N_{TRP}=4) are supported linkages, where 0≤J₂≤J−J₁.

| | {αₙ} | M = 1 | | | M = 2 | |
|---|---|---|---|---|---|---|
| N_{TRP} | combination | β = 1/2 | β = 3/4 | β = 1 | β = 1/2 | β = 3/4 |
| 2 | {1/2, 1/2} | o | | | o | |
| | {1/2, 1}, | o | o | | | |
| | (1, 1/2} | | | | | |
| | {3/4, 3/4} | | o | o | | |
| | {1, 1} | | | o | o | o |
| 3 | {1/2, 1/2, 1/2} | o | | | o | |
| | {1/2, 1/2, 3/4}, | o | | | | |
| | and its | | | | | |
| | permutations | | | | | |
| | {1/2, 1/2, 1}, | | o | o | o | |
| | and its | | | | | |
| | permutations | | | | | |
| | {1, 1, 1} | | | o | | o |
| 4 | {1/2, 1/2, 1/2, | o | | | o | |
| | 1/2} | | | | | |
| | {1/2, 1/2, 1/2, | o | o | | | |
| | 1} and its | | | | | |
| | permutations | | | | | |
| | {1/2, 1/2, 1, 1} | | o | o | o | |
| | {1, 1, 1, 1} | | | o | | o |

In one example, for each N_{TRP}, the supported linkages/pairs between {αₙ} and (M,β) include at least one of the highlighted ones (denoted by ‘S #, R #, T #’) described in the following table.

| | {αₙ} | M = 1 | | | M = 2 | |
|---|---|---|---|---|---|---|
| N_{TRP} | combination | β = 1/2 | β = 3/4 | β = 1 | β = 1/2 | β = 3/4 |
| 2 | {1/2, 1/2} | S1 | | | S7 | |
| | {1/2, 1} | S2 | R1 | | T1 | |
| | {1, 1/2} | S3 | R2 | | T2 | |
| | {3/4, 3/4} | | S4 | S5 | T3 | |
| | {1, 1} | | R3 | S6 | S8 | S9 |
| 3 | {1/2, 1/2, 1/2} | S10 | T4 | | S21 | |
| | {1/2, 1/2, 3/4} | S11 | T5 | | T8 | |
| | {1/2, 3/4, 1/2} | S12 | T6 | | T9 | |
| | {3/4, 1/2, 1/2} | S13 | T7 | | T10 | |
| | {1/2, 1/2, 1} | T11 | S14 | S17 | S22 | |
| | {1/2, 1, 1/2} | T12 | S15 | S18 | S23 | |
| | {1, 1/2, 1/2} | T13 | S16 | S19 | S24 | |
| | {1, 1, 1} | T14 | R4 | S20 | R5 | S25 |
| 4 | {1/2, 1/2, 1/2, | S26 | | | S34 | |
| | 1/2} | | | | | |
| | {1/2, 1/2, 1/2, | S27 | R6 | | R11 | |
| | 1} | | | | | |
| | {1/2, 1/2, 1, | S28 | R7 | | R12 | |
| | 1/2} | | | | | |
| | {1/2, 1, 1/2, | S29 | R8 | | R13 | |
| | 1/2} | | | | | |
| | {1, 1/2, 1/2, | S30 | R9 | | R15 | |
| | 1/2} | | | | | |
| | {1/2, 1/2, 1, 1} | | S31 | S32 | S35 | |
| | {1, 1, 1, 1} | | R10 | S33 | R16 | R17 |

For example, for N_{TRP}=2, the supported linkages/pairs between {αₙ} and (M,β) include at least one of the ones labelled S1 to S9 and R1 to R3 and T1 to T3.

In one example, for N_{TRP}=2, the supported linkages/pairs between {αₙ} and (M,β) include all of the ones labelled S1 to S9 and R1 to R3 and T1 to T3.

In one example, for N_{TRP}=2, the supported linkages/pairs between {αₙ} and (M,β) include the ones labelled S1 to S9 and R1 to R3.

In one example, for N_{TRP}=2, the supported linkages/pairs between {αₙ} and (M,β) include the ones labelled S1 to S9 and R1 to R3 and at least one of the ones labelled T1 to T3.

In one example, for N_{TRP}=2, the supported linkages/pairs between {αₙ} and (M,β) include the ones labelled S11 to S9.

In one example, for N_{TRP}=2, the supported linkages/pairs between {αₙ} and (M,β) include the ones labelled S11 to S9 and at least one of the ones labelled R1 to R3.

In one example, for N_{TRP}=2, the supported linkages/pairs between {αₙ} and (M,β) include the ones labelled S11 to S9 and at least one of the ones labelled T1 to T3.

In one example, for N_{TRP}=2, the supported linkages/pairs between {αₙ} and (M,β) include the highlighted ones labelled S1 to S9 and at least one of the ones labelled R1 to R3 and at least one of the ones labelled T1 to T3.

In one example, for N_{TRP}=2, the supported linkages/pairs between {αₙ} and (M,β) include the ones labelled S1 to S9 and based on J, they further include J₁ linkages from the ones labelled R1 to R3 and T1 to T3, where 0≤J₁≤J−9.

In one example, for N_{TRP}=2, the supported linkages/pairs between {αₙ} and (M,β) include the ones labelled S1 to S9 and R1 to R3, and based on J, they further include J₁ linkages from the ones labelled T1 to T3, where 0≤J₁≤J−12.

For example, for N_{TRP}=3, the supported linkages/pairs between {αₙ} and (M,β) include at least one of the ones labelled S10 to S25 and R4 to R5 and T4 to T14.

In one example, for N_{TRP}=3, the supported linkages/pairs between {αₙ} and (M,β) include all of the ones labelled S10 to S25 and R4 to R5 and T4 to T14.

In one example, for N_{TRP}=3, the supported linkages/pairs between {αₙ} and (M,β) include the ones labelled S10 to S25 and R4 to R5.

In one example, for N_{TRP}=3, the supported linkages/pairs between {αₙ} and (M,β) include the ones labelled S10 to S25 and R4 to R5 and at least one of the ones labelled T4 to T14.

In one example, for N_{TRP}=3, the supported linkages/pairs between {αₙ} and (M,β) include the ones labelled S10 to S25.

In one example, for N_{TRP}=3, the supported linkages/pairs between {αₙ} and (M,β) include the ones labelled S10 to S25 and at least one of the ones labelled R4 to R5.

In one example, for N_{TRP}=3, the supported linkages/pairs between {αₙ} and (M,β) include the ones labelled S10 to S25 and at least one of the ones labelled T4 to T14.

In one example, for N_{TRP}=3, the supported linkages/pairs between {αₙ} and (M,β) include the ones labelled S10 to S25 and at least one of the ones labelled R4 to R5 and at least one of the ones labelled T4 to T14.

In one example, for N_{TRP}=3, the supported linkages/pairs between {αₙ} and (M,β) include the ones labelled S10 to S25 and based on J, they further include J₁ linkages from the ones labelled R4 to R5 and T4 to T14, where 0≤J₁≤J−16.

In one example, for N_{TRP}=3, the supported linkages/pairs between {αₙ} and (M,β) include the ones labelled S10 to S25 and R4 to R5, and based on J, they further include J₁ linkages from the ones labelled T4 to T14, where 0≤J₁≤J−18.

For example, for N_{TRP}=4, the supported linkages/pairs between {αₙ} and (M,β) include at least one of the ones labelled S26 to S35 and R6 to R17.

In one example, for N_{TRP}=4, the supported linkages/pairs between {αₙ} and (M,β) include all of the ones labelled S26 to S35 and R6 to R17.

In one example, for N_{TRP}=4, the supported linkages/pairs between {αₙ} and (M,β) include the ones labelled S26 to S35 and at least one of the ones labelled R6 to R17.

In one example, for N_{TRP}=4, the supported linkages/pairs between {αₙ} and (M,β) include the ones labelled S26 to S35.

In one example, for N_{TRP}=4, the supported linkages/pairs between {αₙ} and (M,β) include the ones labelled S26 to S36 and based on J, they further include J₁ linkages from the ones labelled R6 to R17, where 0≤J₁≤J−11.

In one example, for each N_{TRP}, the supported linkages/pairs between {αₙ} and (M,β) include at least one of the ones (denoted by ‘A #, B #’) described in the following table.

| | {αₙ} | M = 1 | | | M = 2 | |
|---|---|---|---|---|---|---|
| N_{TRP} | combination | β = 1/2 | β = 3/4 | β = 1 | β = 1/2 | β = 3/4 |
| 2 | {1/2, 1/2} | A1 | | | A5 | |
| | {1/2, 1} | A2 | | | | |
| | {1, 1/2} | A3 | | | | |
| | {3/4, 3/4} | | A4 | | | |
| | {1, 1} | | B1 | B2 | A6 | |
| 3 | (1/2, 1/2, 1/2} | A7 | | | A14 | |
| | {1/2, 1/2, 3/4} | A8 | | | | |
| | {1/2, 3/4, 1/2} | A9 | | | | |
| | {3/4, 1/2, 1/2} | A10 | | | | |
| | {1/2, 1/2, 1} | | A11 | | A15 | |
| | {1/2, 1, 1/2} | | A12 | | A16 | |
| | {1, 1/2, 1/2} | | A13 | | A17 | |
| | {1, 1, 1} | | B3 | B4 | | A18 |
| 4 | {1/2, 1/2, 1/2, | A19 | | | A24 | |
| | 1/2} | | | | | |
| | {1/2, 1/2, 1/2, | A20 | | | | |
| | 1} | | | | | |
| | {1/2, 1/2, 1, | | | | | |
| | 1/2} | | | | | |
| | {1/2, 1, 1/2, | | | | | |
| | 1/2} | | | | | |
| | {1, 1/2, 1/2, | | | | | |
| | 1/2} | | | | | |
| | {1/2, 1/2, 1, 1} | | A21 | A22 | A25 | |
| | {1, 1, 1, 1} | | | A23 | | |

For example, for N_{TRP}=2, the supported linkages/pairs between {αₙ} and (M,β) include at least one of the ones labelled A1 to A6 and B1 to B2.

In one example, for N_{TRP}=2, the supported linkages/pairs between {αₙ} and (M,β) include all of the ones labelled A1 to A6 and B1.

In one example, for N_{TRP}=2, the supported linkages/pairs between {αₙ} and (M,β) include all of the ones labelled A1 to A6 and B2.

In one example, for N_{TRP}=2, the supported linkages/pairs between {αₙ} and (M,β) include all of the ones labelled A1 to A6 and B1 and B2.

For example, for N_{TRP}=3, the supported linkages/pairs between {αₙ} and (M,β) include at least one of the ones labelled A7 to A18 and B3 to B4.

In one example, for N_{TRP}=3, the supported linkages/pairs between {αₙ} and (M,β) include all of the ones labelled A7 to A18 and B3.

In one example, for N_{TRP}=3, the supported linkages/pairs between {αₙ} and (M,β) include all of the ones labelled A7 to A18 and B4.

In one example, for N_{TRP}=3, the supported linkages/pairs between {αₙ} and (M,β) include all of the ones labelled A7 to A18 and B3 and B4.

For example, for N_{TRP}=4, the supported linkages/pairs between {αₙ} and (M,β) include at least one of the ones labelled A19 to A25.

In one example, for N_{TRP}=4, the supported linkages/pairs between {αₙ} and (M,β) include all of the ones labelled A19 to A25.

In one example, the supported linkages/pairs between {αₙ} and (M,β) including N_{TRP}=1 (legacy) can be as follows:

| | (M, β) | | | | |
|---|---|---|---|---|---|
| {αₙ} combination | (1, ½) | (1, ¾) | (1, 1) | (2, ½) | (2, ¾) |
| {½} | | | | x | |
| {¾} | x | | | x | |
| {1} | x | x | x | x | x |
| {½, ½} | x | | | x | |
| {½, 1} | x | | | | |
| {1, ½} | x | | | | |
| {¾, ¾} | | x | | | |
| {1, 1} | | x | | x | |
| {½, ½, ½} | x | | | x | |
| {½, ½, ¾} | x | | | | |
| {½, ¾, ½} | x | | | | |
| {¾, ½, ½} | x | | | | |
| {½, ½, 1} | | x | | x | |
| {½, 1, ½} | | x | | x | |
| {1, ½, ½} | | x | | x | |
| {1, 1, 1} | | x | | | x |
| {½, ½, ½, ½} | x | | | | |
| {½, ½, ½, 1} | x | | | | |
| {½, ½, 1, ½} | | x | x | x | |
| {½, 1, ½, ½} | | | x | | |

In one example, the UL can report UL capability on αₜₒₜ. Then, the NW (needs to follow and) can configure a combination of {αₙ} under the UL capability, e.g., a combination of {αₙ} such that Σₙαₙ=Lₜₒₜ.

For example, αₜₒₜ≤t is a basic feature and αₜₒₜ>t is UE-optional. In one example, t=2. In one example, t=3. In one example, t=1. In one example, t=1.5. For αₜₒₜ>t, the UE reports its capability to support it or not and the NW can configure one of the parameter combinations in the table only associated with the {αₙ} that the UE supports (based on the UE capability and the basic feature).

For example, αₜₒₜ<t is a basic feature and αₜₒₜ≥t is UE-optional. In one example, t=2. In one example, t=3. In one example, t=1. In one example, t=1.5. For αₜₒₜ≥t, the UE reports its capability to support it or not and the NW can configure one of the parameter combinations in the table only associated with the {αₙ} that the UE supports (based on the UE capability and the basic feature).

In one example, the UE capability on αₜₒₜ in each example above can be a separate capability.

In one example, the UE capability on αₜₒₜ in each example above can be one component of a capability.

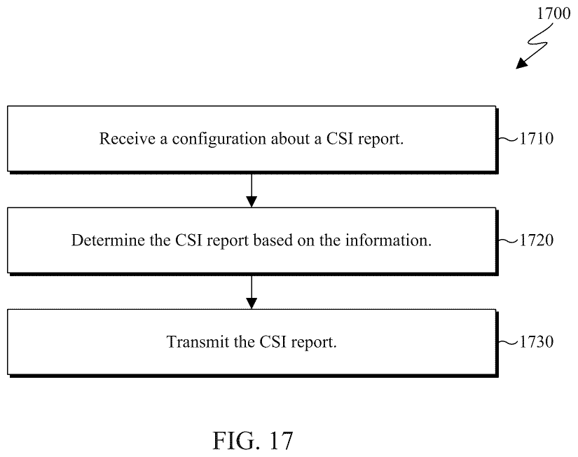

FIG. 17 illustrates αₙ example method 1700 performed by a UE in a wireless communication system according to embodiments of the present disclosure. The method 1700 of FIG. 17 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1700 is for illustration only and other embodiments can be used without departing from the scope of the present disclosure.

The method 1700 begins with the UE receiving information about a CSI report (1710). For example, in 1710, the information indicates codebook parameters N_{L}≥1 combinations of values of {α₁, . . . , α_{N}_{_{TRP}}} from a first table, and a value of (M,β) from a second table. {α₁, . . . , α_{N}_{_{TRP}}} is related to a number of a first set of vectors associated with each of N_{TRP} groups of ports, where aᵣ≤1 for r=1, . . . , N_{TRP}, β is a parameter related to a maximum number of coefficients, and M is a parameter related to a second set of vectors. In various embodiments, the codebook parameters are configured based on a third table that links the first and second tables.

Thereafter, the UE determines the CSI report based on the information (1720) and transmits the CSI report, report (1730).

In various embodiments, a first RRC parameter indicates the N_{L} combinations of values of {α₁, . . . , α_{N}_{_{TRP}}} from the first table. Each of the N_{L} combinations of values of {α₁, . . . , α_{N}_{_{TRP}}} is indicated via N_{TRP} and a value of the first RRC parameter that is configured from a set of values including A1, A2, . . . , and A20.

In various embodiments, a second RRC parameter indicates the value of (M,β) from the second table. The value of (M,β) is indicated via a value of the second RRC parameter that is configured from a set of values including B1, B2, . . . , and B5.

In various embodiments, a first radio resource control (RRC) parameter is associated with the first table, a second RRC parameter is associated with the second table, the third table includes configurable combinations between a value of {α₁, . . . , α_{N}_{_{TRP}}} and a value of (M,β).

In various embodiments, a value of N_{L} is configured by a RRC parameter.

In various embodiments, each of the N_{TRP} groups of ports corresponds to CSI-RS antenna ports associated with a CSI-RS resource.

In various embodiments, the UE is not expected to be configured with N_{TRP} and a first RRC parameter corresponding to {α₁, . . . , α_{N}_{_{TRP}}} including, when P_{CSI-RS}=4 and allowed rank values for the CSI report include 3 or 4, where P_{CSI-RS} is a number of CSI-RS ports for each of N_{TRP} CSI-RS resources.

In various embodiments, a the UE is expected to be configured with R=1 when M=1, where R is a parameter configured with a higher-layer parameter numberOfPMI-SubbandsPerCQI-Subband.

Any of the above variation embodiments can be utilized independently or in combination with at least one other variation embodiment. The above flow charts illustrate example methods that can be implemented in accordance with the principles of the present disclosure and various changes could be made to the methods illustrated in the flow charts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) comprising:
a transceiver configured to receive information about a channel state information (CSI) report, the information indicating codebook parameters:
N_{L}≥1 combinations of values of {α₁, . . . , α_{N}_{_{TRP}}} from a first table, and
a value of (M,β) from a second table,
wherein {α₁, . . . , α_{N}_{_{TRP}}} is related to a number of a first set of vectors associated with each of N_{TRP} groups of ports, where aᵣ≤1 for r=1, . . . , N_{TRP}, β is a parameter related to a maximum number of coefficients, and M is a parameter related to a second set of vectors; and
a processor operably coupled to the transceiver, the processor configured to determine the CSI report based on the information,
wherein the transceiver is further configured to transmit the CSI report, and
wherein the codebook parameters are configured based on a third table that links the first and second tables.

2. The UE of claim 1, wherein a first radio resource control (RRC) parameter indicates the N_{L} combinations of values of {α₁, . . . , α_{N}_{_{TRP}}} from the first table given by:

| | first RRC | |
|---|---|---|
| N_{TRP} | parameter | {α₁, . . . , α_{N}_{_{TRP}}} |
| 1 | A1 | {½} |
| | A2 | {¾} |
| | A3 | {1} |
| 2 | A4 | {½, ½} |
| | A5 | {½, 1} |
| | A6 | {1, ½} |
| | A7 | {¾, ¾} |
| | A8 | {1, 1} |
| 3 | A9 | {½, ½, ½} |
| | A10 | {½, ½, ¾} |
| | A11 | {½, ¾, ½} |
| | A12 | {¾, ½, ½} |
| | A13 | {½, ½, 1} |
| | A14 | {½, 1, ½} |
| | A15 | {1, ½, ½} |
| | A16 | {1, 1, 1} |
| 4 | A17 | {½, ½, ½, ½} |
| | A18 | {½, ½, ½, 1} |
| | A19 | {½, ½, 1, 1} |
| | A20 | {1, 1, 1, 1} |

wherein each of the N_{L} combinations of values of {α₁, . . . , α_{N}_{_{TRP}}} is indicated via N_{TRP} and a value of the first RRC parameter that is configured from a set of values including A1, A2, . . . , and A20.

3. The UE of claim 1, wherein a second radio resource control (RRC) parameter indicates the value of (M,β) from the second table given by:

| second RRC | | |
|---|---|---|
| parameter | M | β |
| B1 | 1 | ½ |
| B2 | 1 | ¾ |
| B3 | 1 | 1 |
| B4 | 2 | ½ |
| B5 | 2 | ¾ |

wherein the value of (M,β) is indicated via a value of the second RRC parameter that is configured from a set of values including B1, B2, . . . , and B5.

4. The UE of claim 1, wherein:
a first radio resource control (RRC) parameter is associated with the first table,
a second RRC parameter is associated with the second table,
the third table includes configurable combinations between a value of {α₁, . . . , α_{N}_{_{TRP}}} and a value of (M,β) marked with ‘x’ in the following table:

| | | second RRC parameter | | | | |
|---|---|---|---|---|---|---|
| N_{TRP} | first RRC parameter | B1 | B2 | B3 | B4 | B5 |
| 1 | A1 | | | | x | |
| | A2 | x | | | x | |
| | A3 | x | x | x | x | x |
| 2 | A4 | x | | | x | |
| | A5 | x | | | | |
| | A6 | x | | | | |
| | A7 | | x | | | |
| | A8 | | x | | x | |
| 3 | A9 | x | | | x | |
| | A10 | x | | | | |
| | A11 | x | | | | |
| | A12 | x | | | | |
| | A13 | | x | | x | |
| | A14 | | x | | x | |
| | A15 | | x | | x | |
| | A16 | | x | | | x |
| 4 | A17 | x | | | | |
| | A18 | x | | | | |
| | A19 | | x | x | x | |
| | A20 | | | x | | |

where:
A1 corresponds to α₁=½;
A2 corresponds to α₁=¾;
A3 corresponds to α₁=1;
A4 corresponds to {α₁,α₂}={½,½};
A5 corresponds to {α₁,α₂}={½,1};
A6 corresponds to {α₁,α₂}={1,½};
A7 corresponds to {α₁,α₂}={¾,¾};
A8 corresponds to {α₁,α₂}={1,1};
A9 corresponds to {α₁,α₂,α₃}={½,½,½};
A10 corresponds to {α₁,α₂,α₃}={½,½,¾};
A11 corresponds to {α₁,α₂,α₃}={½,¾,½};
A12 corresponds to {α₁,α₂,α₃}={¾,½,½};
A13 corresponds to {α₁,α₂,α₃}={½,½,1};
A14 corresponds to {α₁,α₂,α₃}={½,1,½};
A15 corresponds to {α₁,α₂,α₃}={1,½,½};
A16 corresponds to {α₁,α₂,α₃}={1,1,1};
A17 corresponds to {α₁,α₂,α₃,α₄}={½,½,½,½};
A18 corresponds to {α₁,α₂,α₃,α₄}={½,½,½,1};
A19 corresponds to {α₁,α₂,α₃,α₄}={½,½,1,1};
A20 corresponds to {α₁,α₂,α₃,α₄}={1,1,1,1};
B1 corresponds to {M,β}={1,½};
B2 corresponds to {M,β}={1,¾};
B3 corresponds to {M,β}={1,1};
B4 corresponds to {M,β}={2,½}; and
B5 corresponds to {M,β}={2,¾}.

5. The UE of claim 1, wherein a value of N_{L} is configured by a radio resource control (RRC) parameter.

6. The UE of claim 1, wherein each of the N_{TRP} groups of ports corresponds to CSI reference signal (CSI-RS) antenna ports associated with a CSI-RS resource.

7. The UE of claim 1, wherein:
the UE is not expected to be configured with N_{TRP} and a first radio resource control (RRC) parameter corresponding to {α₁, . . . , α_{N}_{_{TRP}}} including ½, when P_{CSIRS}=4 and allowed rank values for the CSI report include 3 or 4, where P_{CSI-RS} is a number of CSI-reference signal (CSI-RS) ports for each of N_{TRP} CSI reference signal (CSI-RS) resources; or
the UE is expected to be configured with R=1 when M=1, where R is a parameter configured with a higher-layer parameter numberOfPMI-SubbandsPerCQI-Subband.

8. A base station (BS) comprising:
a processor; and
a transceiver operably coupled to the processor, the transceiver configured to:
transmit information about a channel state information (CSI) report, the information indicating codebook parameters:
N_{L}≥1 combinations of values of {α₁, . . . , α_{N}_{_{TRP}}} from a first table, and
a value of (M,β) from a second table,
wherein {α₁, . . . , α_{N}_{_{TRP}}} is related to a number of a first set of vectors associated with each of N_{TRP} groups of ports, where aᵣ≤1 for r=1, . . . , N_{TRP}, β is a parameter related to a maximum number of coefficients, and M is a parameter related to a second set of vectors; and
receive the CSI report that is based on the information,
wherein the codebook parameters are configured based on a third table that links the first and second tables.

9. The BS of claim 8, wherein a first radio resource control (RRC) parameter indicates the N_{L} combinations of values of {α₁, . . . , α_{N}_{_{TRP}}} from the first table given by:

| | first RRC | |
|---|---|---|
| N_{TRP} | parameter | {α₁, . . . , α_{N}_{_{TRP}}} |
| 1 | A1 | {½} |
| | A2 | {¾} |
| | A3 | {1} |
| 2 | A4 | {½, ½} |
| | A5 | {½, 1} |
| | A6 | {1, ½} |
| | A7 | {¾, ¾} |
| | A8 | {1, 1} |
| 3 | A9 | {½, ½, ½} |
| | A10 | {½, ½, ¾} |
| | A11 | {½, ¾, ½} |
| | A12 | {¾, ½, ½} |
| | A13 | {½, ½, 1} |
| | A14 | {½, 1, ½} |
| | A15 | {1, ½, ½} |
| | A16 | {1, 1, 1} |
| 4 | A17 | {½, ½, ½, ½} |
| | A18 | {½, ½, ½, 1} |
| | A19 | {½, ½, 1, 1} |
| | A20 | {1, 1, 1, 1} |

wherein each of the N_{L} combinations of values of {α₁, . . . , α_{N}_{_{TRP}}} is indicated via N_{TRP} and a value of the first RRC parameter that is configured from a set of values including A1, A2, . . . , and A20.

10. The BS of claim 8, wherein a second radio resource control (RRC) parameter indicates the value of (M,β) from the second table given by:

| second RRC | | |
|---|---|---|
| parameter | M | β |
| B1 | 1 | ½ |
| B2 | 1 | ¾ |
| B3 | 1 | 1 |
| B4 | 2 | ½ |
| B5 | 2 | ¾ |

wherein the value of (M,β) is indicated via a value of the second RRC parameter that is configured from a set of values including B1, B2, . . . , and B5.

11. The BS of claim 8, wherein:
a first radio resource control (RRC) parameter is associated with the first table,
a second RRC parameter is associated with the second table,
the third table includes configurable combinations between a value of {α₁, . . . , α_{N}_{_{TRP}}} and a value of (M,β) marked with ‘x’ in the following table:

| | | second RRC parameter | | | | |
|---|---|---|---|---|---|---|
| N_{TRP} | first RRC parameter | B1 | B2 | B3 | B4 | B5 |
| 1 | A1 | | | | x | |
| | A2 | x | | | x | |
| | A3 | x | x | x | x | x |
| 2 | A4 | x | | | x | |
| | A5 | x | | | | |
| | A6 | x | | | | |
| | A7 | | x | | | |
| | A8 | | x | | x | |
| 3 | A9 | x | | | x | |
| | A10 | x | | | | |
| | A11 | x | | | | |
| | A12 | x | | | | |
| | A13 | | x | | x | |
| | A14 | | x | | x | |
| | A15 | | x | | x | |
| | A16 | | x | | | x |
| 4 | A17 | x | | | | |
| | A18 | x | | | | |
| | A19 | | x | x | x | |
| | A20 | | | x | | |

where:
A1 corresponds to α₁=½;
A2 corresponds to α₁=¾;
A3 corresponds to α₁=1;
A4 corresponds to {α₁,α₂}={½,½};
A5 corresponds to {α₁,α₂}={½,1};
A6 corresponds to {α₁,α₂}={1,½};
A7 corresponds to {α₁,α₂}={¾,¾};
A8 corresponds to {α₁,α₂}={1,1};
A9 corresponds to {α₁,α₂,α₃}={½,½,½};
A10 corresponds to {α₁,α₂,α₃}={½,½,¾};
A11 corresponds to {α₁,α₂,α₃}={½,¾,½};
A12 corresponds to {α₁,α₂,α₃}={¾,½,½};
A13 corresponds to {α₁,α₂,α₃}={½,½,1};
A14 corresponds to {α₁,α₂,α₃}={½,1,½};
A15 corresponds to {α₁,α₂,α₃}={1,½,½};
A16 corresponds to {α₁,α₂,α₃}={1,1,1};
A17 corresponds to {α₁,α₂,α₃,α₄}={½,½,½,½};
A18 corresponds to {α₁,α₂,α₃,α₄}={½,½,½,1};
A19 corresponds to {α₁,α₂,α₃,α₄}={½,½,1,1};
A20 corresponds to {α₁,α₂,α₃,α₄}={1,1,1,1};
B1 corresponds to {M,β}={1,½};
B2 corresponds to {M,β}={1,¾};
B3 corresponds to {M,β}={1,1};
B4 corresponds to {M,β}={2,½}; and
B5 corresponds to {M,β}={2,¾}.

12. The BS of claim 8, wherein a value of N_{L} is configured by a radio resource control (RRC) parameter.

13. The BS of claim 8, wherein each of the N_{TRP} groups of ports corresponds to CSI reference signal (CSI-RS) antenna ports associated with a CSI-RS resource.

14. The BS of claim 8, wherein:
a user equipment (UE) is not expected to be configured with N_{TRP} and a first radio resource control (RRC) parameter corresponding to {α₁, . . . , α_{N}_{_{TRP}}} including 2, when P_{CSI-RS}=4 and allowed rank values for the CSI report include 3 or 4, where P_{CSI-RS} is a number of CSI-reference signal (CSI-RS) ports for each of N_{TRP} CSI reference signal (CSI-RS) resources; or
the UE is expected to be configured with R=1 when M=1, where R is a parameter configured with a higher-layer parameter numberOfPMI-SubbandsPerCQI-Subband.

15. A method performed by a user equipment (UE), the method comprising:
receiving information about a channel state information (CSI) report, the information indicating codebook parameters:
N_{L}≥1 combinations of values of {α₁, . . . , α_{N}_{_{TRP}}} from a first table, and
a value of (M,β) from a second table,
wherein {α₁, . . . , α_{N}_{_{TRP}}} is related to a number of a first set of vectors associated with each of N_{TRP} groups of ports, where aᵣ≤1 for r=1, . . . , N_{TRP}, β is a parameter related to a maximum number of coefficients, and M is a parameter related to a second set of vectors;
determining the CSI report based on the information; and
transmitting the CSI report,
wherein the codebook parameters are configured based on a third table that links the first and second tables.

16. The method of claim 15, wherein a first radio resource control (RRC) parameter indicates the N_{L} combinations of values of {α₁, . . . , α_{N}_{_{TRP}}} from the first table given by:

| | first RRC | |
|---|---|---|
| N_{TRP} | parameter | {α₁, . . . , α_{N}_{_{TRP}}} |
| 1 | A1 | {½} |
| | A2 | {¾} |
| | A3 | {1} |
| 2 | A4 | {½, ½} |
| | A5 | {½, 1} |
| | A6 | {1, ½} |
| | A7 | {¾, ¾} |
| | A8 | {1, 1} |
| 3 | A9 | {½, ½, ½} |
| | A10 | {½, ½, ¾} |
| | A11 | {½, ¾, ½} |
| | A12 | {¾, ½, ½} |
| | A13 | {½, ½, 1} |
| | A14 | {½, 1, ½} |
| | A15 | {1, ½, ½} |
| | A16 | {1, 1, 1} |
| 4 | A17 | {½, ½, ½, ½} |
| | A18 | {½, ½, ½, 1} |
| | A19 | {½, ½, 1, 1} |
| | A20 | {1, 1, 1, 1} |

wherein each of the N_{L} combinations of values of {α₁, . . . , α_{N}_{_{TRP}}} is indicated via N_{TRP} and a value of the first RRC parameter that is configured from a set of values including A1, A2, . . . , and A20.

17. The method of claim 15, wherein a second radio resource control (RRC) parameter indicates the value of (M,β) from the second table given by:

| second RRC | | |
|---|---|---|
| parameter | M | β |
| B1 | 1 | ½ |
| B2 | 1 | ¾ |
| B3 | 1 | 1 |
| B4 | 2 | ½ |
| B5 | 2 | ¾ |

wherein the value of (M,β) is indicated via a value of the second RRC parameter that is configured from a set of values including B1, B2, . . . , and B5.

18. The method of claim 15, wherein:
a first radio resource control (RRC) parameter is associated with the first table,
a second RRC parameter is associated with the second table,
the third table includes configurable combinations between a value of {α₁, . . . , α_{N}_{_{TRP}}} and a value of (M,β) marked with ‘x’ in the following table:

| | | second RRC parameter | | | | |
|---|---|---|---|---|---|---|
| N_{TRP} | first RRC parameter | B1 | B2 | B3 | B4 | B5 |
| 1 | A1 | | | | x | |
| | A2 | x | | | x | |
| | A3 | x | x | x | x | x |
| 2 | A4 | x | | | x | |
| | A5 | x | | | | |
| | A6 | x | | | | |
| | A7 | | x | | | |
| | A8 | | x | | x | |
| 3 | A9 | x | | | x | |
| | A10 | x | | | | |
| | A11 | x | | | | |
| | A12 | x | | | | |
| | A13 | | x | | x | |
| | A14 | | x | | x | |
| | A15 | | x | | x | |
| | A16 | | x | | | x |
| 4 | A17 | x | | | | |
| | A18 | x | | | | |
| | A19 | | x | x | x | |
| | A20 | | | x | | |

where:
A1 corresponds to α₁=½;
A2 corresponds to α₁=¾;
A3 corresponds to α₁=1;
A4 corresponds to {α₁,α₂}={½,½};
A5 corresponds to {α₁,α₂}={½,1 };
A6 corresponds to {α₁,α₂}={1,½};
A7 corresponds to {α₁,α₂}={¾,¾};
A8 corresponds to {α₁,α₂}={1,1};
A9 corresponds to {α₁,α₂,α₃}={½,½,½};
A10 corresponds to {α₁,α₂,α₃}={½,½,¾};
A11 corresponds to {α₁,α₂,α₃}={½,¾,½};
A12 corresponds to {α₁,α₂,α₃}={¾,½,½};
A13 corresponds to {α₁,α₂,α₃}={½,½,1};
A14 corresponds to {α₁,α₂,α₃}={½,1,½};
A15 corresponds to {α₁,α₂,α₃}={1,½,½};
A16 corresponds to {α₁,α₂,α₃}={1,1,1};
A17 corresponds to {α₁,α₂,α₃,α₄}={½,½,½,½};
A18 corresponds to {α₁,α₂,α₃,α₄}={½,½,½,1};
A19 corresponds to {α₁, α₂,α₃,α₄}={½,½,1,1};
A20 corresponds to {α₁,α₂,α₃,α₄}={1,1,1,1};
B1 corresponds to {M,β}={1,½};
B2 corresponds to {M,β}={1,¾};
B3 corresponds to {M,β}={1,1}
B4 corresponds to {M,β}={2,½}; and B5 corresponds to {M,β}={2,¾}.

19. The method of claim 15, wherein a value of N_{L} is configured by a radio resource control (RRC) parameter.

20. The method of claim 15, wherein each of the N_{TRP} groups of ports corresponds to CSI reference signal (CSI-RS) antenna ports associated with a CSI-RS resource.
